(19) United States
(12) Patent Application Publication
(10) Pub. No.: US 2026/0045997 A1
(43) Pub. Date: Feb. 12, 2026

(54) METHOD AND APPARATUS FOR VALIDITY DETERMINATION OF CHANNEL STATE INFORMATION TRANSMISSION FROM USER EQUIPMENT IN WIRELESS COMMUNICATION SYSTEM

(71) Applicant: Samsung Electronics Co., Ltd., Gyeonggi-do (KR)

(72) Inventors: Youngrok JANG, Gyeonggi-do (KR); Junyung YI, Gyeonggi-do (KR); Hyoungju JI, Gyeonggi-do (KR); Kyungjun CHOI, Gyeonggi-do (KR)

(21) Appl. No.: 19/292,173

(22) Filed: Aug. 6, 2025

(30) Foreign Application Priority Data
Aug. 8, 2024 (KR) 10-2024-0106371

(51) Int. Cl. H04B 7/06; H04B 17/318; H04W 72/21

(52) U.S. Cl. CPC H04B 7/0626; H04B 7/06968; H04B 17/328; H04W 72/21

(57) ABSTRACT

The disclosure relates to a 5G or 6G communication system for supporting a higher data transmission rate. The disclosure relates to operations of a terminal and a BS in a wireless communication system and, more specifically, to a method for reporting reception beam performance by a UE in a wireless communication system and an apparatus capable of performing the same. The disclosure provides an apparatus and a method capable of effectively providing a service in a mobile communication system.

### CROSS-REFERENCE TO RELATED APPLICATION(S)

This application is based on and claims priority under 35 U.S.C. § 119 to Korean Patent Application No. 10-2024-0106371, filed on Aug. 8, 2024, in the Korean Intellectual Property Office, the disclosure of which is incorporated herein by reference in its entirety.

### BACKGROUND

### 1. Field

The disclosure relates generally to operations of a terminal and a base station (BS) in a wireless communication system, and more particularly, to a method for channel state information (CSI) transmission by a terminal in a wireless communication system and an apparatus capable of performing the same.

### 2. Description of Related Art

Fifth generation (5G) mobile communication technologies define broad frequency bands to enable high transmission rates and new services and can be implemented not only in sub 6 gigahertz (GHz) bands such as 3.5 GHz, but also in above 6 GHz bands referred to as millimeter wave (mmWave) bands including 28 GHz and 39 GHz bands. In addition, it has been considered implementing sixth generation (6G) mobile communication technologies referred to as beyond 5G systems in terahertz (THz) bands (e.g., 95 GHz to 3 THz bands) to achieve transmission rates fifty times faster than 5G mobile communication technologies and ultra-low latencies one-tenth of 5G mobile communication technologies.

Since the initial stage of 5G mobile communication technologies, to support services and to satisfy performance requirements in connection with enhanced mobile broadband (eMBB), ultra reliable & low latency communications (URLLC), and massive machine-type communications (mMTC), there has been ongoing standardization regarding beamforming and massive multiple input multi9ple output (MIMO) for alleviating radio-wave path loss and increasing radio-wave transmission distances in mmWave, numerology (for example, operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods such as a low density parity check (LDPC) code for large-capacity data transmission and a polar code for highly reliable transmission of control information, layer 2 (L2) pre-processing, and network slicing for providing a dedicated network customized to a specific service.

Currently, there are ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR user equipment (UE) power saving, non-terrestrial network (NTN) which is UE-satellite direct communication for securing coverage in an area in which communication with terrestrial networks is unavailable, and positioning.

Moreover, there has been ongoing standardization in wireless interface architecture/protocol fields regarding technologies such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access channel (2-step RACH) for simplifying random access procedures for NR. There also has been ongoing standardization in system architecture/service fields regarding a 5G baseline architecture (for example, service based architecture or service based interface) for combining network functions virtualization (NFV) and software-defined networking (SDN) technologies, and mobile edge computing (MEC) for receiving services based on UE positions.

If such 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR), etc., 5G performance improvement and complexity reduction by utilizing artificial intelligence (AI) and machine learning (ML), AI service support, metaverse service support, and drone communication.

Such development of 5G mobile communication systems will serve as a basis for developing not only new waveforms for securing coverage in terahertz bands of 6G mobile communication technologies, full dimensional MIMO (FD-MIMO), multi-antenna transmission technologies such as array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

### SUMMARY

An aspect of the disclosure is to provide an apparatus and a method for reporting reception beam performance by a terminal.

In accordance with an aspect of the disclosure, a method performed by a terminal in a communication system is provided. The method includes receiving, from a BS, configuration information on a channel state information (CSI) reporting initiated by the terminal; detecting an occurrence of an event associated with the CSI reporting initiated by the terminal; transmitting, to the BS, an indicator for the CSI reporting initiated by the terminal on a physical uplink control channel (PUCCH); transmitting, to the BS, CSI on a physical uplink shared channel (PUSCH), wherein the PUSCH is transmitted after an offset from the PUCCH.

In accordance with an aspect of the disclosure, a method performed by a BS in a communication system is provided. The method includes transmitting, to a terminal, configuration information on a channel state information (CSI) reporting initiated by the terminal; receiving, from the terminal, an indicator for the CSI reporting initiated by the terminal on a physical uplink control channel (PUCCH); receiving, from the terminal, CSI on a physical uplink shared channel (PUSCH), wherein the CSI reporting is initiated based on an occurrence of an event associated with the CSI reporting initiated by the terminal, and wherein the PUSCH is transmitted after an offset from the PUCCH.

In accordance with an aspect of the disclosure, a terminal in a communication system is provided. The terminal includes at least one transceiver; at least one processor communicatively coupled to the at least one transceiver; and at least one memory, communicatively coupled to the at least one processor, storing instructions executable by the at least one processor individually or in any combination to cause the terminal to: receive, from a BS, configuration information on a channel state information (CSI) reporting initiated by the terminal, detect an occurrence of an event associated with the CSI reporting initiated by the terminal, transmit, to the BS, an indicator for the CSI reporting initiated by the terminal on a physical uplink control channel (PUCCH), transmit, to the BS, CSI on a physical uplink shared channel (PUSCH), wherein the PUSCH is transmitted after an offset from the PUCCH.

In accordance with an aspect of the disclosure, a BS in a communication system is provided. The BS includes a BS in a communication system, the BS comprising: at least one transceiver; at least one processor communicatively coupled to the at least one transceiver; and at least one memory, communicatively coupled to the at least one processor, storing instructions executable by the at least one processor individually or in any combination to cause the BS to: transmit, to a terminal, configuration information on a channel state information (CSI) reporting initiated by the terminal, receive, from the terminal, an indicator for the CSI reporting initiated by the terminal on a physical uplink control channel (PUCCH), and receive, from the terminal, CSI on a physical uplink shared channel (PUSCH), wherein the CSI reporting is initiated based on an occurrence of an event associated with the CSI reporting initiated by the terminal, and wherein the PUSCH is transmitted after an offset from the PUCCH.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a basic structure of a time-frequency domain in a wireless communication system according to an embodiment;

FIG. 2 illustrates a structure of a frame, a subframe, and a slot in a wireless communication system according to an embodiment;

FIG. 3 illustrates an example of a bandwidth part (BWP) configuration in a wireless communication system according to an embodiment;

FIG. 4 illustrates radio protocol structures of a BS and a UE in single cell, carrier aggregation, and dual connectivity situations in a wireless communication system according to an embodiment;

FIG. 5 illustrates a beam application time which may be considered when a unified transmission configuration indication (TCI) scheme is used in a wireless communication system according to an embodiment;

FIG. 6 illustrates another medium access control control element (MAC-CE) structure for activation and indication of a joint TCI state or a separate DL or UL TCI state in a wireless communication system according to an embodiment;

FIG. 7 illustrates an example of an aperiodic CSI reporting method according to an embodiment;

FIG. 8 illustrates an example of control resource set (CORESET) configuration of a downlink (DL) control channel in a wireless communication system according to an embodiment;

FIG. 9 illustrates a structure of a DL control channel in a wireless communication system according to an embodiment;

FIG. 10 illustrates a method for channel measurement and channel state reporting according to a configuration and instruction of a BS according to an embodiment;

FIG. 11 illustrates operations of a UE and a BS for CSI reporting initiated by a UE using a PUCCH resource that triggers the UE-initiated reception beam performance reporting according to an embodiment;

FIG. 12 illustrates operations of a UE and a BS for CSI reporting initiated by a UE using a pair of a reserved PUCCH resource and a PUSCH transmission according to an embodiment;

FIG. 13 illustrates an example of an operation of a UE that reports reception beam performance according to an embodiment;

FIG. 14 illustrates an example of an operation of a BS that receives a reception beam performance report according to an embodiment;

FIG. 15 illustrates a structure of a UE in a wireless communication system according to an embodiment; and

FIG. 16 illustrates a structure of a BS in a wireless communication system according to an embodiment.

### DETAILED DESCRIPTION

Hereinafter, embodiments of the disclosure will be described in detail in conjunction with the accompanying drawings. A detailed description of known functions or configurations incorporated herein will be omitted for the sake of clarity and conciseness. The terms which will be described below are terms defined in consideration of the functions Herein, and may be different according to users, intentions of the users, or customs. Therefore, the definitions of the terms should be made based on the contents throughout the specification.

In the following description, terms for identifying access nodes and referring to network entities, messages, interfaces between network entities, various types of identification information, etc. are illustratively used for the convenience of description. Therefore, the disclosure is not limited by the terms as used below, and other terms referring to subjects having equivalent technical meanings may be used.

In the accompanying drawings, some elements may be exaggerated, omitted, or schematically illustrated and the size of each element does not completely reflect the actual size. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure.

An element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

The embodiments may be employed in combination, as necessary. For example, a part of one embodiment may be combined with a part of another embodiment to operate a BS and a terminal. As an example, a part of a first embodiment of the disclosure may be combined with a part of a second embodiment to operate a BS and a terminal. Moreover, although the embodiments are described based on the frequency division duplex long term evolution (FDD LTE) system, other variants based on the technical idea of the embodiments may also be implemented in other communication systems such as time division duplex (TDD) LTE, and 5G, or NR systems.

In the drawings, the order relationship between the steps may be changed or the steps may be performed in parallel.

Herein, a BS is an entity that allocates resources to terminals, and may be at least one of a gNode B, an eNode B, a Node B, a wireless access unit, a BS controller, and a node on a network. A terminal may include a user equipment (UE), a mobile station (MS), a cellular phone, a smartphone, a computer, or a multimedia system capable of performing a communication function. A “DL” refers to a radio link via which a BS transmits a signal to a terminal, and an uplink (UL) refers to a radio link via which a terminal transmits a signal to a BS. LTE or LTE-A systems may be described by way of example, but the embodiments of the disclosure may also be applied to other communication systems having similar technical backgrounds or channel types. Examples of such communication systems may include 5th generation mobile communication technologies (5G, new radio, and NR) developed beyond LTE-A, and in the following description, the “5G” may be the concept that covers the exiting LTE, LTE-A, and other similar services. In addition, based on determinations by those skilled in the art, the disclosure may also be applied to other communication systems through some modifications without significantly departing from the scope of the disclosure.

In the following description, the term “a/b” may be understood as at least one of a and b.

### NR Time-Frequency Resources

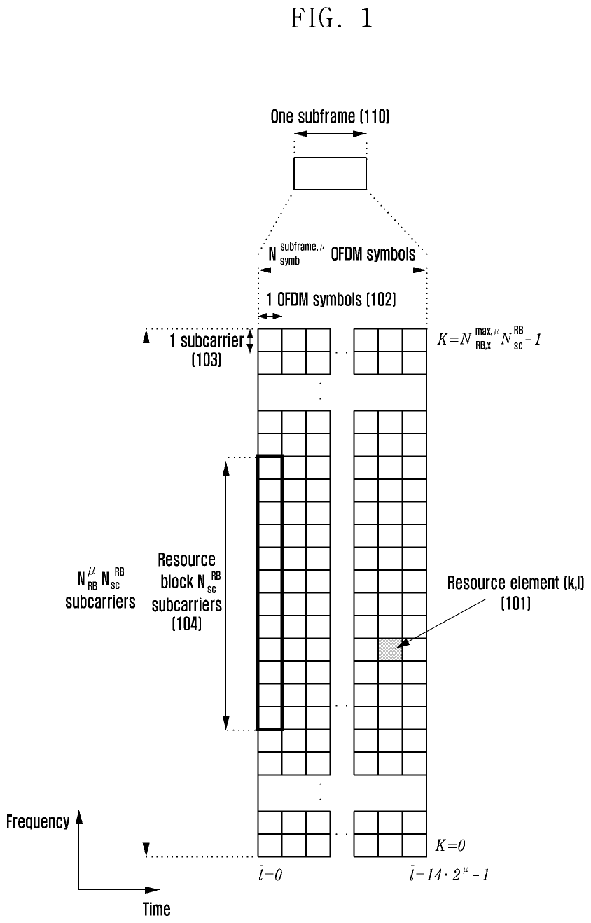

FIG. 1 illustrates a basic structure of a time-frequency domain, which is a radio resource domain used to transmit data or control channels, in a 5G system according to an embodiment.

Referring to FIG. 1, the horizontal axis denotes a time domain, and the vertical axis denotes a frequency domain. The basic unit of resources in the time and frequency domains is a resource element (RE) 101, which may be defined as one OFDM symbol 102 along the time axis and one subcarrier 103 along the frequency axis. In the frequency domain, N&c (for example, 12) consecutive REs may constitute one resource block (RB) 104. In the time domain, one subframe 110 may include multiple OFDM symbols 102. For example, the length of one subframe may be 1 ms.

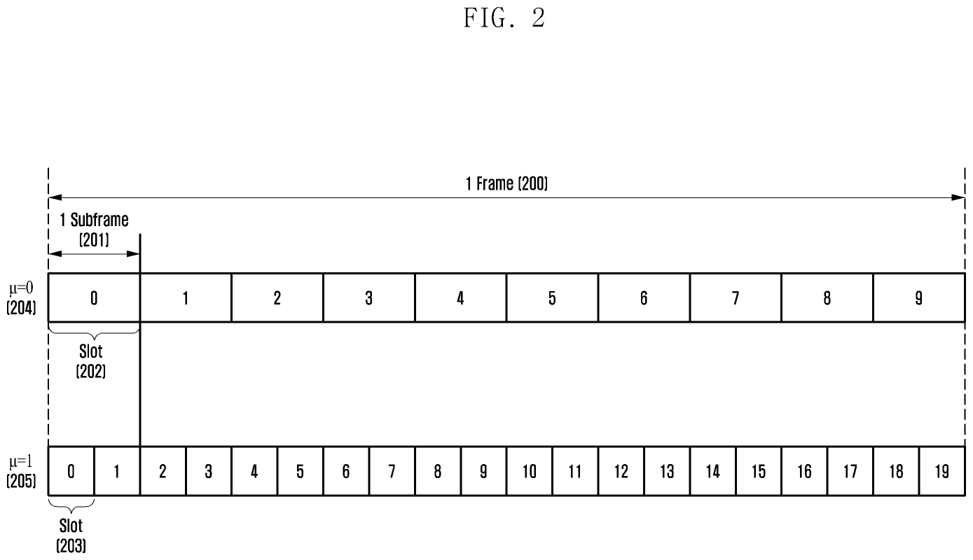

FIG. 2 illustrates a structure of a frame, a subframe, and a slot in a wireless communication system according to an embodiment.

Referring to FIG. 2, an example of a structure of a frame 200, a subframe 201, and a slot 202 is illustrated. One frame 200 may be defined as 10 ms. One subframe 201 may be defined as 1 ms, and thus one frame 200 may include a total of ten subframes 201. One slot 202 or 203 may be defined as 14 OFDM symbols (that is, the number of symbols per one slot

$${N}_{s y m b}^{slot} = 14 ) .$$

Une subframe 201 may include one or multiple slots 202 and 203, and the number of slots 202 and 203 per one subframe 201 may vary depending on configuration values u for the subcarrier spacing 204 or 205. The example in FIG. 2 illustrates a case in which the subcarrier spacing configuration value is μ=0 (204), and a case in which μ=1 (205). In the case of μ=0 (204), one subframe 201 may include one slot 202, and in the case of μ=1 (205), one subframe 201 may include two slots 203. That is, the number of slots per one subframe

$${N}_{slot}^{subframe , μ}$$

may differ depending on the subcarrier spacing configuration value μ, and the number of slots per one frame

$${N}_{slot}^{frame , μ}$$

may differ accordingly.

$${N}_{slot}^{subframe , μ} and {N}_{slot}^{frame , μ}$$

may be defined according to each subcarrier spacing configuration u as shown in Table 1 below.

TABLE 1

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

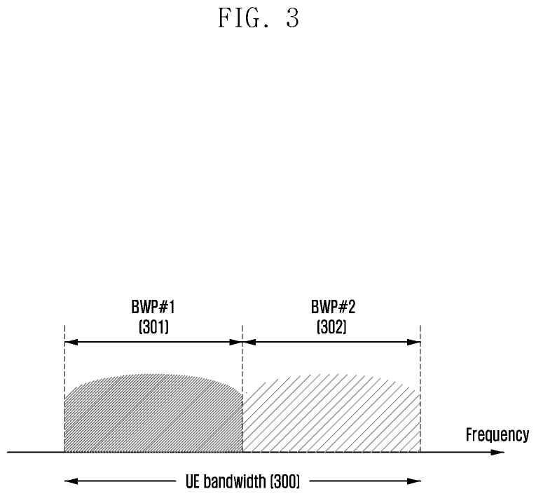

FIG. 3 illustrates an example of a BWP configuration in a wireless communication system according to an embodiment.

Referring to FIG. 3, an example is provided in which a UE bandwidth 300 is configured to include two BWPs, that is, BWP #1 301 and BWP #2 302. A BS may configure one or multiple BWPs for a UE and may configure the following pieces of information in each BWP as given in Table 2 below.

TABLE 2

| | |
|---|---|
| BWP ::= | SEQUENCE { |
| bwp-Id | BWP-Id, |

(BWP identifier)

| | |
|---|---|
| locationAndBandwidth | INTEGER (1..65536), |

(BWP location)

| | |
|---|---|
| subcarrierSpacing | ENUMERATED {n0, n1, n2, n3, n4, n5}, |

(subcarrier spacing)

| | |
|---|---|
| cyclicPrefix (CP) | ENUMERATED { extended } |

(cyclic prefix)
}

Various parameters related to the BWP may be configured for the UE, in addition to the above configuration information. The BS may transfer the configuration information to the UE through higher layer signaling such as radio resource control (RRC) signaling. One configured BWP or at least one BWP among multiple configured BWPs may be activated. Whether the configured BWP is activated may be transferred from the BS to the UE semi-statically through RRC signaling, or dynamically through DL control information (DCI).

Before an RRC connection, an initial BWP for initial access may be configured for the UE by the BS through a master information block (MIB). More specifically, the UE may receive configuration information regarding a CORESET and a search space which may be used to transmit a physical downlink control channel (PDCCH) for receiving system information (which may correspond to remaining system information (RMSI) or system information block 1 (SIB1) necessary for initial access through the MIB in the initial access step. Each of the CORESET and the search space configured through the MIB may be considered identity (ID) 0. The BS may notify the UE of configuration information, such as frequency allocation information, time allocation information, and numerology, regarding control resource region #0 through the MIB. In addition, the BS may notify the UE of configuration information regarding the monitoring cycle and occasion in CORESET #0, that is, configuration information regarding search space #0, through the MIB. The UE may consider that a frequency domain configured by CORESET #0 acquired from the MIB is an initial BWP for initial access. The ID of the initial BWP may be 0.

The BWP-related configuration supported by 5G may be used for various purposes. If the bandwidth supported by the UE is less than the system bandwidth, this may be supported through the BWP configuration. For example, the BS may configure the frequency location (configuration information 2) of the BWP for the UE, so that the UE can transmit/receive data at a specific frequency location within the system bandwidth.

The BS may configure multiple BWPs for the UE for the purpose of supporting different numerologies. For example, to support a UE's data transmission/reception using both a subcarrier spacing of 15 kilohertz (kHz) and a subcarrier spacing of 30 kHz, two BWPs may be configured as subcarrier spacings of 15 kHz and 30 kHz, respectively. Different BWPs may be subjected to frequency division multiplexing (FDM), and if data is to be transmitted/received at a specific subcarrier spacing, the BWP configured as the corresponding subcarrier spacing may be activated.

The BS may configure BWPs having different sizes of bandwidths for the UE for the purpose of reducing power consumed by the UE. For example, if the UE supports a substantially large bandwidth such as 100 MHz and always transmits/receives data with the corresponding bandwidth, a substantially large amount of power consumption may occur. Particularly, it may be substantially inefficient from the viewpoint of power consumption to unnecessarily monitor the DL control channel with a large bandwidth of 100 MHz in the absence of traffic. To reduce power consumed by the UE, the BS may configure a BWP of a relatively small bandwidth (for example, a BWP of 20 MHz) for the UE. The UE may perform a monitoring operation in the 20 MHz BWP in the absence of traffic, and may transmit/receive data with the 100 MHz BWP as instructed by the BS if data has occurred.

In connection with the BWP configuring method, UEs, before being RRC-connected, may receive configuration information regarding the initial BWP through an MIB in the initial access step. To be more specific, a UE may have a CORESET configured for a DL control channel which may be used to transmit DCI for scheduling a SIB from the MIB of a physical broadcast channel (PBCH). The bandwidth of the CORESET configured by the MIB may be considered as the initial BWP, and the UE may receive, through the configured initial BWP, a physical DL shared channel (PDSCH) through which an SIB is transmitted. The initial BWP may be used not only for the purpose of receiving the SIB, but also for other system information (OSI), paging, random access, or the like.

### BWP Change

If a UE has one or more BWPs configured therefor, the BS may indicate, to the UE, to change (or switch or transition) the BWPs by using a BWP indicator field inside DCI. As an example, if the currently activated BWP of the UE is BWP #1 301 in FIG. 3, the BS may indicate BWP #2 302 with a BWP indicator inside DCI, and the UE may change the BWP to BWP #2 302 indicated by the BWP indicator inside received DCI.

As described above, DCI-based BWP changing may be indicated by DCI for scheduling a PDSCH or a PUSCH, and thus, upon receiving a BWP change request, the UE needs to be able to receive or transmit the PDSCH or PUSCH scheduled by the corresponding DCI in the changed BWP with no problem. To this end, requirements for the delay time (TBWP) required during a BWP change are specified in standards, and may be defined as shown below in Table 3.

TABLE 3

BWP switch delay T_{BWP} (slots)

| μ | NR Slot length (ms) | Type 1^{Note 1} | Type 2^{Note 1} |
|---|---|---|---|
| 0 | 1 | 1 | 3 |
| 1 | 0.5 | 2 | 5 |
| 2 | 0.25 | 3 | 9 |
| 3 | 0.125 | 6 | 18 |

Note 1:
Depends on UE capability.
Note 2:
If the BWP switch involves changing of SCS, the BWP switch delay is determined by the larger one between the SCS before BWP switch and the SCS after BWP switch.

The requirements for the BWP change delay time support type 1 or type 2, depending on the capability of the UE. The UE may report the supportable BWP change delay time type to the BS.

If the UE has received DCI including a BWP change indicator in slot n, according to the above-described requirement regarding the BWP change delay time, the UE may complete a change to the new BWP indicated by the BWP change indicator at a timepoint not later than slot n+T_{BWP}, and may transmit/receive a data channel scheduled by the corresponding DCI in the newly changed BWP. If the BS wants to schedule a data channel by using the new BWP, the BS may determine time domain resource allocation regarding the data channel, based on the UE's BWP change delay time (TBWP). That is, when scheduling a data channel by using the new BWP, the BS may schedule the corresponding data channel after the BWP change delay time, in connection with the method for determining time domain resource allocation regarding the data channel. Accordingly, the UE may not expect that the DCI that indicates a BWP change will indicate a slot offset (K0 or K2) value smaller than the BWP change delay time (TBWP).

If the UE has received DCI (for example, DCI format 1_1 or 0_1) indicating a BWP change, the UE may perform no transmission or reception during a time interval from the third symbol of the slot used to receive a PDCCH including the corresponding DCI to the start point of the slot indicated by a slot offset (K0 or K2) value indicated by a time domain resource allocation indicator field in the corresponding DCI. For example, if the UE has received DCI indicating a BWP change in slot n, and if the slot offset value indicated by the corresponding DCI is K, the UE may perform no transmission or reception from the third symbol of slot n to the symbol before slot n+K (for example, the last symbol of slot n+K−1).

### Carrier Aggregation (CA)/Dual Connectivity (DC)

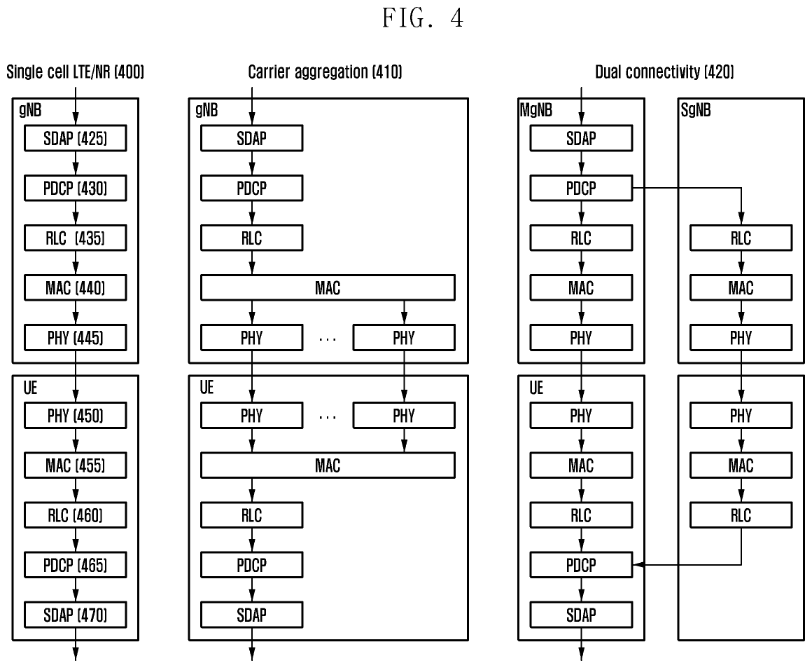

FIG. 4 illustrates radio protocol structures of a BS and a UE in single cell, carrier aggregation, and dual connectivity situations according to an embodiment.

Referring to FIG. 4, a radio protocol of a next-generation mobile communication system includes an NR service data adaptation protocol (SDAP) 425 or 470, an NR packet data convergence protocol (PDCP) 430 or 465, an NR radio link control (RLC) 435 or 460, and an NR medium access controls (MACs) 440 or 455, on each of UE and NR BS sides.

The main functions of the NR SDAP 425 or 470 may include some of functions below.
Transfer of user plane data
Mapping between a quality of service (QoS) flow and a data radio bearer (DRB) for both DL and UL
Marking QoS flow ID in both DL and UL packets
Reflective QoS flow to DRB mapping for the UL SDAP PDUs

In the SDAP layer device, the UE may be configured, through an RRC message, whether to use the header of the SDAP layer device or whether to use functions of the SDAP layer device for each PDCP layer device or each bearer or each logical channel, and if an SDAP header is configured, the non-access stratum (NAS) QoS reflection configuration 1-bit indicator (NAS reflective QoS) and the AS QoS reflection configuration 1-bit indicator (AS reflective QoS) of the SDAP header may be indicated so that the UE can update or reconfigure mapping information regarding the QoS flow and data bearer of the UL and DL. The SDAP header may include QoS flow ID information indicating the QoS. The QoS information may be used as data processing priority, scheduling information, etc. for smoothly supporting services.

The main functions of the NR PDCP 430 or 465 may include some of functions below.
Header compression and decompression: robust header compression (ROHC) only
Transfer of user data
In-sequence delivery of upper layer PDUs
Out-of-sequence delivery of upper layer PDUs
PDCP PDU reordering for reception
Duplicate detection of lower layer SDUs
Retransmission of PDCP SDUs
Ciphering and deciphering
Timer-based SDU discard in UL

The above-mentioned reordering of the NR PDCP device refers to a function of reordering PDCP PDUs received from a lower layer in an order based on the PDCP SN and may include a function of transferring data to an upper layer in the reordered sequence. Alternatively, the reordering of the NR PDCP device may include a function of instantly transferring data without considering the order, may include a function of recording PDCP PDUs lost as a result of reordering, may include a function of reporting the state of the lost PDCP PDUs to the transmitting side, and may include a function of requesting retransmission of the lost PDCP PDUs.

The main functions of the NR RLC 435 or 460 may include some of functions below.
Transfer of upper layer PDUs
In-sequence delivery of upper layer PDUs
Out-of-sequence delivery of upper layer PDUs
Error Correction through automatic repeat request (ARQ)
Concatenation, segmentation and reassembly of RLC SDUs
Re-segmentation of RLC data PDUs
Reordering of RLC data PDUs
Duplicate detection
Protocol error detection
RLC SDU discard
RLC re-establishment

The above-mentioned in-sequence delivery of the NR RLC device refers to a function of delivering RLC SDUs, received from the lower layer to the higher layer in sequence. The in-sequence delivery of the NR RLC device may include a function of, if one original RLC SDU is segmented into multiple RLC SDUs and the segmented RLC SDUs are received, reassembling the RLC SDUs and delivering the reassembled RLC SDUs, may include a function of reordering the received RLC PDUs with reference to the RLC sequence number (SN) or PDCP SN, recording RLC PDUs lost as a result of reordering, reporting the state of the lost RLC PDUs to the transmitting side, and requesting retransmission of the lost RLC PDUs. The in-sequence delivery of the NR RLC device may include a function of, if there is a lost RLC SDU, successively delivering only RLC SDUs before the lost RLC SDU to the upper layer, and if a predetermined timer has expired although there is a lost RLC SDU, successively delivering all RLC SDUs received before the timer was started to the upper layer. Alternatively, the in-sequence delivery of the NR RLC device may include a function of, if a predetermined timer has expired although there is a lost RLC SDU, successively delivering all RLC SDUs received until now to the upper layer. In addition, the in-sequence delivery of the NR RLC device may include a function of processing RLC PDUs in the received order (regardless of the sequence number order, in the order of arrival) and delivering same to the PDCP device regardless of the order (out-of-sequence delivery), and in the case of segments, receiving segments which are stored in a buffer or which are to be received later, reconfiguring same into one complete RLC PDU, processing, and delivering same to the PDCP device. The NR RLC layer may include no concatenation function, which may be performed in the NR MAC layer or replaced with a multiplexing function of the NR MAC layer.

The above-mentioned out-of-sequence delivery of the NR RLC device refers to a function of instantly delivering RLC SDUs received from the lower layer to the upper layer regardless of the order, if multiple RLC SDUs received, into which one original RLC SDU has been segmented, are received, reassembling and delivering the same, and storing the RLC SN or PDCP SN of received RLC PDUs, and recording RLC PDUs lost as a result of reordering.

The NR MAC 440 or 455 may be connected to multiple NR RLC layer devices configured in one UE, and the main functions of the NR MAC may include some of functions below.
Mapping between logical channels and transport channels
Multiplexing/demultiplexing of MAC SDUs
Scheduling information reporting
Error correction through hybrid ARQ (HARQ)
Priority handling between logical channels of one UE
Priority handling between UEs by means of dynamic scheduling
multimedia broadcast multicast service (MBMS) identification
Transport format selection
Padding

An NR PHY layer 445 or 450 may perform operations of channel-coding and modulating upper layer data, thereby obtaining OFDM symbols, and delivering the same through a radio channel, or demodulating OFDM symbols received through the radio channel, channel-decoding the same, and delivering the same to the upper layer.

The detailed structure of the radio protocol structure may vary according to the carrier (or cell) operating scheme. For example, in case that the BS transmits data to the UE, based on a single carrier (or cell), the BS and the UE may use a protocol structure having a single structure in each layer, such as 400. On the other hand, in case that the BS transmits data to the UE, based on CA which uses multiple carriers in a single TRP, the BS and the UE may use a protocol structure which has a single structure up to the RLC, but multiplexes the PHY layer through a MAC layer, such as 410. As another example, in case that the BS transmits data to the UE, based on DC which uses multiple carriers in multiple TRPs, the BS and the UE may use a protocol structure which has a single structure up to the RLC, but multiplexes the PHY layer through a MAC layer, such as 420.

### Unified TCI State

The following is a method for indicating and activating a single TCI state, based on a unified TCI scheme. The unified TCI scheme may refer to a scheme wherein, although the relevant standards have used a TCI state scheme for a UE's DL reception and have used a spatial relation info scheme for uplink transmission (separate transmission/reception beam management scheme), the same is managed in an integrated manner by using a TCI state. Therefore, when a UE receives an indication from a BS, based on the unified TCI scheme, the UE may perform beam management even for uplink transmission by using a TCI state. If the BS has configured a TCI-State (higher layer signaling) having a tci-stateId-r17 (higher layer signaling) for the UE, the UE may perform an operation based on the unified TCI scheme by using the TCI-State. The TCI-State may exist in two types (joint TCI state or separate TCI state).

The first type is a joint TCI state in which all TCI states to be applied to uplink transmission and DL reception may be indicated to a UE by a BS through one TCI-State. If a TCI-State based on a joint TCI state has been indicated to the UE, a parameter to be used for DL channel estimation may be indicated to the UE by using an RS corresponding to quasi co-located (qcl)-Type1 in the TCI-State based on a joint TCI state, and a parameter to be used as a DL reception beam or reception filter may be indicated to the UE by using an RS corresponding to qcl-Type2 therein. If a TCI-State based on a joint TCI state has been indicated to the UE, a parameter to be used as a UL transmission beam or transmission filter may be indicated to the UE by using an RS corresponding to qcl-Type2 therein in the TCI-State based on a joint DL/UL TCI state. If a joint TCI state has been indicated to the UE, the UE may apply the same beam to both uplink transmission and DL reception.

The second type is a separate TCI state, and a UL TCI state to be applied to uplink transmission and a DL TCI state to be applied to DL reception may be individually indicated to a UE by a BS. If a UL TCI state has been indicated to the UE, a parameter to be used as a UL transmission beam or transmission filter may be indicated to the UE by using a reference RS or source RS configured in the UL TCI state. If a DL TCI state has been indicated to the UE, a parameter to be used for DL channel estimation may be indicated to the UE by using an RS corresponding to qcl-Type1 in the DL TCI state, and a parameter to be used as a DL reception beam or reception filter may be indicated to the UE by using an RS corresponding to qcl-Type2 therein.

If both a DL TCI state and a UL TCI state have been indicated to the UE, a parameter to be used as a UL transmission beam or transmission filter may be indicated to the UE by using a reference RS or source RS configured in the UL TCI state, a parameter to be used for DL channel estimation may be indicated to the UE by using an RS corresponding to qcl-Type1 configured in the DL TCI state, and a parameter to be used as a DL reception beam or reception filter may be indicated to the UE by using an RS corresponding to qcl-Type2 configured therein. If the DL TCI state indicated to the UE and the reference RS or source RS configured in the UL TCI state are different, the UE may apply individual beams to uplink transmission and DL reception, respectively, based on the UL TCI state and DL TCI state indicated thereto.

A maximum of 128 joint TCI states may be configured for a particular BWP in a particular cell for the UE by the BS through higher layer signaling, a maximum of 64 or 128 DL TCI states among separate TCI states may be configured for a particular BWP in a particular cell through higher layer signaling, based on a UE capability report, and a DL TCI state among separate TCI states and a joint TCI state may use the same higher layer signaling structure. As an example, if 128 joint TCI states have been configured, and if 64 DL TCI states have been configured among separate TCI states, the 64 DL TCI states may be included in the 128 joint TCI states.

A maximum of 32 or 64 UL TCI states among separate TCI states may be configured for a particular BWP in a particular cell through higher layer signaling, based on a UE capability report, and a UL TCI state among separate TCI states and a joint TCI state may also use the same higher layer signaling structure like the relation between a DL TCI state among separate TCI states and a joint TCI state, or a UL TCI state among separate TCI states may also use a higher layer signaling structure different from that of a joint TCI state and a DL TCI state among separate TCI states.

Such use of different or identical higher layer signaling structures may be defined in specifications or may be distinguished through different higher layer signaling configured by the BS, based on a UE capability report containing information regarding which is to be used among two schemes that the UE may support.

The UE may use one scheme, among a joint TCI state and a separate TCI state configured by the BS, thereby receiving an indication regarding transmission/reception beam according to a unified TCI scheme. The BS may configure, for the UE, whether one of the joint TCI state and the separate TCI state is to be used, through higher layer signaling.

The UE may receive an indication regarding transmission/reception beam by using a scheme selected from a joint TCI state and a separate TCI state through higher layer signaling, and the BS may indicate a transmission/reception beam in two methods (a MAC-CE-based indication method and a MAC-CE-based activation and DCI-based indication method).

If the UE receives an indication regarding transmission/reception beam by using a joint TCI state through higher layer signaling, the UE may receive a MAC-CE indicating a joint TCI state from the BS, thereby performing a transmission/reception beam application operation, and the BS may schedule reception regarding a PDSCH including the MAC-CE for the UE through a PDCCH. If the MAC-CE includes one joint TCI state set, the UE may determine a UL transmission beam or transmission filter and a DL reception beam or reception filter by using joint TCI states included in the indicated joint TCI state set 3 ms after transmission of a PUCCH including HARQ-acknowledgement (ACK) information indicating whether or not the PDSCH is successfully received. If the MAC-CE includes two or more joint TCI state sets, the UE may identify that multiple joint TCI state sets indicated by the MAC-CE correspond to respective codepoints of the TCI state field of DCI format 1_1 or 1_2 and then activate the indicated joint TCI state sets, 3 ms after transmission of a PUCCH including HARQ-ACK information indicating whether or not the PDSCH is successfully received. Thereafter, the UE may receive DCI format 1_1 or 1_2 and may apply one joint TCI state indicated by the TCI state field in corresponding DCI to uplink transmission and DL reception beams. DCI format 1_1 or 1_2 may include DL data channel scheduling information (with DL assignment) or may not include the same (without DL assignment).

If the UE receives an indication regarding transmission/reception beam by using a separate TCI state through higher layer signaling, the UE may receive a MAC-CE indicating a separate TCI state from the BS, thereby performing a transmission/reception beam application operation, and the BS may schedule reception regarding a PDSCH including the MAC-CE for the UE through a PDCCH. If the MAC-CE includes one separate TCI state set, the UE may determine a UL transmission beam or transmission filter and a DL reception beam or reception filter by using separate TCI states included in the indicated separate TCI state set 3 ms after transmission of a PUCCH including HARQ-ACK information indicating whether or not the PDSCH is successfully received. A separate TCI state set may indicate a single or multiple separate TCI states which one codepoint of a TCI state field in DCI format 1_1 or 1_2 may have, and one separate TCI state set may include one DL TCI state, include one UL TCI state, or include one DL TCI state and one UL TCI state. If the MAC-CE includes two or more separate TCI state sets, the UE may identify that multiple separate TCI state sets indicated by the MAC-CE correspond to respective codepoints of the TCI state field of DCI format 1_1 or 1_2 and then activate the indicated separate TCI state sets, 3 ms after transmission of a PUCCH including HARQ-ACK information indicating whether the PDSCH is successfully received.

Each codepoint of the TCI state field of DCI format 1_1 or 1_2 may indicate one DL TCI state, may indicate one UL TCI state, or may indicate one DL TCI state and one UL TCI state. The UE may receive DCI format 1_1 or 1_2 and may apply separate TCI state sets indicated by the TCI state field in corresponding DCI to uplink transmission and DL reception beams. DCI format 1_1 or 1_2 may include DL data channel scheduling information (with DL assignment) or may not include the same (without DL assignment).

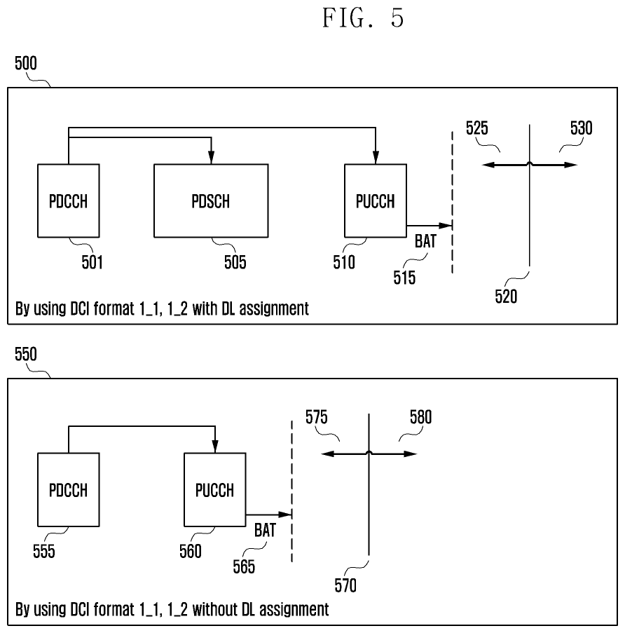

FIG. 5 illustrates a beam application time which may be considered when a unified TCI scheme is used in a wireless communication system according to an embodiment. As described above, the UE may receive DCI format 1_1 or 1_2 including DL data channel scheduling information (with DL assignment) or not including the same (without DL assignment) from the BS, and may apply one joint TCI state or separate TCI state set indicted by the TCI state field in corresponding DCI to uplink transmission and DL reception beams.

Referring to FIG. 5, in DCI format 1_1 or 1_2 with DL assignment (500): If a UE receives, from a BS, DCI format 1_1 or 1_2 including PDCCH scheduling information (501) so that one joint TCI state or one separate TCI state set based on a unified TCI scheme is indicated, the UE may receive a PDSCH scheduled based on the received DCI (505), and transmit a PUCCH including a HARQ-ACK indicating whether reception of the DCI and the PDSCH has been successful (510). The HARQ-ACK may include whether reception has been successful, for both the DCI and the PDSCH, if the UE fails to receive at least one of the DCI and the PDSCH, the UE may transmit a NACK, and if the UE succeeds in receiving both of them, the UE may transmit an ACK.

In DCI format 1_1 or 1_2 without DL assignment (550): If a UE receives, from a BS, DCI format 1_1 or 1_2 not including DL data channel scheduling information (555) so that one joint TCI state or one separate TCI state set based on a unified TCI scheme is indicated, the UE may assume at least one combination of the following items for the DCI.

The DCI includes a CRC scrambled using a CS-RNTI.

The values of all bits assigned to all fields used as redundancy version (RV) fields are 1.

The values of all bits assigned to all fields used as modulation and coding scheme (MCS) fields are 1.

The values of all bits assigned to all fields used as new data indication (NDI) fields are 0.

In frequency domain resource allocation (FDRA) type 0, the values of all bits assigned to an FDRA field are 0, in FDRA type 1, the values of all bits assigned to an FDRA field are 1, and in an FDRA scheme being dynamicSwitch, the values of all bits assigned to an FDRA field are 0.

The UE may transmit a PUCCH including a HARQ-ACK indicating whether DCI format 1_1 or 1_2 for which the items described above are assumed has been successfully received (560).

In both DCI format 1_1 or 1_2 with DL assignment (500) and without DL assignment (550), if the new TCI state indicated through DCI 501 or 555 is the same as a TCI state that has previously been indicated and thus been being applied to uplink transmission and DL reception beams, the UE may maintain the previously applied TCI state. If the new TCI state is different from the previously indicated TCI state, the UE may determine, as a time point for application of the joint TCI state or separate TCI state set, which is indicatable by a TCI state field included in the DCI, a time point 530 or 580 after the first slot 520 or 570 after passage of a time interval as long as a beam application time (BAT) 515 or 565 after PUCCH transmission, and may use the previously indicated TCI state at a time point 525 or 575 before the slot 520 or 570.

In both DCI format 1_1 or 1_2 with DL assignment (500) and without DL assignment (550), the BAT is a particular number of OFDM symbols and may be configured through higher layer signaling, based on UE capability report information, and numerologies of the BAT and the first slot after the BAT may be determined based on the smallest numerology among all cells to which a joint TCI state or separate TCI state set indicated through DCI is applied.

A UE may apply one joint TCI state indicated through a MAC-CE or DCI to reception for control regions connected to all UE-specific search spaces, reception of a PDSCH scheduled by a PDCCH transmitted from the corresponding control region and transmission of a PUSCH, and transmission of all PUCCH resources.

If one separate TCI state set indicated through a MAC-CE or DCI includes one DL TCI state, a UE may apply the one separate TCI state set to reception for control resource regions connected to all UE-specific search spaces and to reception of a PDSCH scheduled by a PDCCH transmitted from the corresponding control region, and apply a previously indicated UL TCI state to all PUSCH and PUCCH resources.

If one separate TCI state set indicated through a MAC-CE or DCI includes one UL TCI state, a UE may apply the one separate TCI state set to all PUSCH and PUCCH resources, and apply a previously indicated DL TCI state to reception for control regions connected to all UE-specific search spaces and reception of a PDSCH scheduled by a PDCCH transmitted from the corresponding control region.

If one separate TCI state set indicated through a MAC-CE or DCI includes one DL TCI state and one UL TCI state, a UE may apply the DL TCI state to reception for CORESETs connected to all UE-specific search spaces and reception of a PDSCH scheduled by a PDCCH transmitted from the CORESETs, and apply the UL TCI state to all PUSCH and PUCCH resources.

### Unified TCI State MAC-CE

A PDSCH including a MAC-CE described below may be scheduled to a UE by a BS, and the UE may interpret each codepoint of a TCI state field in DCI format 1_1 or 1_2, based on information in the MAC-CE received from the BS, after 3 slots from transmission of a HARQ-ACK for the PDSCH to the BS. That is, the UE may activate each entry of the MAC-CE received from the BS in each codepoint of the TCI state field in DCI format 1_1 or 1_2.

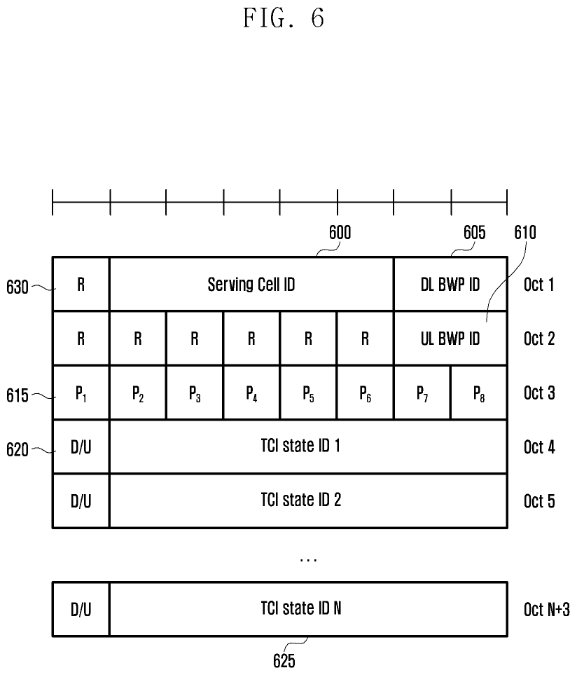

FIG. 6 illustrates another MAC-CE structure for activation and indication of a joint TCI state or a separate DL or UL TCI state in a wireless communication system according to an embodiment. Referring to FIG. 6, each field in the MAC-CE structure may have the following meaning.

Serving Cell ID 600 indicates which serving cell to which a corresponding MAC-CE is to be applied. The length of this field may be 5 bits. If a serving cell indicated by this field is included in at least one of the higher layer signaling simultaneousU-TCI-UpdateList1, simultaneousU-TCI-UpdateList2, simultaneousU-TCI-UpdateList3, or simultaneousU-TCI-UpdateList4, the MAC-CE may be applied to all serving cells included in one or more lists among simultaneousU-TCI-UpdateList1, simultaneousU-TCI-UpdateList2, simultaneousU-TCI-UpdateList3, or simultaneousU-TCI-UpdateList4, in which the serving cell indicated by the field is included.

DL BWP ID 605 indicates which DL BWP to which the MAC-CE is to be applied, and the meanings of codepoints in the field may correspond to codepoints of a BWP indicator in DCI, respectively. The length of this field may be 2 bits.

UL BWP ID 610 indicates which UL BWP to which the MAC-CE is to be applied, and the meanings of codepoints in the field may correspond to codepoints of a BWP indicator in DCI, respectively. The length of this field may be 2 bits.

Pi 615 indicates whether each codepoint of a TCI state field in DCI format 1_1 or 1_2 has multiple TCI states or one TCI state. If the value of Pi is 1, this indicates that a corresponding i-th codepoint has multiple TCI states, and may imply that the codepoint may include a separate DL TCI state and a separate UL TCI state. If the value of Pi is 0, this indicates that a corresponding i-th codepoint has a single TCI state, and may imply that the codepoint may include one type among a joint TCI state, a separate DCI TCI state, or a separate UL TCI state.

D/U 620 indicates whether a TCI state ID field in the same octet is a joint TCI state, a separate DL TCI state, or a separate UL TCI state. If the field is 1, a TCI state ID field in the same octet may be a joint TCI state or a separate DL TCI state, and If the field is 0, a TCI state ID field in the same octet may be a separate UL TCI state.

TCI state ID 625 indicates a TCI state identifiable by the higher layer signaling TCI-StateId. If the D/U field is configured to be 1, the TCI state ID field may be used to represent TCI-StateId expressible by 7 bits. If the D/U field is configured to be 0, a most significant bit (MSB) of the TCI state ID field may be considered as a reserved bit, and the remaining 6 bits may be used to represent the higher layer signaling UL-TCIState-Id. The number of maximally activatable TCI states may be 8 in joint TCI states and may be 16 in separate DL or UL TCI states.

R indicates a reserved bit and may be configured to be 0.

In the MAC-CE structure of FIG. 6, a UE may include, in the MAC-CE structure, a third octet including P1, P2, . . . , and P8 fields in FIG. 6 regardless of unifiedTCI-StateType-r17 in MIMOparam-r17 in the higher layer signaling ServingCellConfig being configured to be joint or separate. In this case, the UE may perform TCI state activation by using a fixed MAC-CE structure regardless of higher layer signaling configured by a BS. As another example, in the MAC-CE structure of FIG. 6, a UE may omit the third octet including P1, P2, . . . , and P8 fields illustrated in FIG. 6, when unifiedTCI-StateType-r17 in MIMOparam-r17 in the higher layer signaling ServingCellConfig being configured to be joint. In this case, the UE may save the payload of the MAC-CE by a maximum of 8 bits according to higher layer signaling configured by a BS. In addition, all D/U fields positioned on the first bits in octets starting from a fourth octet in FIG. 6 may be considered as R fields, and all the R fields may be configured to be 0 bits.

### CSI Resource Setting

In NR, a BS employs a CSI) framework to instruct a UE to measure and report CSI. The CSI framework in the NR may include at least two components of a resource setting and a report setting. The report setting may have an association between the two components by referencing at least one resource setting ID.

According to an embodiment, the resource setting may include information related to a reference signal (RS) for measuring CSI by a UE. The BS may configure at least one resource setting for the UE. For example, the BS and the UE may exchange signaling information such as Table 4 below to transmit information about the resource setting.

TABLE 4
-- ASN1START
-- TAG-CSI-RESOURCECONFIG-START

| | |
|---|---|
| CSI-ResourceConfig ::= | SEQUENCE { |
| csi-ResourceConfigId | CSI-ResourceConfigId, |
| csi-RS-ResourceSetList | CHOICE { |

```
    non zero power (nzp)-CSI-RS-synchronization signal block (SSB)
SEQUENCE {
      nzp-CSI-RS-ResourceSetList SEQUENCE (SIZE (1..maxNrofNZP-CSI-RS-
ResourceSetsPerConfig)) OF NZP-CSI-RS-ResourceSetId
OPTIONAL, -- Need R
      csi-SSB-ResourceSetList SEQUENCE (SIZE (1..maxNrofCSI-SSB-
ResourceSetsPerConfig)) OF CSI-SSB-ResourceSetId
OPTIONAL -- Need R
    },
    csi-interference measurement (IM)-ResourceSetList SEQUENCE (SIZE
(1..maxNrofCSI-IM-ResourceSetsPerConfig)) OF CSI-IM-ResourceSetId
  },
```

| | |
|---|---|
| bwp-Id | BWP-Id, |
| resourceType | ENUMERATED { aperiodic, semiPersistent, periodic }, |

...
}
-- TAG-CSI-RESOURCECONFIG-STOP
-- ASN1STOP

In Table 4, the signaling information CSI-ResourceConfig includes information about each resource setting. According to the above signaling information, each resource setting may include a resource setting index (csi-ResourceConfigId), a BWP index (bwp-ID), a time axis transmission configuration of the resource (resourceType), or a resource set list (csi-RS-ResourceSetList) including at least one resource set. The time axis transmission configuration of the resource may be configured by aperiodic transmission, semi-persistent transmission, or periodic transmission. The resource set list may be a set including resource sets for channel measurement or a set including resource sets for IM. In case that the resource set list is a set including resource sets for channel measurement, each resource set may include at least one resource and may be an index of a CSI reference signal (CSI-RS) resource or a synchronization/broadcast channel block (SS/PBCH block (SSB)). In case that the resource set list is a set that includes resource sets for IM, each resource set may include at least one CSI-IM).

For example, when the resource set includes CSI-RS, the BS and the UE may exchange signaling information such as in Table 5 below to transfer information about the resource set.

TABLE 5
-- ASN1START
-- TAG-NZP-CSI-RS-RESOURCESET-START

| | |
|---|---|
| NZP-CSI-RS-ResourceSet ::= | SEQUENCE { |
| nzp-CSI-ResourceSetId | NZP-CSI-RS-ResourceSetId, |
| nzp-CSI-RS-Resources | SEQUENCE (SIZE |

(1..maxNrofNZP-CSI-RS-ResourcesPerSet)) OF NZP-CSI-RS-ResourceId,

| | |
|---|---|
| repetition | ENUMERATED { on, off } |

OPTIONAL, -- Need S

| | |
|---|---|
| aperiodicTriggeringOffset | INTEGER(0..6) |

OPTIONAL, -- Need S

| | |
|---|---|
| trs-Info | ENUMERATED {true} |

OPTIONAL, -- Need R
...
}
-- TAG-NZP-CSI-RS-RESOURCESET-STOP
-- ASN1STOP

In Table 5, the signaling information NZP-CSI-RS-ResourceSet includes information about each resource set. According to the signaling information, each resource set at least includes information about the resource set index (nzp-CSI-ResourceSetId) or the index set of the included CSI-RS (nzp-CSI-RS-Resources), and may include part of information about the spatial domain transmission filter of the included CSI-RS resource (repetition) or whether the included CSI-RS resource is used for tracking (trs-Info).

CSI-RS may be the most representative reference signal included in the resource set. The BS and the UE may exchange signaling information such as in Table 6 below to transfer 10 information about the CSI-RS resource.

TABLE 6
-- ASN1START
-- TAG-NZP-CSI-RS-RESOURCE-START

| | |
|---|---|
| NZP-CSI-RS-Resource ::= | SEQUENCE { |
| nzp-CSI-RS-ResourceId | NZP-CSI-RS-ResourceId, |
| resourceMapping | CSI-RS-ResourceMapping, |
| powerControlOffset | INTEGER (−8..15), |
| powerControlOffsetSS | ENUMERATED{db−3, db0, db3, db6} |

OPTIONAL, -- Need R

| | |
|---|---|
| scramblingID | ScramblingId, |
| periodicityAndOffset | CSI-ResourcePeriodicityAndOffset |

OPTIONAL, -- Cond PeriodicOrSemiPersistent

| | |
|---|---|
| qcl-InfoPeriodicCSI-RS | TCI-StateId |

OPTIONAL, -- Cond Periodic
...
}
-- TAG-NZP-CSI-RS-RESOURCE-STOP
-- ASN1STOP

In Table 6, the signaling information NZP-CSI-RS-Resource includes information about each CSI-RS. The information included in the signaling information NZP-CSI-RS-Resource may have the following meanings.
nzp-CSI-RS-ResourceId: CSI-RS resource index
resourceMapping: Resource mapping information of CSI-RS resource
powerControlOffset: Ratio between PDSCH energy per RE (EPRE) and CSI-RS EPRE
powerControlOffsetSS: Ratio between SS/PBCH block EPRE and CSI-RS EPRE
scramblingID: Scrambling index of CSI-RS sequence
periodicity AndOffset: Transmission period and slot offset of CSI-RS resource
qcl-InfoPeriodicCSI-RS: TCI-state information when the corresponding CSI-RS is a periodic CSI-RS

The resourceMapping included in the signaling information NZP-CSI-RS-Resource indicates resource mapping information of the CSI-RS resource and may include an RE mapping for frequency resources, the number of ports, symbol mapping, code division multiplexing (CDM) type, frequency resource density, and frequency band mapping information. Each of the number of ports, frequency resource density, CDM type, and time-frequency domain RE mapping, which may be configured through the resource mapping information, may have a determined value in one of the rows shown in Table 7 below.

TABLE 7

| | Ports | Density | | | CDM group | | |
|---|---|---|---|---|---|---|---|
| Row | X | ρ | cdm-Type | (k̅, l̅) | index j | k′ | l′ |
| 1 | 1 | 3 | noCDM | (k₀, l₀), (k₀ + 4, l₀), (k₀ + 8, l₀) | 0, 0, 0 | 0 | 0 |
| 2 | 1 | 1, 0.5 | noCDM | (k₀, l₀), | 0 | 0 | 0 |
| 3 | 2 | 1, 0.5 | fd-CDM2 | (k₀, l₀), | 0 | 0, 1 | 0 |
| 4 | 4 | 1 | fd-CDM2 | (k₀, l₀), (k₀ + 2, l₀) | 0, 1 | 0, 1 | 0 |
| 5 | 4 | 1 | fd-CDM2 | (k₀, l₀), (k₀, l₀ + 1) | 0, 1 | 0, 1 | 0 |
| 6 | 8 | 1 | fd-CDM2 | (k₀, l₀), (k₁, l₀), (k₂, l₀), (k₃, l₀) | 0, 1, 2, 3 | 0, 1 | 0 |
| 7 | 8 | 1 | fd-CDM2 | (k₀, l₀), (k₁, l₀), (k₀, l₀ + 1), | 0, 1, 2, 3 | 0, 1 | 0 |
| | | | | (k₁, l₀ + 1) | | | |
| 8 | 8 | 1 | cdm4- | (k₀, l₀), (k₁, l₀) | 0, 1 | 0, 1 | 0, 1 |
| | | | FD2-TD2 | | | | |
| 9 | 12 | 1 | fd-CDM2 | (k₀, l₀), (k₁, l₀), (k₂, l₀), | 0, 1, 2, 3, | 0, 1 | 0 |
| | | | | (k₃, l₀), (k₄, l₀), (k₅, l₀) | 4, 5 | | |
| 10 | 12 | 1 | cdm4- | (k₀, l₀), (k₁, l₀), (k₂, l₀) | 0, 1, 2 | 0, 1 | 0, 1 |
| | | | FD2-TD2 | | | | |
| 11 | 16 | 1, 0.5 | fd-CDM2 | (k₀, l₀), (k₁, l₀), (k₂, l₀) | 0, 1, 2, 3, | 0, 1 | 0 |
| | | | | (k₃, l₀), (k₀, l₀ + 1), (k₁, l₀ + 1), | 4, 5, 6, 7 | | |
| | | | | (k₂, l₀ + 1), (k₃, l₀ + 1) | | | |
| 12 | 16 | 1, 0.5 | cdm4- | (k₀, l₀), (k₁, l₀), (k₂, l₀), (k₃, l₀) | 0, 1, 2, 3 | 0, 1 | 0, 1 |
| | | | FD2-TD2 | | | | |
| 13 | 24 | 1, 0.5 | fd-CDM2 | (k₀, l₀), (k₁, l₀), (k₂, l₀), (k₀, l₀ + | 0, 1, 2, 3, | 0, 1 | 0 |
| | | | | 1), (k₁, l₀ + 1), (k₂, l₀ + | 4, 5, 6, 7, | | |
| | | | | 1), (k₀, l₁), (k₁, l₁), (k₂, l₁), | 8, 9, 10, 11 | | |
| | | | | (k₀, l₁ + 1), (k₁, l₁ + 1), (k₂, l₁ + 1) | | | |
| 14 | 24 | 1, 0.5 | cdm4- | (k₀, l₀), (k₁, l₀), (k₂, l₀), (k₀, l₁), | 0, 1, 2, 3, | 0, 1 | 0, 1 |
| | | | FD2-TD2 | (k₁, l₁), (k₂, l₁) | 4, 5 | | |
| 15 | 24 | 1, 0.5 | cdm8- | (k₀, l₀), (k₁, l₀), (k₂, l₀) | 0, 1, 2 | 0, 1 | 0, 1, |
| | | | FD2-TD4 | | | | 2, 3 |
| 16 | 32 | 1, 0.5 | fd-CDM2 | (k₀, l₀), (k₁, l₀), (k₂, l₀), | 0, 1, 2, 3, | 0, 1 | 0 |
| | | | | (k₃, l₀), (k₀, l₀ + 1), (k₁, l₀ + 1), | 4, 5, 6, 7, | | |
| | | | | (k₂, l₀ + 1), (k₃, l₀ + 1), (k₀, l₁), | 8, 9, 10, 11, | | |
| | | | | (k₁, l₁), (k₂, l₁), (k₃, l₁), (k₀, l₁ + 1), | 12, 13, 14, 15 | | |
| | | | | (k₁, l₁ + 1), (k₂, l₁ + 1), (k₃, l₁ + 1) | | | |
| 17 | 32 | 1, 0.5 | cdm4- | (k₀, l₀), (k₁, l₀), (k₂, l₀), (k₃, l₀), | 0, 1, 2, 3, 4, | 0, 1 | 0, 1 |
| | | | FD2-TD2 | (k₀, l), (k₁, l₁), (k₂, l₁), (k₃, l₁) | 5, 6, 7 | | |
| 18 | 32 | 1, 0.5 | cdm8- | (k₀, l₀), (k₁, l₀), (k₂, l₀), (k₃, l₀) | 0, 1, 2, 3 | 0, 1 | 0, 1, |
| | | | FD2-TD4 | | | | 2, 3 |

Table 7 shows a frequency resource density configurable according to the number (X) of CSI-RS ports, a CDM type, frequency and time domain starting positions (k̅, l̅) of a CSI-RS component RE pattern, and the number (k′) of frequency domain REs and the number (l′) of time domain REs of a CSI-RS component RE pattern. The CSI-RS component RE pattern described above may be a basic unit for configuring a CSI-RS resource. The CST-RS component RE pattern may be configured by YZ number of REs through Y=1+max(k′) number of frequency domain REs and Z=1+max(l′) number of time domain REs. In case that the number of CSI-RS ports is 1, the position of a CSI-RS RE may be designated in a physical RB (PRB) without restriction on subcarriers and may be designated by a bitmap having 12 bits. In case that the number of CSI-RS ports is {2, 4, 8, 12, 16, 24, 32} ports, and Y=2, the position of a CST-RS RE may be designated at every two subcarriers in a PRB and may be designated by a bitmap having 6 bits. In case that the number of CSI-RS ports is 4, and Y=4, the position of a CSI-RS RE may be designated at every four subcarriers in a PRB and may be designated by a bitmap having 3 bits. Similarly, the position of a time domain RE may be designated by a bitmap having a total of 14 bits.

### CSI Report Configuration

The report setting may have an association with at least one resource setting by referencing the ID of the resource setting. The resource setting(s) associated with the report setting may provide configuration information including information on reference signals for channel measurement. When the resource setting(s) associated with the report setting are used for channel measurement, the measured channel information may be used for reporting the channel information according to the reporting method defined in the associated report setting.

The report setting may include configuration information related to the CSI reporting method. For example, the BS and the UE may exchange signaling information such as in Table 8 below to transmit information about the report setting.

TABLE 8
-- ASN1START
-- TAG-CSI-REPORTCONFIG-START

| CSI-ReportConfig ::= | SEQUENCE { | |
|---|---|---|
| reportConfigId | CSI-ReportConfigId, | |
| carrier | ServCellIndex | OPTIONAL, |

-- Need S

| resourcesForChannelMeasurement | CSI-ResourceConfigId, | |
|---|---|---|
| csi-IM-ResourcesForInterference | CSI-ResourceConfigId | OPTIONAL, - |

- Need R

| | | |
|---|---|---|
| nzp-CSI-RS-ResourcesForInterference | CSI-ResourceConfigId | OPTIONAL, - |

- Need R

| | |
|---|---|
| reportConfigType | CHOICE { |
| periodic | SEQUENCE { |
| reportSlotConfig | CSI-ReportPeriodicityAndOffset, |
| pucch-CSI-ResourceList | SEQUENCE (SIZE (1..maxNrofBWPs)) |

OF PUCCH-CSI-Resource
},

| | |
|---|---|
| semiPersistentOnPUCCH | SEQUENCE { |
| reportSlotConfig | CSI-ReportPeriodicityAndOffset, |
| pucch-CSI-ResourceList | SEQUENCE (SIZE (1..maxNrofBWPs)) |

OF PUCCH-CSI-Resource
},

| | |
|---|---|
| semiPersistentOnPUSCH | SEQUENCE { |
| reportSlotConfig | ENUMERATED {sl5, sl10, sl20, sl40, |

sl80, sl160, sl320},

| | |
|---|---|
| reportSlotOffsetList | SEQUENCE (SIZE (1..maxNrofUL-Allocations)) |

OF INTEGER(0..32),

| | |
|---|---|
| p0alpha | P0-PUSCH-AlphaSetId |

},

| | |
|---|---|
| aperiodic | SEQUENCE { |
| reportSlotOffsetList | SEQUENCE (SIZE (1..maxNrofUL-Allocations)) |

```
OF INTEGER(0..32)
  }
  },
```

| | |
|---|---|
| reportQuantity | CHOICE { |
| none | NULL, |
| cri-RI-PMI-CQI | NULL, |
| cri-RI-i1 | NULL, |
| cri-RI-i1-CQI | SEQUENCE { |
| pdsch-BundleSizeForCSI | ENUMERATED {n2, n4} |

OPTIONAL -- Need S
}

| | |
|---|---|
| cri-RI-CQI | NULL, |
| cri-RSRP | NULL, |
| ssb-Index-RSRP | NULL, |
| cri-RI-LI-PMI-CQI | NULL |

},

| | |
|---|---|
| reportFreqConfiguration | SEQUENCE { |
| cqi-FormatIndicator | ENUMERATED { widebandCQI, subbandCQI } |

OPTIONAL, -- Need R

| | |
|---|---|
| pmi-FormatIndicator | ENUMERATED { widebandPMI, |
| subbandPMI } | OPTIONAL, -- Need R |
| csi-ReportingBand | CHOICE { |
| subbands3 | BIT STRING(SIZE(3)), |
| subbands4 | BIT STRING(SIZE(4)), |
| subbands5 | BIT STRING(SIZE(5)), |
| subbands6 | BIT STRING(SIZE(6)), |
| subbands7 | BIT STRING(SIZE(7)), |
| subbands8 | BIT STRING(SIZE(8)), |
| subbands9 | BIT STRING(SIZE(9)), |
| subbands10 | BIT STRING(SIZE(10)), |
| subbands11 | BIT STRING(SIZE(11)), |
| subbands12 | BIT STRING(SIZE(12)), |
| subbands13 | BIT STRING(SIZE(13)), |
| subbands14 | BIT STRING(SIZE(14)), |
| subbands15 | BIT STRING(SIZE(15)), |
| subbands16 | BIT STRING(SIZE(16)), |
| subbands17 | BIT STRING(SIZE(17)), |
| subbands18 | BIT STRING(SIZE(18)), |

...,

| | |
|---|---|
| subbands19-v1530 | BIT STRING(SIZE(19)) |

```
  } OPTIONAL -- Need S
  }
OPTIONAL, -- Need R
```

| | |
|---|---|
| timeRestrictionForChannelMeasurements | ENUMERATED {configured, |

notConfigured},

| | |
|---|---|
| timeRestrictionForInterferenceMeasurements | ENUMERATED {configured, notConfigured}, |
| codebookConfig | CodebookConfig |

OPTIONAL, -- Need R

| | |
|---|---|
| dummy | ENUMERATED {n1, n2} |

OPTIONAL, -- Need R

| | |
|---|---|
| groupBasedBeamReporting | CHOICE { |
| enabled | NULL, |
| disabled | SEQUENCE { |
| nrofReportedRS | ENUMERATED {n1, n2, n3, n4} |

```
OPTIONAL -- Need S
  }
  },
```

| | |
|---|---|
| cqi-Table | ENUMERATED {table1, table2, table3, spare1} |

OPTIONAL, -- Need R

| | |
|---|---|
| subbandSize | ENUMERATED {value1, value2}, |
| non-PMI-PortIndication | SEQUENCE (SIZE (1..maxNrofNZP-CSI-RS-ResourcesPerConfig)) |

```
OF PortIndexFor8Ranks OPTIONAL, -- Need R
  ...,
  [[
```

| | |
|---|---|
| semiPersistentOnPUSCH-v1530 | SEQUENCE { |
| reportSlotConfig-v1530 | ENUMERATED {sl4, sl8, sl16} |

```
  }
OPTIONAL -- Need R
  ]]
}
```

In Table 8, the signaling information CSI-ReportConfig includes information on each report setting. The information included in the signaling information CSI-ReportConfig may have the following meanings.
reportConfigId: report setting index
carrier: serving cell index
resourcesForChannelMeasurement: resource setting index for channel measurement that has an association with report setting
csi-IM-ResourcesForInterference: Resource setting index that has CSI-IM resources for IM that has an association with report setting
nzp-CSI-RS-ResourcesForInterference: Resource setting index that has CSI-RS resources for IM that has an association with report setting
reportConfigType: Indicates the time domain transmission configuration and transmission channel of channel report, and may have aperiodic transmission, semi-persistent PUCCH transmission, or semi-periodic PUSCH transmission or periodic transmission configuration
reportQuantity: Indicates the type of channel information to be reported, and the type of channel information in case of refraining from transmitting channel report (“none”) and transmitting channel report (“cri-RI-PMI-CQI”, “cri-RI-i1”, “cri-RI-i1-CQI”, “cri-RI-CQI”, “cri-RSRP”, “ssb-Index-RSRP”, “cri-RI-L1-PMI-CQI”). The elements included in the type of channel information refer to channel quality indicator (CQI), precoding matric indicator (PMI), CSI-RS resource indicator (CRI), SS/PBCH block resource indicator (SSBRI), layer indicator (LI), rank indicator (RI), and/or L1-reference signal received power (RSRP).
reportFreqConfiguration: Indicates whether the reported channel information includes only information about the entire band (wideband) or information about each subband. When the reported channel information includes information about each subband, it may have configuration information about the subband in which the channel information is included.
timeRestrictionForChannelMeasurements: Whether the reference signal for channel measurement among the reference signals referenced by the reported channel information has time domain restrictions.
timeRestrictionForInterferenceMeasurements: Whether the reference signal for IM among the reference signals referenced by the reported channel information has time domain restrictions.
codebookConfig: Codebook information referenced by the reported channel information.
groupBasedBeamReporting: Whether beam grouping of channel reporting is performed.
cqi-Table: CQI table index referenced by the reported channel information.
subbandSize: Index indicating the subband size of the channel information.
non-PMI-PortIndication: Port mapping information referenced when reporting non-PMI channel information.

When the BS instructs channel information reporting via higher layer signaling or L1 signaling, the UE may perform channel information reporting by referring to the above-mentioned configuration information included in the instructed report setting.

The BS may instruct the UE to report CSI via higher layer signaling including RRC signaling or MAC control element (CE) signaling, or L1 signaling (e.g., common DCI, group-common DCI, UE-specific DCI).

For example, the BS may instruct the UE to report aperiodic channel information (CSI report) via higher layer signaling or DCI using DCI format 0_1. The BS configures multiple CSI report trigger states including parameters for the aperiodic CSI report of the UE, or parameters for the CSI report, via higher layer signaling. The parameters for the CSI report or the CSI report trigger state may include a set including a slot spacing or possible slot spacing between the PDCCH including the DCI and the PUSCH including the CSI report, a reference signal ID for channel state measurement, the type of channel information included, and the like. When the BS indicates some of the multiple CSI report trigger states to the UE through the DCI, the UE reports channel information according to the CSI report configuration of the report setting configured in the indicated CSI report trigger state. The channel information reporting may be performed through the PUSCH scheduled in DCI format 0_1. The time domain resource allocation of the PUSCH including the CSI report of the UE may be performed through the slot spacing with the PDCCH indicated through the DCI, the start symbol and symbol length indication within the slot for the time domain resource allocation of the PUSCH, and the like. For example, the position of a slot in which the PUSCH including the CSI report of the UE is transmitted may be indicated through the slot spacing with the PDCCH indicated through the DCI, and the start symbol and symbol length within the slot may be indicated through the time domain resource assignment field of the DCI described above.

For example, the BS may instruct the UE to perform semi-persistent CSI report transmitted on the PUSCH through the DCI using DCI format 0_1. The BS may activate or deactivate the semi-persistent CSI report transmitted on the PUSCH through DCI scrambled by SP-CSI-RNTI. When the semi-persistent CSI report is activated, the UE may periodically report channel information according to a configured slot spacing. When the semi-persistent CSI report is deactivated, the UE may stop the activated periodic channel information reporting. The BS configures a parameter for the semi-persistent CSI report of the UE or multiple CSI report trigger states including the parameter for the semi-persistent CSI report via higher layer signaling. Parameters for CSI report or CSI report trigger state may include a set including a slot spacing or possible slot spacing between a PDCCH including DCI indicating CSI report and a PUSCH including the CSI report, a slot spacing between a slot in which higher layer signaling indicating CSI report is activated and a PUSCH including the CSI report, a slot spacing periodicity of the CSI report, a type of channel information included, and the like. When the BS activates some of multiple CSI report trigger states or some of multiple report settings to the UE via higher layer signaling or DCI, the UE may report channel information according to a report setting included in the indicated CSI report trigger state or CSI report configuration configured in the activated report setting. The channel information reporting may be performed through a PUSCH semi-persistently scheduled with DCI format 0_1 scrambled by SP-CSI-RNTI. The time domain resource allocation of the PUSCH including the CSI report of the UE may be performed through a slot spacing periodicity of the CSI report, a slot spacing with respect to a slot in which higher layer signaling is activated, a slot spacing with respect to the PDCCH indicated through DCI, the start symbol and symbol length indication within a slot for the time domain resource allocation of the PUSCH, and the like. For example, the position of the slot in which the PUSCH including the CSI report of the UE is transmitted may be indicated through the slot spacing with respect to the PDCCH indicated through DCI, and the start symbol and symbol length within the slot may be indicated through the time domain resource assignment field of the DCI format 0_1 described above.

For example, the BS may instruct the UE to perform a semi-persistent CSI report transmitted on a PUCCH via higher layer signaling such as MAC-CE. Through the MAC-CE signaling, the BS may activate or deactivate the semi-persistent CSI report transmitted on the PUCCH. When the semi-persistent CSI report is activated, the UE may periodically report channel information according to the configured slot spacing. When the semi-persistent CSI report is deactivated, the UE may stop the periodic channel information reporting that has been activated. The BS configures parameters for the semi-persistent CSI report of the UE via higher layer signaling. The parameters for the CSI report may include the PUCCH resource through which the CSI report is transmitted, the slot spacing periodicity of the CSI report, and the types of channel information included. The UE may transmit the CSI report through the PUCCH. Alternatively, when the PUCCH for the CSI report overlaps with a PUSCH, the UE may transmit the CSI report through the PUSCH. The position of the PUCCH transmission slot including the CSI report may be indicated by the slot spacing periodicity of the CSI report configured through the higher layer signaling and the slot spacing between the slot where the higher layer signaling is activated and the PUCCH including the CSI report. The start symbol and symbol length within the slot may be indicated by the start symbol, to which the PUCCH resource configured via higher layer signaling is assigned, and symbol length.

For example, the BS may instruct the UE to perform periodic CSI report via higher layer signaling. The BS may activate or deactivate the periodic CSI report via higher layer signaling including RRC signaling. When the periodic CSI report is activated, the UE may report channel information periodically according to the configured slot spacing. When periodic CSI reports are deactivated, the UE may stop the previously activated periodic channel information reporting. The BS configures the report setting, which includes parameters for the periodic CSI report of the UE, via higher layer signaling. The parameters for the CSI report may include PUCCH resource configuration for the CSI report, a slot spacing between the PUCCH containing the CSI report and a slot in which the higher layer signaling indicating the CSI report is activated, a slot spacing periodicity of the CSI report, a reference signal ID for channel state measurement, and the type of channel information included. The UE may transmit the CSI report through the PUCCH. Alternatively, when the PUCCH for the CSI report overlaps with a PUSCH, the UE may transmit the CSI report through the PUSCH. The position of the slot in which the PUCCH containing the CSI report is transmitted may be indicated by the slot spacing periodicity of the CSI report configured through the higher layer signaling and the slot spacing between the slot where the higher layer signaling is activated and the PUCCH including the CSI report. The start symbol and symbol length within the slot may be indicated by the start symbol, to which the PUCCH resource configured via higher layer signaling is assigned, and symbol length.

In the aforementioned CSI report settings (CSI-ReportConfig), each report setting CSI-ReportConfig may be associated with one DL BWP identified by a higher-layer parameter BWP identifier (bwp-id) given by CSI resource setting CSI-ResourceConfig associated with the corresponding report setting. As time domain reporting for each report setting CSI-ReportConfig, “aperiodic”, “semi-persistent”, and “periodic” schemes may be supported, and these schemes may be configured for the UE by the BS via a reportConfigType parameter configured from a higher layer. A semi-persistent CSI report method may support a “PUCCH-based semi-persistent (semi-PersistentOnPUCCH)” method and a “PUSCH-based semi-persistent (semi-PersistentOnPUSCH)” method. In the case of the periodic or semi-persistent CSI report method, a PUCCH or PUSCH resource in which CSI is to be transmitted may be configured for the UE by the BS via higher-layer signaling. A periodicity and a slot offset of the PUCCH or PUSCH resource in which CSI is to be transmitted may be given by a numerology of a UL BWP configured for CSI report transmission. For the aperiodic CSI report method, a PUSCH resource in which CSI is to be transmitted may be scheduled for the UE by the BS via L1 signaling (e.g., aforementioned DCI format 0_1).

In the aforementioned CSI resource settings (CSI-ResourceConfig), each CSI resource setting CSI-ReportConfig may include S (≥1) CSI resource sets (e.g., given via a higher-layer parameter of csi-RS-ResourceSetList). A CSI resource set list may include an NZP CSI-RS resource set and an SS/PBCH block set or may include a CSI-IM resource set. Each CSI resource setting may be positioned in a DL BWP identified by higher-layer parameter bwp-id and may be connected to CSI report setting in the same DL BWP. A time domain operation of a CSI-RS resource in CSI resource setting may be configured to be one of “aperiodic”, “periodic”, or “semi-persistent” from the higher-layer parameter resourceType. In the periodic or semi-persistent CSI resource setting, the number of CSI-RS resource sets may be limited to S (S=1), and the configured periodicity and slot offset may be given based on numerology of the DL BWP identified by bwp-id. One or more CSI resource settings for channel or interference measurement may be configured for the UE by the BS via higher-layer signaling, and may include the following CSI resources.
CSI-IM resource for IM
NZP CSI-RS resource for IM
NZP CSI-RS resource for channel measurement

In CSI-RS resource sets associated with a resource setting in which the higher-layer parameter of resource Type is configured to be “aperiodic”, “periodic”, or “semi-persistent”, a trigger state of CSI report setting having reportType configured to be “aperiodic”, and a resource setting for channel or IM on one or multiple component cells (CCs) may be configured via the higher-layer parameter of CSI-AperiodicTriggerStateList.

Aperiodic CSI reporting of the UE may be performed using a PUSCH, periodic CSI reporting may be performed using a PUCCH, and semi-persistent CSI reporting may be performed using a PUSCH when triggered or activated via DCI and may be performed using a PUCCH after activated via a MAC CE. As described above, a CSI resource setting may also be configured to be aperiodic, periodic, or semi-persistent. A combination of CSI reporting setting and CSI resource setting may be supported based on Table 9 below.

TABLE 9

| CSI-RS | | Semi-Persistent CSI | Aperiodic CSI |
|---|---|---|---|
| Configuration | Periodic CSI Reporting | Reporting | Reporting |
| Periodic CSI-RS | No dynamic | For reporting on PUCCH, | Triggered by DCI; |
| | triggering/activation | the UE receives an activation | additionally, activation |
| | | command [10, TS 38.321]; | command [10, TS |
| | | for reporting on PUSCH, the | 38.321] possible as |
| | | UE receives triggering on | defined in Subclause |
| | | DCI | 5.2.1.5.1. |
| Semi-Persistent | Not Supported | For reporting on PUCCH, | Triggered by DCI; |
| CSI-RS | | the UE receives an activation | additionally, activation |
| | | command [10, TS 38.321]; | command [10, TS |
| | | for reporting on PUSCH, the | 38.321] possible as |
| | | UE receives triggering on | defined in Subclause |
| | | DCI | 5.2.1.5.1. |
| Aperiodic CSI-RS | Not Supported | Not Supported | Triggered by DCI; |
| | | | additionally, activation |
| | | | command [10, TS |
| | | | 38.321] possible as |
| | | | defined in Subclause |
| | | | 5.2.1.5.1. |

Aperiodic CSI reporting may be triggered by a “CSI request” field in DCI format 0_1 described above, which corresponds to scheduling DCI for a PUSCH. The UE may monitor a PDCCH, may acquire DCI format 0_1, and may acquire scheduling information of a PUSCH and a CSI request indicator. The CSI request indicator may be configured to have N_{TS} (=0, 1, 2, 3, 4, 5, or 6) bits, and may be determined by higher-layer signaling (reportTriggerSize).

One trigger state among one or multiple aperiodic CSI report trigger states which may be configured via higher-layer signaling (CSI-AperiodicTriggerStateList) may be triggered by the CSI request indicator.

If all bits in the CSI request field are 0, this may indicate that CSI reporting is not requested.

If the number M of configured CSI trigger states in CSI-AperiodicTriggerStateLite is greater than 2N_{Ts}−1, M CSI trigger states may be mapped to 2N_{Ts}−1 trigger states according to a predefined mapping relation, and one trigger state among the 2N_{Ts}−1 trigger states may be indicated by the CSI request field.

If the number M of configured CSI trigger states in CSI-AperiodicTriggerStateLite is less than or equal to 2N_{Ts}−1, one of the M CSI trigger states may be indicated by the CSI request field.

Table 10 below shows an example of a relationship between a CSI request indicator and a CSI trigger state that may be indicated by a corresponding indicator.

TABLE 10

| CSI | | | |
|---|---|---|---|
| request | | | CSI- |
| field | CSI trigger state | CSI-ReportConfigId | ResourceConfigId |
| 00 | no CSI request | N/A | N/A |
| 01 | CSI trigger state#1 | CSI report#1 | CSI resource#1, |
| | | CSI report#2 | CSI resource#2 |
| 10 | CSI trigger state#2 | CSI report#3 | CSI resource#3 |
| 11 | CSI trigger state#3 | CSI report#4 | CSI resource#4 |

The UE may measure a CSI resource in a CSI trigger state triggered via the CSI request field, and then generate CSI (including at least one of the CQI, PMI, CRI [PLEASE DEFINE], SSBRI, LI, RI, or L1-RSRP described above) based on the measurement. The UE may transmit the acquired CSI by using the PUSCH scheduled via corresponding DCI format 0_1. If one bit corresponding to a UL data indicator (UL-SCH indicator) in DCI format 0_1 indicates “1”, the UE may multiplex the UL-SCH and the acquired CSI on the PUSCH resource scheduled by DCI format 0_1 so as to transmit the same. If one bit corresponding to the UL-SCH indicator in DCI format 0_1 indicates “0”, the UE may map only CSI, without UL data (UL-SCH), to the PUSCH resource scheduled by DCI format 0_1 so as to transmit the same.

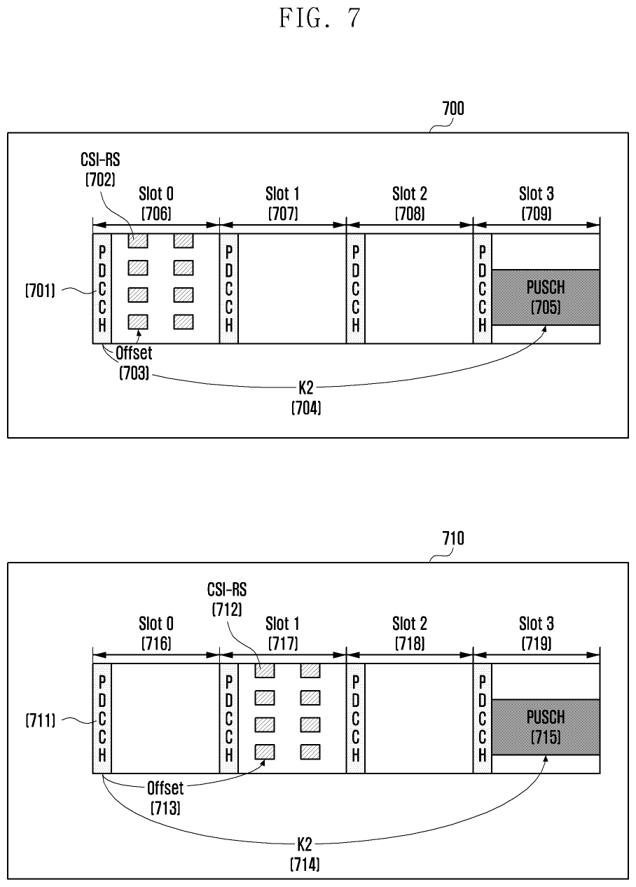

FIG. 7 illustrates an example of an aperiodic CSI reporting method according to an embodiment.

Referring to FIG. 7, in example 700, a UE may acquire DCI format 0_1 by monitoring a PDCCH 701 and may acquire scheduling information and CSI request information for a PUSCH 705 therefrom. The UE may acquire resource information of a CSI-RS 702 to be measured, from a received CSI request indicator. The UE may determine a time point at which the UE needs to measure a resource of the CSI-RS 702, based on a time point at which DCI format 0_1 is received, and a parameter for an offset (e.g., aforementioned aperiodicTriggeringOffset) in a CSI resource set configuration (e.g., an NZP CSI-RS resource set configuration (NZP-CSI-RS-ResourceSet)). More specifically, the UE may be configured with an offset value X of the parameter, aperiodicTriggeringOffset, in the NZP-CSI-RS resource set configuration from a BS via higher-layer signaling, and the configured offset value X may refer to an offset between a slot in which DCI triggering aperiodic CSI reporting is received, and a slot in which the CSI-RS resource is transmitted. For example, aperiodicTriggeringOffset parameter values and offset values X may have mapping relationships as shown in Table 11 below.

TABLE 11

| aperiodicTriggeringOffset | Offset X |
|---|---|
| 0 | 0 slot |
| 1 | 1 slot |
| 2 | 2 slots |
| 3 | 3 slots |
| 4 | 4 slots |
| 5 | 16 slots |
| 6 | 24 slots |

In example 700, the aforementioned offset value X is configured to be 0 (X=0). In this case, the UE may receive the CSI-RS 702 in a slot 0 706 in which DCI format 0_1 triggering aperiodic CSI reporting is received, and may report CSI information, which is measured based on the received CSI-RS, to the BS via the PUSCH 705. The UE may acquire, from DCI format 0_1, scheduling information (information corresponding to each field of DCI format 0_1 described above) on the PUSCH 705 for CSI reporting. For example, in DCI format 0_1, the UE may acquire information on a slot in which the PUSCH 705 is to be transmitted, from time domain resource allocation information for the PUSCH 705 described above. The UE acquires 3 as a K2 value corresponding to a slot offset value for PDCCH-to-PUSCH, and accordingly, the PUSCH 705 may be transmitted in slot 3 709, which is spaced 3 slots apart from slot 0 706, i.e., a time point at which the PDCCH 701 has been received. In example 710, the UE may acquire DCI format 0_1 by monitoring a PDCCH 711 and may acquire scheduling information and CSI request information for a PUSCH 715 therefrom. The UE may acquire resource information of a CSI-RS 712 to be measured, from a received CSI request indicator. The offset value X for CSI-RS described above is configured to be 1 (X=1). In this case, the UE may receive the CSI-RS 712 in a slot 0 716 in which DCI format 0_1 triggering aperiodic CSI reporting is received, and may report CSI information, which is measured based on the received CSI-RS, to the BS via the PUSCH 715.

The aperiodic CSI report may include at least one of or both CSI part 1 and CSI part 2. When the aperiodic CSI report is transmitted via the PUSCH, the aperiodic CSI report may be multiplexed on a transport block. After a CRC is inserted into an input bit of aperiodic CSI for multiplexing, encoding and rate matching may be performed, and then transmission may be performed by mapping to REs within the PUSCH in a specific pattern. The CRC insertion may be omitted depending on a coding method or length of the input bit. The number of modulation symbols, which are calculated for rate matching during multiplexing of CSI part 1 or CSI part 2 included in the aperiodic CSI report, may be calculated as shown in Table 12 below.

```
TABLE 12
For CSI part 1 transmission on PUSCH not using repetition type B with UL-SCH,
the number of coded modulation symbols per layer for CSI part 1 transmission,
$denoted as {Q}_{CSI - part 1}^{′} , is determined as follows :$
${Q}_{CSI - 1}^{′} = min \{ ⌈ \frac{( {O}_{CSI - 1} + {L}_{CSI - 1} ) \cdot {β}_{offset}^{PUSCH} \cdot {\sum }_{l = 0}^{{N}_{symb , {all}^{- 1}}^{PUSCH}} {M}_{SC}^{UCI} ( l )}{{\sum }_{r = 0}^{{C}_{UL - {SCH}^{- 1}}} Kr} ⌉ , ⌈ α \cdot {\sum }_{l = 0}^{{N}_{symb , {all}^{- 1}}^{PUSCH}} {M}_{sc}^{UCI} ( l ) ⌉ - {Q}_{ACK / CG - UCI}^{′} \}$
. . .
For CSI part 1 transmission on an actual repetition of a PUSCH with repetition
Type B with UL-SCH, the number of coded modulation symbols per layer
$for CSI part 1 transmission , denoted as {Q}_{CSI - p a r t 1}^{′} , is determined as follows :$
${Q}_{CSI - 1}^{′} = min \{ ⌈ \frac{( {O}_{CSI - 1} + {L}_{CSI - 1} ) \cdot {β}_{offset}^{PUSCH} \cdot {\sum }_{l = 0}^{{N}_{symb , {nominal}^{- 1}}^{PUSCH}} {M}_{sc , nominal}^{UCI} ( l )}{{\sum }_{r = 0}^{{C}_{UL - {SCH}^{- 1}}} Kr} ⌉ , ⌈ α \cdot {{\sum }^{{N}_{symb , {nominal}^{- 1}}^{PUSCH}}}_{l = 0} {M}_{sc , nominal}^{UCI} ( l ) ⌉ - {Q}_{ACK / CG - UCI}^{′} , {{\sum }^{{N}_{symb , {nominal}^{- 1}}^{PUSCH}}}_{l = 0} {M}_{sc , actual}^{UCI} ( l ) - {Q}_{ACK / CG - UCI}^{′} \}$
. . .
For CSI part 1 transmission on PUSCH without UL-SCH, the number of
coded modulation symbols per layer for CSI part 1 transmission, denoted as
${Q}_{CSI - part 1}^{′} , is determined as follows :$
if there is CSI part 2 to be transmitted on the PUSCH,
  ${Q}_{CSI - 1}^{′} = min \{ ⌈ \frac{( {O}_{CSI - 1} + {L}_{CSI - 1} ) \cdot {β}_{offset}^{PUSCH}}{R \cdot {Q}_{m}} ⌉ \cdot {\sum }_{l = 0}^{{N}_{symb , {all}^{- 1}}^{PUSCH}} {M}_{SC}^{UCI} ( l ) - {Q}_{ACK}^{′} \}$
. . .
For CSI part 2 transmission on PUSCH not using repetition type B with
UL-SCH, the number of coded modulation symbols per layer for CSI part 2
transmission, denoted as Q′_{CSI-part2}, is determined as follows:
  ${Q}_{CSI - 2}^{′} = min \{ ⌈ \frac{( {O}_{CSI - 2} + {L}_{CSI - 2} ) \cdot {β}_{offset}^{PUSCH} \cdot {\sum }_{l = 0}^{{N}_{symb , {all}^{- 1}}^{PUSCH}} {M}_{SC}^{UCI} ( l )}{{\sum }_{r = 0}^{{C}_{UL - {SCH}^{- 1}}} {K}_{r}} ⌉ ,$ $⌈ α \cdot {\sum }_{l = 0}^{{N}_{symb , {all}^{- 1}}^{PUSCH}} {M}_{sc}^{UCI} ( l ) ⌉ - {Q}_{ACK / CG - UCI}^{′} - {Q}_{CSI - 1}^{′} \}$
. . .
For CSI part 2 transmission on an actual repetition of a PUSCH with repetition
Type B with UL-SCH, the number of coded modulation symbols per layer
$for CSI part 2 transmission , denoted as Q {{}_{CSI}^{′}}_{- part 2} , is determined as follows :$
${Q}_{CSI - 2}^{′} = min \{ ⌈ \frac{( {O}_{CSI - 2} + {L}_{CSI - 2} ) \cdot {β}_{offset}^{PUSCH} \cdot {\sum }_{l = 0}^{{N}_{symb , {nominal}^{- 1}}^{PUSCH}} {M}_{sc , nominal}^{UCI} ( l )}{{\sum }_{r = 0}^{{C}_{UL - {SCH}^{- 1}}} Kr} ⌉ , ⌈ α \cdot {{\sum }^{{N}_{symb , {nominal}^{- 1}}^{PUSCH}}}_{l = 0} {M}_{sc , nominal}^{UCI} ( l ) ⌉ - {Q}_{ACK / CG - UCI}^{′} - {Q}_{CSI - 1}^{′} , {{\sum }^{{N}_{symb , {actual}^{- 1}}^{PUSCH}}}_{l = 0} {M}_{sc , actual}^{UCI} ( l ) - {Q}_{ACK / CG - UCI}^{′} - {Q}_{CSI - 1}^{′} \}$
. . .
For CSI part 2 transmission on PUSCH without UL-SCH, the number of
coded modulation symbols per layer for CSI part 2 transmission, denoted as
${Q}_{CSI - part 2}^{′} , is determined as follows :$
  ${Q}_{CSI - 2}^{′} = {\sum }_{l = 0}^{{N}_{symb , {all}^{- 1}}^{PUSCH}} {M}_{sc}^{UCI} ( l ) - {Q}_{ACK}^{′} - {Q}_{CSI - 1}^{′}$
```

Specifically, for repeated PUSCH transmission schemes A and B, the UE may multiplex the aperiodic CSI report only on the first repetition transmission among PUSCH repetition transmissions, to transmit the same. This is because aperiodic CSI report information to be multiplexed is encoded in a polar code scheme, and at this time, each PUSCH repetition needs to have the same frequency and time resource allocation to multiplex the aperiodic CSI report information on multiple PUSCH repetitions. Particularly, in the case of PUSCH repetition type B transmission, since each actual repetition may have different OFDM symbol durations, the aperiodic CSI report may be multiplexed only on the first repetition and then transmitted.

In addition, for repeated PUSCH transmission scheme B, when the UE receives DCI for activation of semi-persistent CSI reporting or scheduling of aperiodic CSI reporting without scheduling for a transport block, the UE may assume that a value of nominal repetition is 1 even if the number of repeated PUSCH transmissions, which is configured via higher-layer signaling, is greater than 1. When the aperiodic or semi-persistent CSI reporting is scheduled or activated without scheduling for a transport block, based on repeated PUSCH transmission scheme B, the UE may expect that a first nominal repetition is identical to a first actual repetition. In the PUSCH transmitted while including semi-persistent CSI, based on repeated PUSCH transmission scheme B, without scheduling for DCI after the semi-persistent CSI reporting has been activated via the DCI, if the first nominal repetition is different from the first actual repetition, transmission for the first nominal repetition may be ignored.

### CSI Computation Time

When the BS instructs the UE to perform an aperiodic CSI report or a semi-persistent CSI report through DCI, the UE may determine whether a valid channel report can be performed through the indicated CSI report by considering the channel computation time (CSI computation time) required for the CSI report. For the aperiodic CSI report or semi-persistent CSI report indicated through the DCI, the UE may perform a valid CSI report starting from the UL symbol that occurs Z symbol after the end of the last symbol of the PDCCH containing the DCI indicating the CSI report. The value of Z symbol may differ depending on the numerology of the DL BWP to which the PDCCH including DCI indicating the CS report belongs, the numerology of the UL BWP to which the PUSCH for transmitting the CSI report belongs, and the type or characteristics of the channel information to be reported in the CSI report (e.g., report quantity, frequency bandwidth granularity, number of reference signal ports, type of codebook, etc.). In other words, for a CSI report to be regarded as a valid CSI report, the UL transmission of the CSI report, including time point advance, should not be performed before the Z_{ref} symbol. The Z_{ref} symbol refers to the UL symbol that starts its CP after a time T_{proc,CSI}=(Z)(2048+144)·κ2^{-μ}·T_{C} from the end of the last symbol of the triggering PDCCH. The detailed value of Z is determined below, where T_{c}=1/(Δfₘₐₓ·N_{f}), Δfₘₐₓ=480·10³ Hz, N_{f}=4096, κ=64, and μ denote numerology. In this case, μ may be configured to use the one that results in the largest value of T_{proc,CSI} among the numerologies (μ_{PDCCH},μ_{CSI-RS},μ_{UL}), μ_{PDCCH} refers to a subcarrier spacing used for PDCCH transmission, μ_{CSI-RS} refers to a subcarrier spacing used for CSI-RS transmission, and μ_{UL} may refer to a subcarrier spacing of the UL channel used for transmitting uplink control information (UCI) for CSI reporting. It is also possible to configure u as the value that results in the largest T_{proc,CSI} value among (μ_{PDCCH},μ_{UL}). The definitions of μ_{PDCCH} and μ_{UL} follow the descriptions above. For convenience of further explanation, satisfying this condition is referred to as satisfying CSI reporting validity condition 1.

When the reference signal for channel measurement for the aperiodic CSI report instructed to the UE through DCI is an aperiodic reference signal, the UE may perform a valid CSI report starting from the UL symbol that occurs Z′ symbol after the end of the last symbol including the reference signal. The value of Z′ symbol may differ depending on the numerology of the DL BWP to which the PDCCH including DCI indicating the CS report belongs, the numerology of the bandwidth to which the reference signal for channel measurement for the CSI report belongs, the numerology of the UL BWP to which the PUSCH for transmitting the CSI report belongs, and the type or characteristics of the channel information to be reported in the CSI report (e.g., report quantity, frequency bandwidth granularity, number of reference signal ports, type of codebook, etc.). In other words, for a CSI report to be regarded as a valid CSI report, the UL transmission of the CSI report, including time point advance, should not be performed before the Zref′ symbol. The Zref′ symbol refers to the UL symbol that starts its CP after a time

$${T}_{proc , CSI}^{′} = ( {Z}^{′} ) ( 2048 + 144 ) \cdot {κ2}^{- μ} \cdot {T}_{C}$$

from the end of the last symbol of the aperiodic CSI-RS or aperiodic CSI-IM triggered by the triggering PDCCH. The detailed value of Z′ is determined below, where T_{c}=1/(Δfₘₐₓ·N_{f}), Δfₘₐₓ=480·10³ Hz, N_{f}=4096, κ=64, and μ denote numerology. In this case, μ may be configured to use the one that results in the largest value of T_{proc,CSI} among the numerologies (μ_{PDCCH},μ_{CSI-RS},μ_{UL}), μ_{PDCCH} refers to a subcarrier spacing used for the transmission of the triggering PDCCH, μ_{CSI-RS} refers to a subcarrier spacing used for CSI-RS transmission, and Hot may refer to a subcarrier spacing of the UL channel used for transmitting UCI for CSI reporting.

It is also possible to configure u as the value that results in the largest process value among (μ_{PDCCH},μ_{UL}). The definitions of μ_{PDCCH} and μ_{UL} follow the descriptions above. For convenience of further explanation, satisfying this condition is referred to as satisfying CSI reporting validity condition 2.

When the BS instructs the UE to perform an aperiodic CSI report for aperiodic reference signals through the DCI, the UE may perform a valid CSI report starting from the first UL symbol that satisfies both the time point after Z symbols following the last symbol containing the PDCCH that includes the DCI instructing the CSI report and the time point after Z′ symbol following the last symbol containing the reference signal. In other words, for aperiodic CSI reporting based on aperiodic reference signals, both CSI reporting validity conditions 1 and 2 should be satisfied for the CSI report to be considered valid.

In case that the CSI report time point instructed by the BS fails to satisfy the CSI computation time requirements, the UE may determine the CSI report as invalid and may not consider updating the channel information state for the CSI report.

The Z and Z′ symbols used for the CSI computation time calculation described above follow Tables 13 and 14 below. For example, when the channel information reported in the CSI report includes only wideband information, the number of reference signal ports is 4 or less, the reference signal resource is one, the codebook type is “typeI-SinglePanel”, or the type of reported channel information (report quantity) is “cri-RI-CQI”, the Z and Z′ symbols follow the values of

$${Z}_{1} , {Z}_{1}^{′}$$

In Table 14. This is referred to as delay requirement 2. Additionally, when the PUSCH containing the CSI report does not include TB or HARQ-ACK and the CPU occupation of the UE is 0, the Z and Z′ symbols follow the values of

$${Z}_{1} , {Z}_{1}^{′}$$

in Table 13, which is referred to as delay requirement 1. The explanation of the aforementioned CPU occupation is detailed below.

When the report quantity is “cri-RSRP” or “ssb-Index-RSRP”, the Z and Z′ symbols follow the values of

$${Z}_{3} , {Z}_{3}^{′}$$

in Table 14. X1, X2, X3, and X4 in Table 14 represent a UE capability regarding beam reporting time, while KB1 and KB2 in Table 14 represent a UE capability regarding beam change time. In case that the type or characteristics of the channel information reported in the aforementioned CSI report do not apply, the Z and Z′ symbols follow the values of

$${Z}_{2} , {Z}_{2}^{′}$$

### in Table 14.

TABLE 13

Z₁ [symbols]

| μ | Z₁ | Z′₁ |
|---|---|---|
| 0 | 10 | 8 |
| 1 | 13 | 11 |
| 2 | 25 | 21 |
| 3 | 43 | 36 |

TABLE 14

| | Z₁ _{[symbols]} | | Z_{2 [symbols]} | | Z_{3 [symbols]} | |
|---|---|---|---|---|---|---|
| μ | Z₁ | Z₁′ | Z₂ | Z₂′ | Z₃ | Z₃′ |
| 0 | 22 | 16 | 40 | 37 | 22 | X₁ |
| 1 | 33 | 30 | 72 | 69 | 33 | X₂ |
| 2 | 44 | 42 | 141 | 140 | min(44, X₃ + KB₁) | X₃ |
| 3 | 97 | 85 | 152 | 140 | min(97, X₄ + KB₂) | X₄ |

### CSI Reference Resource

When the BS instructs the UE to perform aperiodic/semi-persistent/periodic CSI reports, it may configure a CSI reference resource to determine the reference time and frequency for channels to be reported in the CSI report. The frequency of the CSI reference resource may be carrier and subband information for measuring CSI, which are indicated in the CSI report configuration, and the carrier and subband information may correspond to carrier and the higher layer signaling reportFreqConfiguration in CSI-ReportConfig, respectively. The time of the CSI reference resource may be defined based on a time at which the CSI report is transmitted. For example, when CSI report #X is instructed to be transmitted in UL slot n′ of the carrier and BWP through which the CSI report is transmitted, the time of the CSI reference resource for CSI report #X may be defined by the DL slot n-nCSI-ref of the carrier and BWP through which CSI is measured. DL slot n is calculated as n=└n′·2^{μ}^{_{DL}}/2^{μ}^{_{DL}}┘ when the numerology of the carrier and BWP for measuring CSI is referred to as μDL, and the numerology of the carrier and BWP for transmitting CSI report #X is referred to as μ_{UL}. In case that CSI report #X transmitted in UL slot n′ is a semi-persistent or periodic CSI report, the slot spacing nCSI-ref between the DL slot n and the CSI reference signal satisfies n_{CSI-ref}=4·2^{μ}^{_{DL}} when a single CSI-RS/SSB resource is associated with the CSI report for channel measurement, or satisfies n_{CSI-ref}=5·2^{μ}^{_{DL}} when multiple CSI-RS/SSB resources are associated with the CSI report. In case that CSI report #X transmitted in UL slot n′ is an aperiodic CSI report, the n_{CSI-ref} is calculated as

$${n}_{CSI - ref} = ⌊ {Z}^{′} / {N}_{symb}^{slot} ⌋$$

by considering the CSI computation time Z′ required for channel measurement. The parameter

$${N}_{symb}^{slot}$$

described above refers to the number of symbols included in one slot, and in NR, it is assumed to be

$${N}_{symb}^{slot} = 14.$$

When the BS instructs the UE to transmit a CSI report in UL slot n′ via higher layer signaling or DCI, the UE may report CSI by performing channel measurement or IM on a CSI-RS resource, CSI-IM resource, or SSB resource transmitted no later than the CSI reference resource slot of the CSI report transmitted in UL slot n′ among the CSI-RS resources or CSI-IM or SSB resources associated with the corresponding CSI report. The CSI-RS resource, CSI-IM resource, or SSB resource associated with the corresponding CSI report may refer to a CSI-RS resource, CSI-IM resource, or SSB resource included in a resource set configured in a resource setting referenced by a report setting for a CSI report of the UE configured via higher layer signaling, or refer to a CSI-RS resource, CSI-IM resource, or SSB resource referenced by a CSI report trigger state that includes parameters for the corresponding CSI report, or a CSI-RS resource, CSI-IM resource, or SSB resource indicated by an ID of a set of RSs.

Herein, a CSI-RS/CSI-IM/SSB occasion refers to the transmission time point of CSI-RS/CSI-IM/SSB resources determined by higher layer configurations or a combination of higher layer configurations and DCI triggering. For example, semi-persistent or periodic CSI-RS resources are transmitted in slots determined according to the slot period and slot offset configured by higher layer signaling, and the transmission symbols within the slot are determined based on resource mapping information (resourceMapping). In another example, aperiodic CSI-RS resources are transmitted in slots determined by the slot offset with the PDCCH containing the DCI indicating channel reporting configured by higher layer signaling, and the transmission symbols within the slot are determined based on the resource mapping information (resourceMapping).

The aforementioned CSI-RS occasion may be determined by considering the transmission time point of each CSI-RS resource independently or by comprehensively considering the transmission time point of one or more CSI-RS resources included in the resource set. Accordingly, the following two interpretations are possible for each CSI-RS occasion according to each resource set configuration.

Interpretation 1-1: From a start time point of the earliest symbol to an end time point of the latest symbol in which a specific CSI-RS resource is transmitted among one or more CSI-RS resources included in the resource set(s) configured in the resource setting referenced by the report setting configured for the CSI report.

Interpretation 1-2: From a start time point of the earliest symbol of the CSI-RS resource that is transmitted first among all CSI-RS resources included in the resource set(s) configured in the resource setting referenced by the report setting configured for the CSI report, to an end time point of the latest symbol of the CSI-RS resource that is transmitted last.

It is possible to consider both interpretations of the CSI-RS occasion and apply them separately. Furthermore, it is possible to consider both interpretations of the CSI-IM occasion and SSB occasion in the same manner as the CSI-RS occasion, but since the principle is similar to the above explanation, redundant explanations will be omitted below.

Herein, the “CSI-RS/CSI-IM/SSB occasion for CSI report #X transmitted in UL slot n”′ refers to a set of CSI-RS occasions, CSI-IM occasions, and SSB occasions, among those included in the CSI-RS resource, CSI-IM resource, and SSB resource of the resource set configured in the resource setting referenced by the report setting for CSI report #X, which are not later than the CSI reference resource of CSI report #X transmitted in UL slot n′.

The “latest CSI-RS/CSI-IM/SSB occasion among the CSI-RS/CSI-IM/SSB occasions transmitted in UL slot n′ for CSI report #X” may be interpreted as follows.

Interpretation 2-1: A set of occasions including the latest CSI-RS occasion among the CSI-RS occasions for CSI report #X transmitted in UL slot n′, the latest CSI-IM occasion among the CSI-IM occasions for CSI report #X transmitted in UL slot n′, and the latest SSB occasion among the SSB occasions for CSI report #X transmitted in UL slot n′.

Interpretation 2-2: The latest occasion among all the CSI-RS occasions, CSI-IM occasions, and SSB occasions for CSI report #X transmitted in UL slot n′.

Herein, both interpretations of “the latest CSI-RS/CSI-IM/SSB occasion among the CSI-RS/CSI-IM/SSB occasions for CSI report #X transmitted in UL slot n′” may be considered and applied separately. Furthermore, when considering Interpretation 1-1 and Interpretation 1-2 for the CSI-RS occasion, CSI-IM occasion, and SSB occasion, the “latest CSI-RS/IM/SSB occasion among the CSI-RS/IM/SSB occasions for the CSI report #X transmitted in the UL slot n′” may be separately applied by considering all four different interpretations (applying interpretation 1-1 and interpretation 2-1, applying interpretation 1-1 and interpretation 2-2, applying interpretation 1-2 and interpretation 2-1, applying interpretation 1-2 and interpretation 2-2).

The BS may instruct the CSI report by considering the amount of channel information that the UE may calculate simultaneously for the CSI report, i.e., the number of channel information computation units (CSI processing unit (CPU)) of the UE. In case that the number of channel information computation units that the UE may calculate simultaneously is denoted as N_{CPU}, the UE may not expect CSI reporting instruction from the BS that requires more channel information computations than N_{CPU}, or may not consider channel information updates that require more channel information computations than N_{CPU}. N_{CPU} may be reported by the UE to the BS via higher layer signaling or may configure by the BS via higher layer signaling.

The CSI report instructed by the BS to the UE is assumed to occupy some or all of the CPU for channel information computation out of the total number of channel information units N_{CPU} that the UE may calculate simultaneously. For each CSI report when the number of channel information computation units required for CSI report n(n=0, 1, . . . , N−1) is denoted as

$${O}_{CPU}^{( n )} ,$$

the total number of channel information computation units required for CSI reports may be denoted as

$${\sum }_{n = 0}^{N - 1} {O}_{CPU}^{( n )} .$$

The number of channel information computation units required for each reportQuantity configured in the CSI report may be configured as shown in Table 15 below.

```
TABLE 15
$- {O}_{CPU}^{( n \}} = 0 : When the reportQuantity configured in the CSI report is set to ‘ none ’ , and the trs - Info is$
configured in the CSI-RS resource set associated with the CSI report
$- {O}_{CPU}^{( n )} = 1 : When the reportQuantity configured in the CSI report is set to ‘ none ’ , ‘ cri - RSRP ’ , or ‘ ssb -$
Index-RSRP’, and the trs-Info is not configured in the CSI-RS resource set associated with the CSI report
- When the reportQuantity configured in the CSI report is set to ‘cri-RI-PMI-CQI’, ‘cri-RI-il’, ‘cri-RI-il-CQI’,
‘cri-RI-CQI’, or ‘cri-RI-LI-PMI-CQI’
$>> {O}_{CPU}^{( n )} = {N}_{C P U} : When the aperiodic CSI report is triggered and is not multiplexed with either or both$
of the TB and HARQ-ACK. In this case, the CSI report corresponds to a wideband CSI, includes up to 4
CSI-RS ports, corresponds to a single resource without CRI reporting, and either the codebookType
corresponds to ‘typeI-SinglePanel’ or the reportQuantity corresponds to ‘cri-RI-CQI’
(This case corresponds to the latency requirement 1 described above, where the UE utilizes its full available
CPU resources to quickly compute and report CSI.)
  $>> {O}_{CPU}^{( n )} = {K}_{s} : All remaining cases except for the case above . {K}_{s} refers to the number of$
  CSI-RS resources within the CSI-RS resource set used for channel measurements
```

In case that the number of channel information computations required by the UE for multiple CSI reports at a specific time point exceeds the number of channel information computation units N_{CPU} that the UE may calculate simultaneously, the UE may not consider updating the channel information for some CSI reports. Among multiple instructed CSI reports, a CSI report for which channel information update is not considered may be determined based at least on the CPU occupancy time required for channel information computation required for the CSI report and the reporting priority of the channel information. For example, channel information update may be excluded from consideration for a CSI report in which the required channel information computation for the CSI report starts at the latest CPU occupancy time point and may also be preferentially excluded for a CSI report having a lower reporting priority.

The above channel information priority may be determined as shown in Table 16 below.

```
TABLE 16
CSI priority value Pri_{iCSI}(y, k, c, s) = 2 · N_{cells} · Mₛ · y + N_{cells} · Mₛ · k +
Mₛ · c + s,
  y = 0 when the CSI report is an aperiodic CSI report transmitted via
  PUSCH, y = 1 when the CSI report is a semi-persistent CSI reports
  transmitted via PUSCH, y = 2 when the CSI report is a semi-persistent
  CSI reports transmitted via PUCCH and y = 3 when the CSI report is a
  periodic CSI reports transmitted via PUCCH;
  k = 0 when the CSI reports includes L1-RSRP and k = 1 when
  CSI reports does not include L1-RSRP;
  c: the serving cell index and N_{cells}: the maximum number of serving
  cells configured via higher layer signaling (maxNrofServingCells);
  s: CSI report configuration index (reportConfigID) and Mₛ: the
  maximum number of CSI report configurations configured via higher
  layer signaling (maxNrofCSI-ReportConfigurations).
```

In Table 16, the CSI priority for CSI reporting is determined by the priority value Pri_{iCSI}(y,k,c,s). The CSI priority value is determined based on the type of channel information included in the CSI report, the time-domain reporting characteristics of the CSI report (aperiodic, semi-persistent, periodic), a channel through which the CSI report is transmitted (PUSCH, PUCCH), a serving cell index, and a CSI report configuration index. The CSI priority for CSI report may be determined based on comparison of priority values Pri_{iCSI}(y,k,c,s), and a CSI report having a smaller priority value may be determined to have a higher CSI priority.

If the time for which the channel information computation required for the CSI report instructed by the BS occupies the CPU is referred to as a “CPU occupation time”, the CPU occupation time may be determined by considering at least a part or all of a type (report quantity) of channel information included in the CSI report, a time-domain characteristic (e.g., aperiodic, semi-persistent, or periodic) of the CSI report, a slot or symbol occupied by higher layer signaling or DCI that instructs the CSI report, and a slot or symbol occupied by reference signals for channel state measurement.

### PDCCH: DCI

In a 5G system, scheduling information regarding a PUSCH or PDSCH) is included in DCI and transferred from a BS to a UE through the DCI. The UE may monitor, in the PUSCH or PDSCH, a fallback DCI format and a non-fallback DCI format. The fallback DCI format may include a fixed field predefined between the BS and the UE, and the non-fallback DCI format may include a configurable field.

The DCI may be subjected to channel coding and modulation processes and then transmitted through a PDCCH after a channel coding and modulation process. A cyclic redundancy check (CRC) may be attached to the payload of a DCI message, and the CRC may be scrambled by a radio network temporary identifier (RNTI) corresponding to the identity of the UE. Different RNTIs may be used according to the purpose of the DCI message such as UE-specific data transmission, power control command, or a random access response. That is, the RNTI may not be explicitly transmitted, but may be transmitted while being included in a CRC calculation process. Upon receiving a DCI message transmitted through the PDCCH, the UE may determine the CRC by using the allocated RNTI, and if the CRC identification result is correct, the UE may know that the corresponding message has been transmitted to the UE.

For example, DCI for scheduling a PDSCH regarding system information (SI) may be scrambled by an SI-RNTI. DCI for scheduling a PDSCH regarding a random access response (RAR) message may be scrambled by an RA-RNTI. DCI for scheduling a PDSCH regarding a paging message may be scrambled by a P-RNTI. DCI for notifying of a slot format indicator (SFI) may be scrambled by an SFI-RNTI. DCI for notifying of transmit power control (TPC) may be scrambled by a TPC-RNTI. DCI for scheduling a UE-specific PDSCH or PUSCH may be scrambled by a cell RNTI (C-RNTI).

DCI format 0_0 may be used as fallback DCI for scheduling a PUSCH, and in this case, the CRC may be scrambled by a C-RNTI. DCI format 0_0 in which the CRC is scrambled by a C-RNTI may include the following pieces of information given in Table 17 below.

TABLE 17
- Identifier for DCI formats - [1 bit
$- Frequency domain resource assignment - [ ⌈ {log}_{2} ( {N}_{R B}^{U L , B W P} ( {N}_{R B}^{U L , B W P} + 1 ) / 2 ) ⌉ ] bits$
- Time domain resource assignment - X bits
- Frequency hopping flag - 1 bit.
- Modulation and coding scheme - 5 bits
- New data indicator - 1 bit
- Redundancy version - 2 bits
- HARQ process number - 4 bits
- Transmit power control (TPC) command for scheduled PUSCH - [2 bits
- Uplink/ supplementary uplink (UL/SUL) indicator - 0 or 1 bit

DCI format 0_1 may be used as non-fallback DCI for scheduling a PUSCH, and in this case, the CRC may be scrambled by a C-RNTI. DCI format 0_1 in which the CRC is scrambled by a C-RNTI may include the following pieces of information given in Table 18 below.

```
TABLE 18
- Carrier indicator - 0 or 3 bits
- UL/SUL indicator - 0 or 1 bit
- Identifier for DCI formats - [1 bit
- BWP indicator - 0, 1 or 2 bits
- Frequency domain resource assignment
    ○  $For resource allocation type 0 , ⌈ {N}_{RB}^{UL , B W P} / P ⌉ bits$
    ○   $For resource allocation type 1 , ⌈ {log}_{2} ( {N}_{R B}^{UL , BWP} ( {N}_{R B}^{UL , BWP} + 1 ) / 2 ) ⌉ bits$
- Time domain resource assignment - 1, 2, 3, or 4 bits
- Virtual resource block (VRB)-to-PRB mapping - 0 or 1 bit, only for resource
allocation type 1.
    ○ 0 bit if only resource allocation type 0 is configured;
    ○ 1 bit otherwise.
- Frequency hopping flag - 0 or 1 bit, only for resource allocation type 1.
    ○ 0 bit if only resource allocation type 0 is configured;
    ○ 1 bit otherwise.
- Modulation and coding scheme - 5 bits
- New data indicator - 1 bit
- Redundancy version - 2 bits
- HARQ process number - 4 bits
- 1st DL assignment index - 1 or 2 bits
    ○ 1 bit for semi-static HARQ-ACK codebook;
    ○ 2 bits for dynamic HARQ-ACK codebook with single HARQ-ACK
    codebook.
- 2nd DL assignment index - 0 or 2 bits
    ○ 2 bits for dynamic HARQ-ACK codebook with two HARQ-ACK sub-codebooks;
    ○ 0 bit otherwise.
- TPC command for scheduled PUSCH - 2 bits
  $- SRS resource indicator - ⌈ {log}_{2} ( {\sum }_{k = 1}^{{L}_{max} \sum } ( \begin{matrix}{N}_{SRS} \\ k\end{matrix} ) ) ⌉ or ⌈ {log}_{2} ( {N}_{S R S} ) ⌉ bits$
    ○ $⌈ {log}_{2} ( {\sum }_{k = 1}^{{L}_{max} \sum } ( \begin{matrix}{N}_{SRS} \\ k\end{matrix} ) ) ⌉ bits for non - codebook based PUSCH$
    transmission;
    ○ ┌log₂(N_{SRS})]┐ bits for codebook based PUSCH transmission.
- Precoding information and number of layers - up to 6 bits
- Antenna ports - up to 5 bits
- SRS request - 2 bits
- CSI request - 0, 1, 2, 3, 4, 5, or 6 bits
- Code block group (CBG) transmission information - 0, 2, 4, 6, or 8 bits
- Phase tracking reference signal (PTRS)-demodulation reference signal (DDMRS)
association - 0 or 2 bits.
- beta offset indicator - 0 or 2 bits
- DMRS sequence initialization - 0 or 1 bit
```

DCI format 1_0 may be used as fallback DCI for scheduling a PDSCH, and in this case, the CRC may be scrambled by a C-RNTI. DCI format 1_0 in which the CRC is scrambled by a C-RNTI may include the following pieces of information given in Table 19 below.

TABLE 19
- Identifier for DCI formats - [1 bit
$- Frequency domain resource assignment - [ ⌈ {log}_{2} ( {N}_{R B}^{D L , B W P} ( {N}_{R B}^{D L , B W P} + 1 ) / 2 ) ⌉ ] bits$
- Time domain resource assignment - X bits
- VRB-to-PRB mapping - 1 bit.
- Modulation and coding scheme - 5 bits
- New data indicator - 1 bit
- Redundancy version - 2 bits
- HARQ process number - 4 bits
- DL assignment index - 2 bits
- TPC command for scheduled PUCCH - [2 bits
- PUCCH resource indicator - 3 bits
- PDSCH-to-HARQ feedback timing indicator - [3 bits

DCI format 1_I may be used as non-fallback DCI for scheduling a PDSCH, and in this case, the CRC may be scrambled by a C-RNTI. DCI format 1_1 in which the CRC is scrambled by a C-RNTI may include the following pieces of information given in Table 20 below.

```
TABLE 20
- Carrier indicator - 0 or 3 bits
- Identifier for DCI formats - [1 bit
- BWP indicator - 0, 1 or 2 bits
- Frequency domain resource assignment
    ○  $For resource allocation type 0 , ⌈ {N}_{R B}^{D L , B W P} / P ⌉ bits$
    ○  $For resource allocation type 1 , ⌈ {log}_{2} ( {N}_{R B}^{D L , B W P} ( {N}_{R B}^{D L , B W P} + 1 ) / 2 ) ⌉ bits$
- Time domain resource assignment - 1, 2, 3, or 4 bits
- VRB-to-PRB mapping - 0 or 1 bit, only for resource allocation type 1.
    ○ 0 bit if only resource allocation type 0 is configured;
    ○ 1 bit otherwise.
- PRB bundling size indicator - 0 or 1 bit
- Rate matching indicator - 0, 1, or 2 bits
- Zero power (ZP) CSI- RS trigger - 0, 1, or 2 bits
For transport block 1:
- Modulation and coding scheme - 5 bits
- New data indicator - 1 bit
- Redundancy version - 2 bits
For transport block 2:
- Modulation and coding scheme - 5 bits
- New data indicator - 1 bit
- Redundancy version - 2 bits
- HARQ process number - 4 bits
- DL assignment index - 0 or 2 or 4 bits
- TPC command for scheduled PUCCH - 2 bits
- PUCCH resource indicator - 3 bits
- PDSCH-to-HARQ_feedback timing indicator - 3 bits
- Antenna ports - 4, 5 or 6 bits
- Transmission configuration indication - 0 or 3 bits
- SRS request - 2 bits
- CBG transmission information - 0, 2, 4, 6, or 8 bits
- CBG flushing out information - 0 or 1 bit
- DMRS sequence initialization - 1 bit
```

### PDCCH: CORESET, REG, CCE, and Search Space

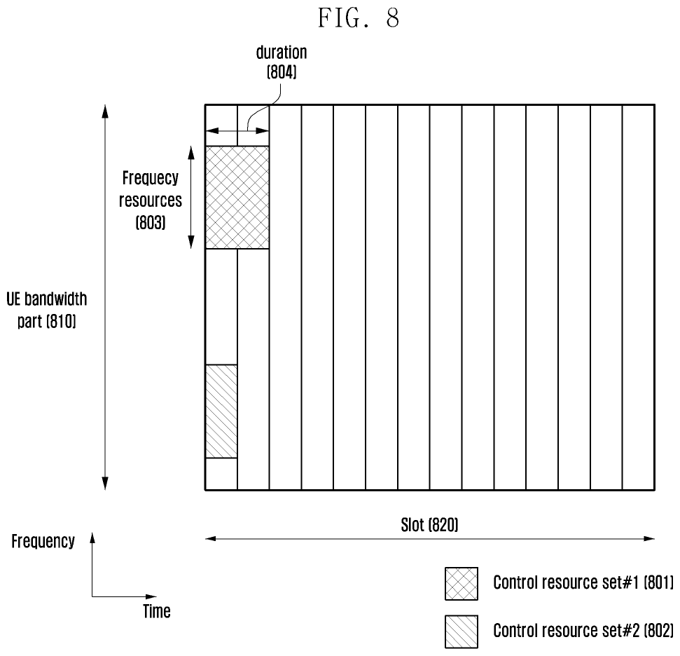

FIG. 8 illustrates a CORESET used to transmit a DL control channel in a 5G wireless communication system according to an embodiment. Referring to FIG. 8, a UE BWP 810 is configured along the frequency axis, and two CORESETs (CORESET #1 801 and CORESET #2 802) are configured within one slot % n along the time axis. The CORESETs 801 and 802 may be configured in a specific frequency resource 803 within the entire UE BWP 810 along the frequency axis. The CORESETs 801 and 802 may be configured as one or multiple OFDM symbols along the time domain, and the number of the OFDM symbols may be defined as a CORESET duration 804. CORESET #1 801 is configured to have a CORESET duration corresponding to two symbols, and CORESET #2 802 is configured to have a CORESET duration corresponding to one symbol.

A CORESET in 5G described above may be configured for a UE by a BS through higher layer signaling (for example, system information, MIB, or RRC signaling). The description that a CORESET is configured for a UE means that information such as a CORESET identity, the CORESET's frequency location, and the CORESET's symbol duration is provided. For example, this information may include the following pieces of information given in Table 21 below.

TABLE 21
SEQUENCE

| | |
|---|---|
| ControlResourceSet ::= | SEQUENCE { |

-- Corresponds to L1 parameter ‘CORESET-ID’

| | |
|---|---|
| controlResourceSetId | ControlResourceSetId, |

(CORESET identity)

| | |
|---|---|
| frequencyDomainResources | BIT STRING (SIZE (45)), |

(frequency domain resource assignment information)

| | |
|---|---|
| duration | INTEGER (1..maxCoReSetDuration), |

(time domain resource assignment information)

| | |
|---|---|
| cce-REG-Mapping Type | CHOICE { |

(CCE-to-REG mapping type)

| | |
|---|---|
| interleaved | SEQUENCE { |
| reg-BundleSize | ENUMERATED {n2, n3, n6}, |

(REG bundle size)

| | |
|---|---|
| precoderGranularity | ENUMERATED |

{sameAsREG-bundle, allContiguousRBs},

| | |
|---|---|
| interleaverSize | ENUMERATED {n2, n3, n6} |

```
      (interleaver size)
      shiftIndex
  INTEGER(0..maxNrofPhysicalResourceBlocks−1)
  OPTIONAL
      (interleaver shift)
      },
```

| | |
|---|---|
| nonInterleaved | NULL |

},

| | |
|---|---|
| tci-StatesPDCCH | SEQUENCE(SIZE |
| (1..maxNrofTCI-StatesPDCCH)) OF TCI-StateId | OPTIONAL, |

(QCL configuration information)

| | |
|---|---|
| tci-PresentInDCI | ENUMERATED {enabled} |
| | OPTIONAL, ... Need S |

}

In Table 21, tci-StatesPDCCH configuration information may include information of one or multiple SS/PBCH block indexes or CSI-RS indexes, which are QCLed with a DMRS transmitted in a corresponding CORESET.

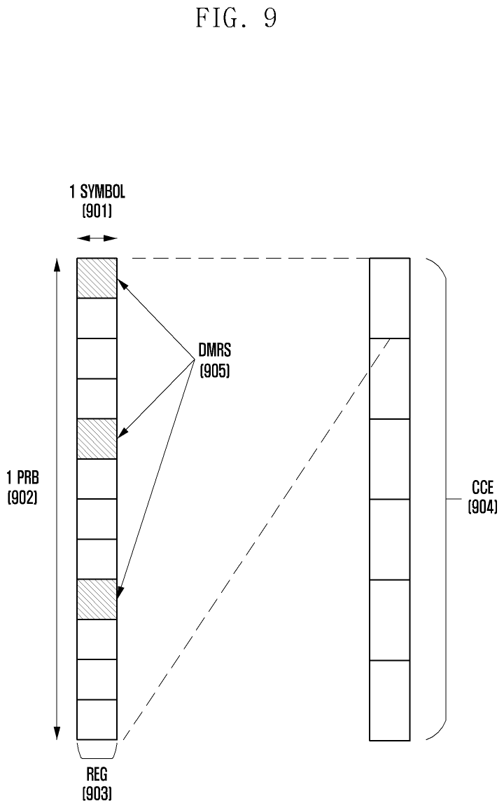

FIG. 9 illustrates a basic unit of time and frequency resources constituting a DL control channel available in a 5G system according to an embodiment. Referring to FIG. 9, the basic unit of time and frequency resources constituting a control channel may be referred to as a resource element group (REG) 903, and the REG 903 may be defined by one OFDM symbol % n along the time axis and one PRB 902, that is, 12 subcarriers, along the frequency axis. The BS may constitute a DL control channel allocation unit by connecting REGs 903.

Provided that the basic unit of DL control channel allocation in 5G is a control channel element (CCE) 904 as illustrated in FIG. 9, one CCE 004 may include multiple REGs 903. The REG 903 may include 12 REs, and if one CCE 904 includes six REGs 903, one CCE 904 may then include 72 REs. A DL CORESET, once configured, may include multiple CCEs 904, and a specific DL control channel may be mapped to one or multiple CCEs 904 and then transmitted according to the aggregation level (AL) in the CORESET. The CCEs 904 in the CORESET are distinguished by numbers, and the numbers of CCEs 904 may be allocated according to a logical mapping scheme.

The basic unit of the DL control channel illustrated in FIG. 9, that is, the REG 903, may include both REs to which DCI is mapped, and an area to which a reference signal (DMRS 905) for decoding the same is mapped. As in FIG. 9, three DRMSs 905 may be transmitted inside one REG % n. The number of CCEs necessary to transmit a PDCCH may be 1, 2, 4, 8, or 16 according to the aggregation level (AL), and different number of CCEs may be used to implement link adaption of the DL control channel. For example, in the case of AL=L, one DL control channel may be transmitted through L CCEs. The UE needs to detect a signal while being no information regarding the DL control channel, and thus a search space indicating a set of CCEs has been defined for blind decoding. The search space is a set of DL control channel candidates including CCEs which the UE needs to attempt to decode at a given AL, and since 1, 2, 4, 8, or 16 CCEs may constitute a bundle at various ALs, the UE may have multiple search spaces. A search space set may be defined as a set of search spaces at all configured aggregation levels.

Search spaces may be classified into common search spaces and UE-specific search spaces. A group of UEs or all UEs may search a common search space of the PDCCH to receive cell-common control information such as dynamic scheduling regarding system information or a paging message. For example, PDSCH scheduling allocation information for transmitting an SIB including a cell operator information or the like may be received by searching the common search space of the PDCCH. In the case of a common search space, a group of UEs or all UEs need to receive the PDCCH, and the common search space may thus be defined as a predetermined set of CCEs. Scheduling allocation information regarding a UE-specific PDSCH or PUSCH may be received by searching the UE-specific search space of the PDCCH. The UE-specific search space may be defined UE-specifically as a function of various system parameters and the identity of the UE.

In 5G, parameters for a search space regarding a PDCCH may be configured for the UE by the BS through higher layer signaling (for example, SIB, MIB, or RRC signaling). The BS may provide the UE with configurations such as the number of PDCCH candidates at each aggregation level L, the monitoring cycle regarding the search space, the monitoring occasion in each symbol in a slot regarding the search space, the search space type (common search space or UE-specific search space), a combination of an RNTI and a DCI format to be monitored in the corresponding search space, a CORESET index for monitoring the search space, and the like. This information may include the following pieces of information given in Table 22 below.

TABLE 22

| | |
|---|---|
| SearchSpace ::= | SEQUENCE { |

-- Identity of the search space. SearchSpaceId = 0 identifies the SearchSpace configured
via PBCH (MIB) or ServingCellConfigCommon.

| | |
|---|---|
| searchSpaceId | SearchSpaceId, |

(search space identity)

| | |
|---|---|
| controlResourceSetId | ControlResourceSetId, |

(CORESET identity)

| | |
|---|---|
| monitoringSlotPeriodicityAndOffset | CHOICE { |

(monitoring slot level periodicity)

| | |
|---|---|
| sl1 | NULL, |
| sl2 | INTEGER (0..1), |
| sl4 | INTEGER (0..3), |
| sl5 | INTEGER (0..4), |
| sl8 | INTEGER (0..7), |
| sl10 | INTEGER (0..9), |
| sl16 | INTEGER (0..15), |
| sl20 | INTEGER (0..19) |

```
  }
    OPTIONAL,
```

| | |
|---|---|
| duration (monitoring duration) | INTEGER (2..2559) |
| monitoringSymbolsWithinSlot | BIT STRING (SIZE (14)) |

```
    OPTIONAL,
  (monitoring symbols within slot)
```

| | |
|---|---|
| nrofCandidates | SEQUENCE { |

(number of PDCCH candidates for each aggregation level)

| | |
|---|---|
| aggregationLevel1 | ENUMERATED {n0, n1, n2, n3, n4, n5, n6, n8}, |
| aggregationLevel2 | ENUMERATED {n0, n1, n2, n3, n4, n5, n6, n8}, |
| aggregationLevel4 | ENUMERATED {n0, n1, n2, n3, n4, n5, n6, n8}, |
| aggregationLevel8 | ENUMERATED {n0, n1, n2, n3, n4, n5, n6, n8}, |
| aggregationLevel16 | ENUMERATED {n0, n1, n2, n3, n4, n5, n6, n8} |

},

| | |
|---|---|
| searchSpaceType | CHOICE { |

```
  (search space type)
  -- Configures this search space as common search space (CSS) and DCI formats to
monitor.
```

| | |
|---|---|
| common | SEQUENCE { |

```
  (common search space)
  }
```

| | |
|---|---|
| ue-Specific | SEQUENCE { |

```
  (UE-specific search space)
    -- Indicates whether the UE monitors in this USS for DCI formats 0-0 and 1-0 or
for formats 0-1 and 1-1.
```

| | |
|---|---|
| formats | ENUMERATED {formats0-0-And- |

1-0, formats0-1-And-1-1},
...
}

According to configuration information, the BS may configure one or multiple search space sets for the UE. The BS may configure search space set 1 and search space set 2 for the UE, may configure DCI format A scrambled by an X-RNTI to be monitored in a common search space in search space set 1, and may configure DCI format B scrambled by a Y-RNTI to be monitored in a UE-specific search space in search space set 2.

According to configuration information, one or multiple search space sets may exist in a common search space or a UE-specific search space. For example, search space set #1 and search space set #2 may be configured as a common search space, and search space set #3 and search space set #4 may be configured as a UE-specific search space.

Combinations of DCI formats and RNTIs given below may be monitored in a common search space but are not limited thereto.
DCI format 0 0/1_0 with CRC scrambled by C-RNTI, CS-RNTI, SP-CSI-RNTI, RA-RNTI, TC-RNTI, P-RNTI, SI-RNTI
DCI format 2_0 with CRC scrambled by SFI-RNTI
DCI format 2_1 with CRC scrambled by INT-RNTI
DCI format 2 2 with CRC scrambled by TPC-PUSCH-RNTI, TPC-PUCCH-RNTI
DCI format 2 3 with CRC scrambled by TPC-SRS-RNTI

Combinations of DCI formats and RNTIs given below may be monitored in a UE-specific search space but are not limited thereto.
DCI format 0_0/1_0 with CRC scrambled by C-RNTI, CS-RNTI, TC-RNTI
DCI format 1_0/1_1 with CRC scrambled by C-RNTI, CS-RNTI, TC-RNTI

Enumerated RNTIs may follow the definition and usage given below.
Cell RNTI (C-RNTI) is used to schedule a UE-specific PDSCH
Temporary cell RNTI (TC-RNTI) is used to schedule a UE-specific PDSCH
Configured scheduling RNTI (CS-RNTI) is used to schedule a semi-statically configured UE-specific PDSCH
Random access RNTI (RA-RNTI) is used to schedule a PDSCH in a random access step
Paging RNTI (P-RNTI) is used to schedule a PDSCH in which paging is transmitted
System information RNTI (SI-RNTI) is used to schedule a PDSCH in which system information is transmitted
Interruption RNTI (INT-RNTI) is used to indicate whether a PDSCH is punctured
Transmit power control for PUSCH RNTI (TPC-PUSCH-RNTI) is used to indicate a power control command regarding a PUSCH
Transmit power control for PUCCH RNTI (TPC-PUCCH-RNTI) is used to indicate a power control command regarding a PUCCH
Transmit power control for SRS RNTI (TPC-SRS-RNTI) is used to indicate a power control command regarding an SRS

The DCI formats enumerated above may follow the definitions given in Table 23 below.

TABLE 23

| DCI | |
|---|---|
| format | Usage |
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and OFDM symbol(s) |
| | where UE may assume no transmission is intended for the UE |
| 2_2 | Transmission of TPC commands for PUCCH and PUSCH |
| 2_3 | Transmission of a group of TPC commands for SRS |
| | transmissions by one or more UEs |

In a 5G system, the search space at aggregation level L in connection with CORESET p and search space set s may be expressed by Equation (1) below.

$$\cdot \{ ( {Y}_{p , {n}_{s , f}^{μ}} + ⌊ \frac{{m}_{s , {n}_{CI}} \cdot {N}_{CCE , p}}{L \cdot {M}_{s , max}^{( L )}} ⌋ + {n}_{CI} ) mod ⌊ \frac{{N}_{CCE , p}}{L} ⌋ \} + i \qquad ( 1 )$$

In Equation (1):
L: aggregation level
n_{CI}: carrier index
N_{CCE,p}: total number of CCEs existing in CORESET p

$${n}_{s , f}^{μ} :$$

slot index

$${M}_{s , max}^{( L )}$$

number of PDCCH candidates at aggregation level L

$${m}_{s , {n}_{CI}} = 0 , … , {M}_{s , max}^{( L )} - 1$$

PDCCH candidate index at aggregation level L

$$i = 0 , … , L - 1$$

$${Y}_{p , {n}_{s , f}^{μ}} = ( {A}_{p} \cdot {Y}_{p , {n}_{s , f}^{μ} - 1} ) mod D ,$$

$${Y}_{p , - 1} = {n}_{RNTI} \neq 0 ,$$

$${A}_{p} = 39827 for pmod 3 = 0 ,$$

$${A}_{p} = 39829 for pmod 3 = 1 ,$$

$${A}_{p} = 39839 for pmod 3 = 2 ,$$

$$D = 65 \; 537$$

n_{RNTI}: UE identity

The

$${Y}_{p , {n}_{s , f}^{μ}}$$

value may correspond to 0 in the case of a common search space.

The

$${Y}_{p , {n}_{s , f}^{μ}}$$

value may correspond to a value changed by the UE's identity (C-RNTI or ID configured for the UE by the BS) and the time index in the case of a UE-specific search space.

In 5G, multiple search space sets may be configured by different parameters such as in Table 22, and the group of search space sets monitored by the UE at each time point may differ accordingly. For example, if search space set #1 is configured at X-slot periodicity, and if search space set #2 is configured at Y-slot periodicity, and if X and Y are different, the UE may monitor search space set #1 and search space set #2 both in a specific slot, and may monitor one of search space set #1 and search space set #2 both in another specific slot.

### PUCCH Transmission

In an NR system, a UE may transmit UCI to a BS through a PUCCH. The control information may include at least one of a HARQ-ACK indicating whether the UE has succeeded in demodulating/decoding a transport block (TB) having been received through a PDSCH, a scheduling request (SR) through which the UE requests a PUSCH BS to allocate resources for UL data transmission, and CSI that is information for reporting a channel state of the UE.

PUCCH resources may be generally classified as being for a long PUCCH and a short PUCCH according to the length of allocated symbols. In an NR system, a long PUCCH has a length of 4 or more symbols in a slot, and a short PUCCH has a length of 2 or less symbols in a slot.

A long PUCCH may be used for the purpose of increasing uplink cell coverage, and thus may be transmitted in a discrete Fourier transform (DFT)-S-OFDM scheme relating to single carrier transmission rather than OFDM transmission. A long PUCCH supports transmission formats, such as PUCCH format 1, PUCCH format 3, and PUCCH format 4, according to the number of supportable control information bits, and support or nonsupport of UE multiplexing through pre-DFT orthogonal cover code (OCC) support at an inverse fast Fourier transform (IFFT) front end.

First, PUCCH format 1 is a DFT-S-OFDM-based long PUCCH format capable of supporting control information up to 2 bits, and uses as many frequency resources as 1 RB. The control information may be configured by a HARQ-ACK, an SR, or a combination thereof. UCCH format 1 has a structure in which an OFDM symbol including a demodulation reference signal (DMRS) that is a demodulation reference signal (or reference signal) and an OFDM symbol including UCI are repeated.

For example, if the number of transmission symbols of PUCCH format 1 is 8, the 8 symbols may be configured by a DMRS symbol, a UCI symbol, a DMRS symbol, a UCI symbol, a DMRS symbol, a UCI symbol, a DMRS symbol, and a UCI symbol sequentially starting from the first starting symbol. DMRS symbols may be spread using an orthogonal code (or orthogonal sequence or spreading code, wᵢ(m)) on the time axis for a sequence corresponding to the length of 1 RB on the frequency axis in one OFDM symbol, may be subject to IFFT, and then be transmitted.

In UCI symbols, the UE may perform BPSK modulation of 1-bit control information or QPSK modulation of 2-bit control information to generate d(0), multiply the generated d(0) by a sequence corresponding to the length of 1 RB on the frequency axis to scramble same, spread the scrambled sequence by using an orthogonal code (or orthogonal sequence or spreading code, wᵢ(m)) on the time axis, perform IFFT of the spread sequence, and then transmit same.

The UE generates a sequence, based on a group hopping or sequence hopping configuration and a configured ID configured by the BS through higher layer signaling, and performs a cyclic shift of the generated sequence by using an initial cyclic shift (CS) value configured through a higher signal to generate a sequence corresponding to the length of 1 RB.

Table 24 below provides wᵢ(m) according to the length (N_{SF}) of a spreading code. i means the index of the spreading code itself, and m denotes the index of each element of the spreading code. The numbers in the square brackets [ ] in Table 24 (spreading code

$${w}_{i} ( m ) = {e}^{j {2}_{πφ} ( m ) / {N}_{S F}}$$

for PUCCH format 1) denotes μ(m), and if the length of a spreading code is 2 and the configured index i of the spreading code is 0 (i=0), the spreading code wᵢ(m) becomes

$${w}_{i} ( 0 ) = {e}^{j 2 π0 / {N}_{S F}} = 1 ,$$

$${w}_{i} ( 1 ) = {e}^{j 2 π0 / {N}_{S F}} = 1$$

and thus is equal to wᵢ(m)=[1_1].

TABLE 24

| | φ(m) | | | | | | |
|---|---|---|---|---|---|---|---|
| N_{SF} | i = 0 | i = 1 | i = 2 | i = 3 | i = 4 | i = 5 | i = 6 |
| 1 | [0] | — | — | — | — | — | — |
| 2 | [0 0] | [0 1] | — | — | — | — | — |
| 3 | [0 0 0] | [0 1 2] | [0 2 1] | — | — | — | — |
| 4 | [0 0 0 0] | [0 2 0 2] | [0 0 2 2] | [0 2 2 0] | — | — | — |
| 5 | [0 0 0 0 0] | [0 1 2 3 4] | [0 2 4 1 3] | [0 3 1 4 2] | [0 4 3 2 1] | — | — |
| 6 | [0 0 0 0 0 0] | [0 1 2 3 4 5] | [0 2 4 0 2 4] | [0 3 0 3 0 3] | [0 4 2 0 4 2] | [0 5 4 3 2 1] | — |
| 7 | [0 0 0 0 0 0 0] | [0 1 2 3 4 5 6] | [0 2 4 6 1 3 5] | [0 3 6 2 5 1 4] | [0 4 1 5 2 6 3] | [0 5 3 1 6 4 2] | [0 6 5 4 3 2 1] |

PUCCH format 3 is a DFT-S-OFDM-based long PUCCH format capable of supporting control information greater than 2 bits, and the number of used RBs is configurable through a higher layer. The control information may be configured by a combination or each of a HARQ-ACK, an SR, and CSI. DMRS symbol positions in PUCCH format 3 are shown in Table 25 below according to whether there is frequency hopping in a slot, and whether an additional DMRS symbol is configured.

TABLE 25

| | DMRS location within PUCCH format 3/4 transmission | | | |
|---|---|---|---|---|
| | Additional DMRS is not | | Additional DMRS is | |
| PUCCH | configured | | configured | |
| format 3/4 | Frequency | Frequency | Frequency | Frequency |
| transmission | hopping is not | hopping is | hopping is not | hopping is |
| duration | configured | configured | configured | configured |
| 4 | 1 | 0, 2 | 1 | 0, 2 |

| | | |
|---|---|---|
| 5 | 0, 3 | 0, 3 |
| 6 | 1, 4 | 1, 4 |
| 7 | 1, 4 | 1, 4 |
| 8 | 1, 5 | 1, 5 |
| 9 | 1, 6 | 1, 6 |
| 10 | 2, 7 | 1, 3, 6, 8 |
| 11 | 2, 7 | 1, 3, 6, 9 |
| 12 | 2, 8 | 1, 4, 7, 10 |
| 13 | 2, 9 | 1, 4, 7, 11 |
| 14 | 3, 10 | 1, 5, 8, 12 |

If the number of transmission symbols of PUCCH format 3 is 8, a DMRS is transmitted on a first symbol and a fifth symbol if the 0-th symbol is used as the first starting symbol of the 8 symbols. Table 25 is also applied to DMRS symbol positions of PUCCH format 4 in the same manner.

Next, PUCCH format 4 is a DFT-S-OFDM-based long PUCCH format capable of supporting control information greater than 2 bits, and uses as many frequency resources as 1 RB. The control information may be configured by a combination or each of a HARQ-ACK, an SR, and CSI. The difference between PUCCH format 4 and PUCCH format 3 is that, in PUCCH format 4, PUCCH formats 4 of several UEs are multiplexable in one RB. It is possible to multiplex PUCCH formats 4 of multiple UEs through pre-DFT OCC application to control information at an IFFT front end. However, the number of control information symbols transmittable by one UE is reduced according to the number of multiplexed UEs. The number of multiplexable UEs, that is, the number of available different OCCs may be 2 or 4, and the number of OCCs and OCC indexes to be applied may be configured through a higher layer.

A short PUCCH may be transmitted on both a DL-centric slot and a UL-centric slot, and in general, may be transmitted on the last symbol of a slot or an OFDM symbol positioned in a back part (e.g., the last OFDM symbol, the second last OFDM symbol, or the last two OFDM symbols). It is also possible for a short PUCCH to be transmitted on a random position in a slot. A short PUCCH may be transmitted using one OFDM symbol or two OFDM symbols. A short PUCCH may be used to shorten a delay time, compared to a long PUCCH, when uplink cell coverage is good, and may be transmitted in a CP-OFDM scheme.

A short PUCCH may support transmission formats, such as PUCCH format 0 and PUCCH format 2, according to the number of supportable control information bits. First, PUCCH format 0 is a short PUCCH format capable of supporting control information up to 2 bits, and uses as many frequency resources as 1 RB. The control information may be configured by a HARQ-ACK, an SR, or a combination thereof. PUCCH format 0 has a structure of refraining from transmitting a DMRS and transmitting only a sequence mapped to 12 subcarriers on the frequency axis in one OFDM symbol. The UE may generate a sequence, based on a group hopping or sequence hopping configuration and a configured ID configured by the BS through a higher signal, perform a CS of the generated sequence by using a final CS value obtained after adding, to an indicated initial CS value, a CS value varying according to an ACK or NACK, map the sequence to 12 subcarriers, and transmit the mapped sequence.

For example, if a HARQ-ACK has 1 bit, as shown in Table 26 below, and the HARQ-ACK is an ACK, the UE may generate the final CS by adding 6 to the initial CS value, and if the HARQ-ACK is a NACK, the UE may generate the final CS by adding 0 to the initial CS. The value of 0 that is a CS value for NACK and the value of 6 that is a CS value for ACK are defined in a specification, and the UE may generate PUCCH format 0 according to the values defined in the specification to transmit a 1-bit HARQ-ACK.

TABLE 26

| 1-bit HARQ-ACK | NACK | ACK |
|---|---|---|
| final CS | (initial CS + 0) mod | (initial CS + 6) mod 12 |
| | 12 = initial CS | |

For example, if a HARQ-ACK has 2 bits, as shown in Table 27 below, the UE may add 0 to the initial CS value if the HARQ-ACK is negative-ACK (NACK, NACK), add 3 to the initial CS value if the HARQ-ACK is (NACK, ACK), add 6 to the initial CS value if the HARQ-ACK is (ACK, ACK), and add 9 to the initial CS value if the HARQ-ACK is (ACK, NACK). The value of 0 that is a CS value for (NACK, NACK), the value of 3 that is a CS value for (NACK, ACK), the value of 6 that is a CS value for (ACK, ACK), and the value of 9 that is a CS value for (ACK, NACK) are defined in a specification, and the UE may generate PUCCH format 0 according to the values defined in the specification to transmit a 2-bit HARQ-ACK. If the final CS value exceeds 12 due to the CS value added to the initial CS value according to an ACK or NACK, since length of the sequence is 12, modulo 12 may be applied to the final CS value.

TABLE 27

| 2-bit HARQ-ACK | NACK, NACK | NACK, ACK | ACK, ACK | ACK, NACK |
|---|---|---|---|---|
| final CS | (initial CS + 0) mod | (initial CS + 3) | (initial CS + 6) | (initial CS + 9) |
| | 12 = initial CS | mod 12 | mod 12 | mod 12 |

PUCCH format 2 is a short PUCCH format supporting control information greater than 2 bits, and the number of used RBs may be configured through a higher layer. The control information may be configured by a combination or each of a HARQ-ACK, an SR, and CSI. If the index of a first subcarrier is #0, PUCCH format 2 may be fixed to subcarriers having indexes of #1, #4, #7, and #10 as the positions of subcarriers on which a DMRS is transmitted in one OFDM symbol. The control information may undergo channel coding and then a modulation process to be mapped to the remaining subcarriers except the subcarriers on which the DMRS is positioned.

In summary, configurable values for each PUCCH format described above and the ranges thereof may be organized as shown in Table 28 below, which provides cases where there is no need to configure values are represented as “N.A.”.

TABLE 28

| | | PUCCH | PUCCH | PUCCH | PUCCH | PUCCH |
|---|---|---|---|---|---|---|
| | | format 0 | format 1 | Format 2 | format 3 | format 4 |
| Starting | Configurability | √ | √ | √ | √ | √ |
| symbol | Value range | 0-13 | 0-10 | 0-13 | 0-10 | 0-10 |
| Number of | Configurability | √ | √ | √ | √ | √ |
| symbols in a | Value range | 1, 2 | 4-14 | 1, 2 | 4-14 | 4-14 |
| slot | | | | | | |
| Index for | Configurability | √ | √ | √ | √ | √ |
| identifying | Value range | 0-274 | 0-274 | 0-274 | 0-274 | 0-274 |
| starting PRB) | | | | | | |
| Number of | Configurability | N.A. | N.A. | √ | √ | N.A. |
| PRBs | Value range | N.A. | N.A. | 1-16 | 1-6, | N.A. |
| | | (Default | (Default | | 8-10, 12, | (Default |
| | | is 1) | is 1) | | 15, 16 | is 1) |
| Enabling a | Configurability | √ | √ | √ | √ | |
| FH | Value range | On/Off (only | On/Off | On/Off (only | On/Off | On/Off |
| | | for 2 symbol) | | for 2 symbol) | | |
| (Frequency | Configurability | √ | √ | √ | √ | √ |
| resource of | Value range | 0-274 | 0-274 | 0-274 | 0-274 | 0-274 |
| 2nd hop if FH | | | | | | |
| is enabled | | | | | | |
| Index of | Configurability | √ | √ | N.A. | N.A. | N.A. |
| initial CS | Value range | 0-11 | 0-11 | N.A. | 0-11 | 0-11 |
| Index of | Configurability | N.A. | √ | N.A. | N.A. | N.A. |
| time-domain | Value range | N.A. | 0-6 | N.A. | N.A. | N.A. |
| OCC | | | | | | |
| Length of | Configurability | N.A. | N.A. | N.A. | N.A. | √ |
| Pre-DFT | Value range | N.A. | N.A. | N.A. | N.A. | 2, 4 |
| OCC | | | | | | |
| Index of Pre- | Configurability | N.A. | N.A. | N.A. | N.A. | √ |
| DFT OCC) | Value range | N.A. | N.A. | N.A. | N.A. | 0, 1, 2, 3 |

For UL coverage improvement, multi-slot repeated transmission may be supported for PUCCH formats 1, 3, and 4, and PUCCH repeated transmission may be configured for each PUCCH format. The UE may perform repeated transmission of a PUCCH including UCI as many times as the number of slots configured through the higher layer signaling nrofSlots. For PUCCH repeated transmission, a PUCCH transmission on each slot is performed using the same number of consecutive symbols, and the number of consecutive symbols may be configured through nrofSymbols in the higher layer signaling PUCCH-format1, PUCCH-format3, or PUCCH-format4. For PUCCH repeated transmission, a PUCCH transmission on each slot is performed using the same starting symbol, and the starting symbol may be configured through startingSymbolIndex in the higher layer signaling PUCCH-format1, PUCCH-format3, or PUCCH-format4. For PUCCH repeated transmission, single PUCCH-spatialRelationInfo may be configured for a single PUCCH resource. For PUCCH repeated transmission, if the UE is configured to perform frequency hopping between PUCCH transmissions on different slots, the UE may perform frequency hopping in a unit of a slot.

If the UE is configured to perform frequency hopping between PUCCH transmissions on different slots, the UE may start a PUCCH transmission on an even-numbered slot at a first PRB index configured through the higher layer signaling startingPRB and start a PUCCH transmission on an odd-numbered slot at a second PRB index configured through the higher layer signaling secondHopPRB. Additionally, if the UE is configured to perform frequency hopping between PUCCH transmissions on different slots, the index of a slot indicated for the UE to perform a first PUCCH transmission thereon is 0, and through a configured entire PUCCH repeated transmission count, a PUCCH repeated transmission count value may be increased independently of whether PUCCH transmission is performed on each slot. If the UE is configured to perform frequency hopping between PUCCH transmissions on different slots, the UE does not expect that frequency hopping in a slot at the time of PUCCH transmission is configured. If performing frequency hopping between PUCCH transmissions on different slots is not configured for the UE and frequency hopping in a slot is configured, the first and second PRB indexes may also be identically applied in the slot. If the number of uplink symbols on which PUCCH transmission is possible is less than a number indicated by nrofSymbols configured through higher layer signaling, the UE may not transmit a PUCCH. Even if the UE has failed PUCCH transmission on a slot for a reason during PUCCH repeated transmission, the UE may increase the PUCCH repeated transmission count.

In the relevant standard, the number of slots for repeated transmission of each PUCCH resource in PUCCH-ResourceExt that is an expansion of the higher layer signaling PUCCH-Resource for PUCCH resources may be configured through the higher layer signaling pucch-RepetitionNrofSlots-r17. If the higher layer signaling pucch-RepetitionNrofSlots-r17 is configured, a corresponding PUCCH is configured, and the higher layer signaling nrofSlots is also configured, the UE may determine the number of slots on which the corresponding PUCCH is repeatedly transmitted through pucch-RepetitionNrofSlots-r17 and disregard the higher layer signaling nrofSlots.

### PUCCH Resource Configuration

The BS may be able to configure a PUCCH resource for each BWP for a particular UE through a higher layer. A PUCCH resource configuration may be as shown in Table 29 below.

TABLE 29

| | |
|---|---|
| PUCCH-Config ::= | SEQUENCE { |
| resourceSetToAddModList | SEQUENCE (SIZE (1..maxNrofPUCCH- |
| ResourceSets)) OF PUCCH-ResourceSet | OPTIONAL, -- Need N |
| resourceSetToReleaseList | SEQUENCE (SIZE (1..maxNrofPUCCH- |

ResourceSets)) OF PUCCH-ResourceSetId OPTIONAL, -- Need N

| | |
|---|---|
| resourceToAddModList | SEQUENCE (SIZE (1..maxNrofPUCCH- |
| Resources)) OF PUCCH-Resource | OPTIONAL, -- Need N |
| resourceToReleaseList | SEQUENCE (SIZE (1..maxNrofPUCCH-Resources)) |
| OF PUCCH-ResourceId | OPTIONAL, -- Need N |
| format1 | SetupRelease { PUCCH-FormatConfig } |

OPTIONAL, -- Need M

| | |
|---|---|
| format2 | SetupRelease { PUCCH-FormatConfig } |

OPTIONAL, -- Need M

| | |
|---|---|
| format3 | SetupRelease { PUCCH-FormatConfig } |

OPTIONAL, -- Need M

| | |
|---|---|
| format4 | SetupRelease { PUCCH-FormatConfig } |

OPTIONAL, -- Need M

| | |
|---|---|
| schedulingRequestResourceToAddModList | SEQUENCE (SIZE (1..maxNrofSR-Resources)) OF |

SchedulingRequestResourceConfig
OPTIONAL, -- Need N

| | |
|---|---|
| schedulingRequestResourceToReleaseList | SEQUENCE (SIZE (1..maxNrofSR-Resources)) OF |

SchedulingRequestResourceId
OPTIONAL, -- Need N

| | |
|---|---|
| multi-CSI-PUCCH-ResourceList | SEQUENCE (SIZE (1..2)) OF PUCCH-ResourceId |

OPTIONAL, -- Need M

| | |
|---|---|
| dl-DataToUL-ACK | SEQUENCE (SIZE (1..8)) OF INTEGER (0..15) |

OPTIONAL, -- Need M

| | |
|---|---|
| spatialRelationInfoToAddModList | SEQUENCE (SIZE (1..maxNrofSpatialRelationInfos)) OF |

PUCCH-SpatialRelationInfo
OPTIONAL, -- Need N

| | |
|---|---|
| spatialRelationInfoToReleaseList | SEQUENCE (SIZE (1..maxNrofSpatialRelationInfos)) OF |

PUCCH-SpatialRelationInfoId
OPTIONAL, -- Need N

| | |
|---|---|
| pucch-PowerControl | PUCCH-PowerControl |

```
OPTIONAL, -- Need M
  ...,
  [[
```

| | |
|---|---|
| resourceToAddModListExt-r16 | SEQUENCE (SIZE (1..maxNrofPUCCH- |
| Resources)) OF PUCCH-ResourceExt-r16 | OPTIONAL, -- Need N |
| dl-DataToUL-ACK-r16 | SetupRelease { DL-DataToUL-ACK-r16 |

OPTIONAL, -- Need M

| | |
|---|---|
| ul-AccessConfigListDCI-1-1-r16 | SetupRelease { UL-AccessConfigListDCI-1-1-r16 |

OPTIONAL, -- Need M

| | |
|---|---|
| subslotLengthForPUCCH-r16 | CHOICE { |
| normalCP-r16 | ENUMERATED {n2,n7}, |
| extendedCP-r16 | ENUMERATED {n2,n6} |

}
OPTIONAL, -- Need R

| | |
|---|---|
| dl-DataToUL-ACK-DCI-1-2-r16 | SetupRelease { DL-DataToUL-ACK-DCI-1-2-r16} |

OPTIONAL, -- Need M

| | |
|---|---|
| numberOfBitsForPUCCH-ResourceIndicatorDCI-1-2-r16 | INTEGER (0..3) |

OPTIONAL, -- Need R

| | |
|---|---|
| dmrs-UplinkTransformPrecodingPUCCH-r16 | ENUMERATED {enabled} OPTIONAL, |

-- Cond PI2-BPSK

| | |
|---|---|
| spatialRelationInfoToAddModListSizeExt-v1610 | SEQUENCE (SIZE |

(1..maxNrofSpatialRelationInfosDiff-r16)) OF PUCCH-SpatialRelationInfo
OPTIONAL, -- Need N

| | |
|---|---|
| spatialRelationInfoToReleaseListSizeExt-v1610 | SEQUENCE (SIZE |

(1..maxNrofSpatialRelationInfosDiff-r16)) OF PUCCH-SpatialRelationInfoId
OPTIONAL, -- Need N

| | |
|---|---|
| spatialRelationInfoToAddModListExt-v1610 | SEQUENCE (SIZE |

(1..maxNrofSpatialRelationInfos-r16)) OF PUCCH-SpatialRelationInfoExt-r16
OPTIONAL, -- Need N

| | |
|---|---|
| spatialRelationInfoToReleaseListExt-v1610 | SEQUENCE (SIZE |

(1..maxNrofSpatialRelationInfos-r16)) OF PUCCH-SpatialRelationInfoId-r16 OPTIONAL, --
Need N

| | |
|---|---|
| resource GroupToAddModList-r16 | SEQUENCE (SIZE (1..maxNrofPUCCH- |

ResourceGroups-r16)) OF PUCCH-ResourceGroup-r16
OPTIONAL, -- Need N

| | |
|---|---|
| resourceGroupToReleaseList-r16 | SEQUENCE (SIZE (1..maxNrofPUCCH- |

ResourceGroups-r16)) OF PUCCH-ResourceGroupId-r16
OPTIONAL, -- Need N

| | |
|---|---|
| sps-PUCCH-AN-List-r16 | SetupRelease { SPS-PUCCH-AN-List-r16 } |

OPTIONAL, -- Need M

| | |
|---|---|
| schedulingRequestResourceToAddModListExt-v1610 | SEQUENCE (SIZE (1..maxNrofSR- |

Resources)) OF SchedulingRequestResourceConfigExt-v1610
OPTIONAL -- Need N
]]
}

In Table 29, one or multiple PUCCH resource sets may be configured in a PUCCH resource configuration for a particular BWP, and a maximum payload value for UCI transmission may be configured for some of the PUCCH resource sets. One or multiple PUCCH resources may belong to each PUCCH resource set, and each PUCCH resource may belong to one of the PUCCH formats described above.

In the PUCCH resource sets, a maximum payload value of the first PUCCH resource set may be fixed to 2 bits. Accordingly, the value may not be separately configured through a higher layer. If the remaining PUCCH resource sets are configured, the index of a corresponding PUCCH resource set may be configured in an ascending order according to the maximum payload value, and no maximum payload value may be configured for the last PUCCH resource set. A higher layer configuration for a PUCCH resource set may be as shown in Table 30 below.

TABLE 30

| | |
|---|---|
| PUCCH-ResourceSet ::= | SEQUENCE { |
| pucch-ResourceSetId | PUCCH-ResourceSetId, |
| resourceList | SEQUENCE (SIZE (1..maxNrofPUCCH- |

ResourcesPerSet)) OF PUCCH-ResourceId,

| | |
|---|---|
| maxPayloadSize | INTEGER (4..256) |

OPTIONAL -- Need R
}

The parameter resourceList in Table 30 may include IDs of PUCCH resources belonging to a PUCCH resource set.

At the time of initial access, or if a PUCCH resource set is not configured, a PUCCH resource set, as shown in Table 31 below, configured by multiple PUCCH resources which are cell-specific in an initial BWP, may be used. A PUCCH resource to be used for initial access in the PUCCH resource set may be indicated through SIB1.

TABLE 31

| | PUCCH | First | Number of | PRB offset | Set of initial |
|---|---|---|---|---|---|
| Index | format | symbol | symbols | ${RB}_{BWP}^{offset}$ | CS indexes |
| 0 | 0 | 12 | 2 | 0 | {0, 3} |
| 1 | 0 | 12 | 2 | 0 | {0, 4, 8} |
| 2 | 0 | 12 | 2 | 3 | {0, 4, 8} |
| 3 | 1 | 10 | 4 | 0 | {0, 6} |
| 4 | 1 | 10 | 4 | 0 | {0, 3, 6, 9} |
| 5 | 1 | 10 | 4 | 2 | {0, 3, 6, 9} |
| 6 | 1 | 10 | 4 | 4 | {0, 3, 6, 9} |
| 7 | 1 | 4 | 10 | 0 | {0, 6} |
| 8 | 1 | 4 | 10 | 0 | {0, 3, 6, 9} |
| 9 | 1 | 4 | 10 | 2 | {0, 3, 6, 9} |
| 10 | 1 | 4 | 10 | 4 | {0, 3, 6, 9} |
| 11 | 1 | 0 | 14 | 0 | {0, 6} |
| 12 | 1 | 0 | 14 | 0 | {0, 3, 6, 9} |
| 13 | 1 | 0 | 14 | 2 | {0, 3, 6, 9} |
| 14 | 1 | 0 | 14 | 4 | {0, 3, 6, 9} |
| 15 | 1 | 0 | 14 | $⌊ N {}_{BWP}^{size} / 4 ⌋$ | {0, 3, 6, 9} |

A maximum payload of each of PUCCH resources included in the PUCCH resource set may be 2 bits in PUCCH format 0 or 1, and may be determined according to a symbol length, the number of PRBs, and a maximum code rate in the remaining formats. The symbol length and the number of PRBs may be configured for each PUCCH resource, and the maximum code rate may be configured for each PUCCH format.

In SR transmission, a PUCCH resource for an SR corresponding to schedulingRequestID as shown in Table 32 below may be configured through a higher layer.

5 The PUCCH resource may be a resource belonging to PUCCH format 0 or PUCCH format 1.

TABLE 32

| SchedulingRequestResourceConfig ::= | SEQUENCE { |
|---|---|
| schedulingRequestResourceId | SchedulingRequestResourceId, |
| schedulingRequestID | SchedulingRequestId, |
| periodicityAndOffset | CHOICE { |
| sym2 | NULL, |
| sym6or7 | NULL, |
| sl1 | NULL, -- |
| Recurs in every slot | |
| sl2 | INTEGER (0..1), |
| sl4 | INTEGER (0..3), |
| sl5 | INTEGER (0..4), |
| sl8 | INTEGER (0..7), |
| sl10 | INTEGER (0..9), |
| sl16 | INTEGER (0..15), |
| sl20 | INTEGER (0..19), |
| sl40 | INTEGER (0..39), |
| sl80 | INTEGER (0..79), |
| sl160 | INTEGER (0..159), |
| sl320 | INTEGER (0..319), |
| sl640 | INTEGER (0..639) |

```
  }
OPTIONAL, -- Need M
  resource PUCCH-ResourceId OPTIONAL
-- Need M
}
```

A transmission period and an offset of the configured PUCCH resource may be configured through the parameter periodicity AndOffset in Table 32. If there is UL data to be transmitted by the UE at a time point corresponding to the configured period and offset, the PUCCH resource is transmitted. Otherwise, the PUCCH resource may not be transmitted.

In CSI transmission, a PUCCH resource on which a periodic CSI report or a semi-persistent CSI report through a PUCCH is to be transmitted may be configured in the parameter pucch-CSI-ResourceList as shown in Table 33 below. The parameter pucch-CSI-ResourceList may include a list of PUCCH resources for each BWP for a cell or CC on which the CSI report is to be transmitted. The PUCCH resource may be a resource belonging to PUCCH format 2, PUCCH format 3, or PUCCH format 4. A transmission period and an offset of the PUCCH resource may be configured through reportSlotConfig in Table 33 below.

TABLE 33

| CSI-ReportConfig ::= | SEQUENCE { |
|---|---|
| reportConfigId | CSI-ReportConfigId, |
| carrier | ServCellIndex |
| OPTIONAL, -- Need S | |
| ... | |
| reportConfigType | CHOICE { |
| periodic | SEQUENCE { |
| reportSlotConfig | CSI-ReportPeriodicityAndOffset, |
| pucch-CSI-ResourceList | SEQUENCE (SIZE (1..maxNrofBWPs)) |
| OF PUCCH-CSI-Resource | |
| }, | |
| semiPersistentOnPUCCH | SEQUENCE { |
| reportSlotConfig | CSI-ReportPeriodicityAndOffset, |
| pucch-CSI-ResourceList | SEQUENCE (SIZE (1..maxNrofBWPs)) |
| OF PUCCH-CSI-Resource | |
| }, | |
| semiPersistentOnPUSCH | SEQUENCE { |
| reportSlotConfig | ENUMERATED {sl5, sl10, sl20, sl40, |
| sl80, sl160, sl320}, | |
| reportSlotOffsetList | SEQUENCE (SIZE (1..maxNrofUL- |
| Allocations)) OF INTEGER(0..32), | |
| p0alpha | P0-PUSCH-AlphaSetId |
| }, | |
| aperiodic | SEQUENCE { |
| reportSlotOffsetList | SEQUENCE (SIZE (1..maxNrofUL- |

```
Allocations)) OF INTEGER(0..32)
  }
  },
  ...
}
```

In HARQ-ACK transmission, a resource set of PUCCH resources to be transmitted may be first selected according to a payload of UCI including the HARQ-ACK. That is, a PUCCH resource set having a minimum payload greater than or equal to that of the UCI payload may be selected. Next, a PUCCH resource in the PUCCH resource set may be selected through a PUCCH resource indicator (PRI) in DCI scheduling a TB corresponding to the HARQ-ACK, and the PRI may be a PUCCH resource indicator specified above in Table 19 or Table 20. A relation between a PRI and a PUCCH resource selected in the PUCCH resource set may be as shown in Table 34 below.

TABLE 34

| PUCCH resource indicator | PUCCH resource |
|---|---|
| ‘000’ | 1^{st} PUCCH resource provided by pucch-ResourceId obtained from the |
| | 1^{st} value of resourceList |
| ‘001’ | 2^{nd} PUCCH resource provided by pucch-ResourceId obtained from the |
| | 2^{nd} value of resourceList |
| ‘010’ | 3^{rd} PUCCH resource provided by pucch-ResourceId obtained from the |
| | 3^{rd} value of resourcelist |
| ‘011’ | 4^{th} PUCCH resource provided by pucch-ResourceId obtained from the |
| | 4^{th} value of resourceList |
| ‘100’ | 5^{th} PUCCH resource provided by pucch-ResourceId obtained from the |
| | 5^{th} value of resourceList |
| ‘101’ | 6^{th} PUCCH resource provided by pucch-ResourceId obtained from the |
| | 6^{th} value of resourceList |
| ‘110’ | 7^{th} PUCCH resource provided by pucch-ResourceId obtained from the |
| | 7^{th} value of resourceList |
| ‘111’ | 8^{th} PUCCH resource provided by pucch-ResourceId obtained from the |
| | 8^{th} value of resourceList |

If the number of PUCCH resources in a selected PUCCH resource set is greater than 8, a PUCCH resource may be selected by Equation (2) below.

$${r}_{PUCCH} = \{ \begin{matrix}\begin{matrix}⌊ \frac{{n}_{CCE , p} \cdot ⌈ {R}_{PUCCH} / 8 ⌉}{{N}_{CCE , p}} ⌋ + \\ {Δ}_{PRI} \cdot ⌈ \frac{{R}_{PUCCH}}{8} ⌉\end{matrix} & if {Δ}_{PRI} < {R}_{PUCCH} mod 8 \\ \begin{matrix}⌊ \frac{{n}_{CCE , p} \cdot ⌊ {R}_{PUCCH} / 8 ⌋}{{N}_{CCE , p}} ⌋ + \\ {Δ}_{PRI} \cdot ⌊ \frac{{R}_{PUCCH}}{8} ⌋ + \\ {R}_{PUCCH} mod 8\end{matrix} & if {Δ}_{PRI} \geq {R}_{PUCCH} mod 8\end{matrix} \} \qquad ( 2 )$$

In Equation (2), r_{PUCCH} denotes the index of the selected PUCCH resource in the PUCCH resource set, R_{PUCCH} denotes the number of the PUCCH resources belonging to the PUCCH resource set, Δ_{PRI} denotes a PRI value, N_{CCE,p} denotes a total number of CCEs of CORESET p to which reception DCI belongs, and n_{CCE,p} denotes the index of a first CCE for the reception DCI.

A time point at which the PUCCH resource is transmitted is a time point after K₁ slots after transmission of a TB corresponding to the HARQ-ACK. A candidate of the K₁ value is configured through a higher layer and, more specifically, may be configured in the parameter dl-DataToUL-ACK in PUCCH-Config specified above in Table 29.

One K₁ value among these candidates may be selected by a PDSCH-to-HARQ feedback timing indicator in DCI scheduling a TB, and the value may be a value specified in Table 18 or Table 19. The unit of the K₁ value may be a unit of a slot or a unit of a subslot. A subslot is a length unit smaller than a slot, and one subslot may be configured by one or multiple symbols.

Next, a case where two or more PUCCH resources are positioned in one slot is described. A UE may transmit UCI through one or two PUCCH resources in one slot or subslot, and when UCI is transmitted through two PUCCH resources in one slot/subslot, i) each PUCCH resource does not overlap in a unit of a symbol, and ii) at least one PUCCH resource may be a short PUCCH. The UE may not expect to transmit multiple PUCCH resources for HARQ-ACK transmission in one slot.

### PUSCH Transmission Scheme

PUSCH transmission may be dynamically scheduled by a UL grant inside DCI, or operated by means of configured grant Type 1 or Type 2. Dynamic scheduling indication regarding PUSCH transmission may be made by DCI format 0_0 or 0_1.

Configured grant Type 1PUSCH transmission may be configured semi-statically by receiving configuredGrantConfig including rrc-ConfiguredUplinkGrant in Table 35 below through higher signaling, without receiving a UL grant inside DCI. Configured grant Type 2PUSCH transmission may be scheduled semi-persistently by a UL grant inside DCI after receiving configuredGrantConfig not including rrc-ConfiguredUplinkGrant in Table 35 through higher signaling. If PUSCH transmission is operated by a configured grant, parameters applied to the PUSCH transmission are applied through configuredGrantConfig (higher signaling) in Table 35 except for dataScramblingIdentityPUSCH, txConfig, codebookSubset, maxRank, and scaling of UCI-OnPUSCH, which are provided by pusch-Config (higher signaling) in Table 36 below. If provided with transformPrecoder inside configuredGrantConfig (higher signaling) in Table 35 below, the UE applies tp-pi2BPSK inside pusch-Config in Table 36 to PUSCH transmission operated by a configured grant.

TABLE 35

| | |
|---|---|
| ConfiguredGrantConfig ::= | SEQUENCE { |
| frequencyHopping | ENUMERATED {intraSlot, interSlot} |
| OPTIONAL, -- Need S, | DMRS-UplinkConfig, |

cg-DMRS-Configuration

| | |
|---|---|
| mcs-Table | ENUMERATED {qam256, qam64LowSE} |

OPTIONAL, -- Need S

| | |
|---|---|
| mcs-TableTransformPrecoder | ENUMERATED {qam256, qam64LowSE} |

OPTIONAL, -- Need S

| | |
|---|---|
| uci-OnPUSCH | SetupRelease { CG-UCI-OnPUSCH } |

OPTIONAL, -- Need M

| | |
|---|---|
| resourceAllocation | ENUMERATED { resourceAllocationType0, |

resourceAllocationType1, dynamicSwitch },

| | |
|---|---|
| rbg-Size | ENUMERATED {config2} |

OPTIONAL, -- Need S

| | |
|---|---|
| powerControlLoopToUse | ENUMERATED {n0, n1}, |
| p0-PUSCH-Alpha | P0-PUSCH-AlphaSetId, |
| transformPrecoder | ENUMERATED {enabled, disabled} |

OPTIONAL, -- Need S

| | |
|---|---|
| nrofHARQ-Processes | INTEGER(1..16), |
| repK | ENUMERATED {n1, n2, n4, n8}, |
| repK-RV | ENUMERATED {s1-0231, s2-0303, s3-0000} |

OPTIONAL, -- Need R

| | |
|---|---|
| periodicity | ENUMERATED { |
| | sym2, sym7, sym1x14, sym2x14, sym4x14, |

sym5x14, sym8x14, sym10x14, sym16x14, sym20x14,

sym32x14, sym40x14, sym64x14,

sym80x14, sym128x14, sym160x14, sym256x14, sym320x14, sym512x14,

sym640x14, sym1024x14, sym1280x14,

sym2560x14, sym5120x14,

sym6, sym1x12, sym2x12, sym4x12,

sym5x12, sym8x12, sym10x12, sym16x12, sym20x12, sym32x12,

sym40x12, sym64x12, sym80x12,

sym128x12, sym160x12, sym256x12, sym320x12, sym512x12, sym640x12,

sym1280x12, sym2560x12

},

| | |
|---|---|
| configuredGrantTimer | INTEGER (1..64) |

OPTIONAL, -- Need R

| | |
|---|---|
| rrc-ConfiguredUplinkGrant | SEQUENCE { |
| timeDomainOffset | INTEGER (0..5119), |
| timeDomainAllocation | INTEGER (0..15), |
| frequencyDomainAllocation | BIT STRING (SIZE(18)), |
| antennaPort | INTEGER (0..31), |
| dmrs-SeqInitialization | INTEGER (0..1) |

OPTIONAL, -- Need R

| | |
|---|---|
| precodingAndNumberOfLayers | INTEGER (0..63), |
| srs-ResourceIndicator | INTEGER (0..15) |

OPTIONAL, -- Need R

| | |
|---|---|
| mcsAndTBS | INTEGER (0..31), |
| frequencyHoppingOffset | INTEGER (1.. |
| maxNrofPhysicalResourceBlocks−1) | OPTIONAL, -- Need R |
| pathlossReferenceIndex | INTEGER (0..maxNrofPUSCH- |

```
PathlossReferenceRSs−1),
  ...
  }
OPTIONAL, -- Need R
  ...
}
```

The DMRS antenna port for PUSCH transmission is identical to an antenna port for SRS transmission. PUSCH transmission may follow a codebook-based transmission method and a non-codebook-based transmission method according to whether the value of txConfig inside pusch-Config in Table 36, which is higher signaling, is “codebook” or “nonCodebook”.

As described above, PUSCH transmission may be dynamically scheduled through DCI format 0_0 or 0_1 and may be semi-statically configured by a configured grant. Upon receiving indication of scheduling regarding PUSCH transmission through DCI format 0_0, the UE performs beam configuration for PUSCH transmission by using pucch-spatialRelationInfoID corresponding to a UE-specific PUCCH resource corresponding to the minimum ID inside an activated uplink BWP inside a serving cell, and the PUSCH transmission is based on a single antenna port. The UE does not expect scheduling regarding PUSCH transmission through DCI format 0_0 inside a BWP having no configured PUCCH resource including pucch-spatialRelationInfo. If the UE has no configured txConfig inside pusch-Config in Table 36 below, the UE does not expect scheduling through DCI format 0_1.

TABLE 36

| | |
|---|---|
| PUSCH-Config ::= | SEQUENCE { |
| dataScramblingIdentityPUSCH | INTEGER (0..1023) |

OPTIONAL, -- Need S

| | |
|---|---|
| txConfig | ENUMERATED {codebook, nonCodebook} |

OPTIONAL, -- Need S

| | |
|---|---|
| dmrs-UplinkForPUSCH-MappingTypeA | SetupRelease { DMRS-UplinkConfig } |

OPTIONAL, -- Need M

| | |
|---|---|
| dmrs-UplinkForPUSCH-MappingTypeB | SetupRelease { DMRS-UplinkConfig } |

OPTIONAL, -- Need M

| | |
|---|---|
| pusch-PowerControl | PUSCH-PowerControl |

OPTIONAL, -- Need M

| | |
|---|---|
| frequencyHopping | ENUMERATED {intraSlot, interSlot} |

OPTIONAL, -- Need S

| | |
|---|---|
| frequencyHoppingOffsetLists | SEQUENCE (SIZE (1..4)) OF INTEGER (1.. |

maxNrofPhysicalResourceBlocks−1)
OPTIONAL, -- Need M

| | |
|---|---|
| resourceAllocation | ENUMERATED { resourceAllocationType0, |

resourceAllocationType1, dynamicSwitch},

| | |
|---|---|
| pusch-TimeDomainAllocationList | SetupRelease { PUSCH- |
| TimeDomainResourceAllocationList } | OPTIONAL, -- Need M |
| pusch-AggregationFactor | ENUMERATED { n2, n4, n8 } |

OPTIONAL, -- Need S

| | |
|---|---|
| mcs-Table | ENUMERATED {qam256, qam64LowSE} |

OPTIONAL, -- Need S

| | |
|---|---|
| mcs-TableTransformPrecoder | ENUMERATED {qam256, qam64LowSE} |

OPTIONAL, -- Need S

| | |
|---|---|
| transformPrecoder | ENUMERATED {enabled, disabled} |

OPTIONAL, -- Need S

| | |
|---|---|
| codebookSubset | ENUMERATED |

{fullyAndPartialAndNonCoherent, partialAndNonCoherent,nonCoherent}
OPTIONAL, -- Cond codebookBased

| | |
|---|---|
| maxRank | INTEGER (1..4) |

OPTIONAL, -- Cond codebookBased

| | |
|---|---|
| rbg-Size | ENUMERATED { config2} |

OPTIONAL, -- Need S

| | |
|---|---|
| uci-OnPUSCH | SetupRelease { UCI-OnPUSCH} |

OPTIONAL, -- Need M

| | |
|---|---|
| tp-pi2BPSK | ENUMERATED {enabled} |

OPTIONAL, -- Need S
...
}

The codebook-based PUSCH transmission may be dynamically scheduled through DCI format 0_0 or 0_1 and may be operated semi-statically by a configured grant. If a codebook-based PUSCH is dynamically scheduled through DCI format 0_1 or configured semi-statically by a configured grant, the UE determines a precoder for PUSCH transmission, based on an SRS resource indicator (SRI), a transmission precoding matrix indicator (TPMI), and a transmission rank (the number of PUSCH transmission layers).

The SRI may be given through the SRS resource indicator (a field inside DCI) or configured through srs-ResourceIndicator (higher signaling). During codebook-based PUSCH transmission, the UE has at least one SRS resource configured therefor and may have a maximum of two SRS resources configured therefor. If the UE is provided with the SRI through DCI, the SRS resource indicated by the corresponding SRI refers to the SRS resource corresponding to the SRI, among SRS resources transmitted prior to the PDCCH including the corresponding SRI. In addition, the TPMI and the transmission rank may be given through “precoding information and number of layers” (a field inside DCI) or configured through precodingAndNumberOfLayers (higher signaling). The TPMI is used to indicate a precoder to be applied to PUSCH transmission. If one SRS resource is configured for the UE, the TPMI may be used to indicate a precoder to be applied in the configured one SRS resource. If multiple SRS resources are configured for the UE, the TPMI is used to indicate a precoder to be applied in an SRS resource indicated through the SRI.

The precoder to be used for PUSCH transmission is selected from a UL codebook having the same number of antenna ports as the value of nrofSRS-Ports inside SRS-Config (higher signaling). In connection with codebook-based PUSCH transmission, the UE determines a codebook subset, based on codebookSubset inside pusch-Config (higher signaling) and TPMI. The codebookSubset inside pusch-Config (higher signaling) may be configured to be one of “fully AndPartialAndNonCoherent”, “partialAndNonCoherent”, or “nonCoherent”, based on UE capability reported by the UE to the BS. If the UE reported “partialAndNonCoherent” as UE capability, the UE does not expect that the value of codebookSubset (higher signaling) will be configured as “fully AndPartialAndNonCoherent”. If the UE reported “nonCoherent” as UE capability, UE does not expect that the value of codebook Subset (higher signaling) will be configured as “fullyAndPartialAndNonCoherent” or “partialAndNonCoherent”. If nrofSRS-Ports inside SRS-ResourceSet (higher signaling) indicates two SRS antenna ports, the UE does not expect that the value of codebookSubset (higher signaling) will be configured as “partialAndNonCoherent”.

The UE may have one SRS resource set configured therefor, wherein the value of usage inside SRS-ResourceSet (higher signaling) is “codebook”, and one SRS resource may be indicated through an SRI inside the corresponding SRS resource set. If multiple SRS resources are configured inside the SRS resource set wherein the value of usage inside SRS-ResourceSet (higher signaling) is “codebook”, the UE expects that the value of nrofSRS-Ports inside SRS-Resource (higher signaling) is identical for all SRS resources.

The UE transmits, to the BS, one or multiple SRS resources included in the SRS resource set wherein the value of usage is configured as “codebook” according to higher signaling, and the BS selects one from the SRS resources transmitted by the UE and indicates the UE to be able to transmit a PUSCH by using transmission beam information of the corresponding SRS resource. In connection with the codebook-based PUSCH transmission, the SRI is used as information for selecting the index of one SRS resource and is included in DCI. Additionally, the BS adds information indicating the rank and TPMI to be used by the UE for PUSCH transmission to the DCI. Using the SRS resource indicated by the SRI, the UE applies, in performing PUSCH transmission, the precoder indicated by the rank and TPMI indicated based on the transmission beam of the corresponding SRS resource, thereby performing PUSCH transmission.

The non-codebook-based PUSCH transmission may be dynamically scheduled through DCI format 0_0 or 0_1 and may be operated semi-statically by a configured grant. If at least one SRS resource is configured inside an SRS resource set wherein the value of usage inside SRS-ResourceSet (higher signaling) is “nonCodebook”, non-codebook-based PUSCH transmission may be scheduled for the UE through DCI format 0_1.

In the SRS resource set wherein the value of usage inside SRS-ResourceSet (higher signaling) is “nonCodebook”, one connected NZP CSI-RS resource may be configured for the UE. The UE may calculate a precoder for SRS transmission by measuring the NZP CSI-RS resource connected to the SRS resource set. If the difference between the last received symbol of an aperiodic NZP CSI-RS resource connected to the SRS resource set and the first symbol of aperiodic SRS transmission in the UE is less than 42 symbols, the UE does not expect that information regarding the precoder for SRS transmission will be updated.

If the configured value of resourceType inside SRS-ResourceSet (higher signaling) is “aperiodic”, the connected NZP CSI-RS is indicated by an SRS request which is a field inside DCI format 0_1 or 1_1. If the connected NZP CSI-RS resource is an aperiodic NZP CSI-RS resource, the existence of the connected NZP CSI-RS is indicated in the case in which the value of SRS request (a field inside DCI format 0_1 or 1_1) is not “00”. The corresponding DCI should not indicate cross carrier or cross BWP scheduling. In addition, if the value of SRS request indicates the existence of a NZP CSI-RS, the NZP CSI-RS is in the slot used to transmit the PDCCH including the SRS request field. In this case, TCI states configured for the scheduled subcarrier are not configured as QCL-TypeD.

If there is a periodic or semi-persistent SRS resource set configured, the connected NZP CSI-RS may be indicated through associatedCSI-RS inside SRS-ResourceSet (higher signaling). In non-codebook-based transmission, the UE does not expect that spatialRelationInfo which is higher signaling regarding the SRS resource and associatedCSI-RS inside SRS-ResourceSet (higher signaling) will be configured together.

If multiple SRS resources are configured for the UE, the UE may determine a precoder to be applied to PUSCH transmission and the transmission rank, based on an SRI indicated by the BS. The SRI may be indicated through the SRS resource indicator (a field inside DCI) or configured through srs-ResourceIndicator (higher signaling). Similarly to the above-described codebook-based PUSCH transmission, if the UE is provided with the SRI through DCI, the SRS resource indicated by the corresponding SRI refers to the SRS resource corresponding to the SRI, among SRS resources transmitted prior to the PDCCH including the corresponding SRI. The UE may use one or multiple SRS resources for SRS transmission, and the maximum number of SRS resources that can be transmitted simultaneously in the same symbol inside one SRS resource set and the maximum number of SRS resources are determined by UE capability reported to the BS by the UE. SRS resources simultaneously transmitted by the UE occupy the same RB. The UE configures one SRS port for each SRS resource. There may be only one configured SRS resource set wherein the value of usage inside SRS-ResourceSet (higher signaling) is “nonCodebook”, and a maximum of four SRS resources may be configured for non-codebook-based PUSCH transmission.

The BS transmits one NZP-CSI-RS connected to the SRS resource set to the UE, and the UE calculates the precoder to be used when transmitting one or multiple SRS resources inside the corresponding SRS resource set, based on the result of measurement when the corresponding NZP-CSI-RS is received. The UE applies the calculated precoder when transmitting, to the BS, one or multiple SRS resources inside the SRS resource set wherein the configured usage is “nonCodebook”, and the BS selects one or multiple SRS resources from the received one or multiple SRS resources. In connection with the non-codebook-based PUSCH transmission, the SRI indicates an index that may express one SRS resource or a combination of multiple SRS resources, and the SRI is included in DCI. The number of SRS resources indicated by the SRI transmitted by the BS may be the number of transmission layers of the PUSCH, and the UE transmits the PUSCH by applying the precoder applied to SRS resource transmission to each layer.

### PUSCH: Preparation Procedure Time

If a BS schedules a UE so as to transmit a PUSCH by using DCI format 0_0, 0_1, or 0_2, the UE may require a PUSCH preparation procedure time such that a PUSCH is transmitted by applying a transmission method (SRS resource transmission precoding method, the number of transmission layers, spatial domain transmission filter) indicated through DCI. The PUSCH preparation procedure time is defined in NR in consideration thereof. The PUSCH preparation procedure time of the UE may be calculated using Equation (3) below.

$${T}_{p roc , 2} = max ( ( {N}_{2} + {d}_{2 , 1} + {d}_{2} ) ( 2048 + 1 \; 44 ) {κ2}^{- μ} {T}_{c} + {T}_{e x t} + {T}_{s w i t c h} , {d}_{2 , 2} ) \qquad ( 3 )$$

In Equation (3), each parameter in T_{proc,2} may have the following meaning.
N₂: the number of symbols determined according to UE processing capability 1 or 2, based on the UE's capability, and numerology μ. N₂ may have a value in Table 37 below if UE processing capability 1 is reported according to the UE's capability report, and may have a value in Table 38 below if UE processing capability 2 is reported, and if availability of UE processing capability 2 is configured through higher layer signaling.

TABLE 37

| μ | PUSCH preparation time N₂ [symbols] |
|---|---|
| 0 | 10 |
| 1 | 12 |
| 2 | 23 |
| 3 | 36 |

TABLE 38

| μ | PUSCH preparation time N₂ [symbols] |
|---|---|
| 0 | 5 |
| 1 | 5.5 |
| 2 | 11 for frequency range 1 |

d_{2,1}: the number of symbols determined to be 0 if all REs of the first OFDM symbol of PUSCH transmission include DM-RSs, and to be 1 otherwise. −κ: 64
μ: follows a value, among μDL and μ_{UL}, which makes T_{proc,2} larger. μDL refers to the numerology of a DL used to transmit a PDCCH including DCI that schedules a PUSCH, and μ_{UL} refers to the numerology of a UL used to transmit a PUSCH.

$${T}_{c} : has 1 / ( Δ {f}_{max} \cdot {N}_{f} ) , Δ {f}_{max} = 480 \cdot {10}^{3} Hz , {N}_{f} = 4096 . .$$

d_{2,2}: follows a BWP switching time if DCI that schedules a PUSCH indicates BWP switching, and has 0 otherwise.
d₂: if OFDM symbols overlap temporally between a PUSCH having a high priority index and a PUCCH having a low priority index, the d₂ value of the PUSCH having a high priority index is used. Otherwise, d₂ is 0.
Tₑₓₜ: if the UE uses a shared spectrum channel access scheme, the UE may calculate Tₑₓₜ and apply the same to a PUSCH preparation procedure time. Otherwise, Tₑₓₜ is assumed to be 0.
T_{switch}: if a UL switching spacing has been triggered, T_{switch} is assumed to be the switching spacing time. Otherwise, T_{switch} is assumed to be 0.

The BS and the UE determine that the PUSCH preparation procedure time is insufficient if the first symbol of a PUSCH starts earlier than the first UL symbol in which a CP starts after T_{proc,2} from the last symbol of a PDCCH including DCI that schedules the PUSCH, in view of the influence of timing advance between the UL and the DL and time domain resource mapping information of the PUSCH scheduled through the DCI. Otherwise, the BS and the UE determine that the PUSCH preparation procedure time is sufficient. The UE may transmit the PUSCH only if the PUSCH preparation procedure time is sufficient and may ignore the DCI that schedules the PUSCH if the PUSCH preparation procedure time is insufficient.

### UE Capability Report

In LTE and NR, a UE may perform a procedure in which, while being connected to a serving BS, the UE may report capability supported by the UE to the corresponding BS. In the following description, the above-described procedure will be referred to as a UE capability report.

The BS may transfer a UE capability enquiry message to the UE in a connected state so as to request a capability report. The message may include a UE capability request in each radio access technology (RAT) type of the BS. The RAT type-specific request may include supported frequency band combination information and the like. In the UE capability enquiry message, UE capability in multiple RAT types may be requested through one RRC message container transmitted by the BS, or the BS may transfer a UE capability enquiry message including multiple UE capability requests in respective RAT types. That is, a capability enquiry may be repeated multiple times in one message, and the UE may configure a UE capability information message corresponding thereto and report the same multiple times. In next-generation mobile communication systems, a UE capability request may be made regarding multi-RAT DC (MR-DC), such as NR, LTE, evolved universal terrestrial radio access (E-UTRA)-NR dual connectivity (EN-DC). The UE capability enquiry message may be transmitted initially after the UE is connected to the BS, in general, but may be requested in any condition if needed by the BS.

Upon receiving the UE capability report request from the BS in the above step, the UE configures UE capability according to band information and RAT type requested by the BS. The method in which the UE configures UE capability in an NR system is summarized below.
1. If the UE receives a list regarding LTE and/or NR bands from the BS at a UE capability request, the UE constructs band combinations (BCs) regarding EN-DC and NR standalone (SA). That is, the UE configures a candidate list of BCs regarding EN-DC and NR SA, based on bands received from the BS at a request through FreqBandList. Bands have priority in the order described in FreqBandList.
2. If the BS sets “eutra-nr-only” flag or “eutra” flag and requests a UE capability report, the UE removes everything related to NR SA BCs from the configured BC candidate list. Such an operation may occur only if an LTE BS (eNB) requests “eutra” capability.
3. The UE then removes fallback BCs from the BC candidate list configured in the above step. As used herein, a fallback BC refers to a BC that can be obtained by removing a band corresponding to at least one SCell from a specific BC, and since a BC before removal of the band corresponding to at least one SCell can already cover a fallback BC, the same may be omitted. This step is applied in MR-DC as well, that is, LTE bands are also applied. BCs remaining after the above step constitute the final “candidate BC list”.
4. The UE selects BCs appropriate for the requested RAT type from the final “candidate BC list” and configures BCs to report. In this step, the UE configures supportedBandCombinationList in a determined order. That is, the UE configures BCs and UE capability to report according to a preconfigured rat-Type order. (nr->eutra-nr->eutra). In addition, the UE configures featureSetCombination regarding the configured supportedBandCombinationList and configures a list of “candidate feature set combinations” from a candidate BC list from which a list regarding fallback BCs (including capability of the same or lower step) is removed. The “candidate feature set combinations” may include all feature set combinations regarding NR and EUTRA-NR BCs, and may be acquired from feature set combinations of containers of UE-NR-Capabilities and UE-MRDC-Capabilities.
5. If the requested RAT type is eutra-nr and has an influence, featureSetCombinations is on both containers of UE-MRDC-Capabilities and UE-NR-Capabilities. However, the feature set of NR is included only in UE-NR-Capabilities.

After the UE capability is configured, the UE transfers a UE capability information message including the UE capability to the BS. The BS performs scheduling and transmission/reception management appropriate for the UE, based on the UE capability received from the UE.

For L1-RSRP calculation, the following details may be considered.

The UE may be configured with one or more CSI-RS resources, one or more SSB resources, or both CSI-RS resources and SSB resources that have a QCL relationship between resources in terms of QCL-TypeC and QCL-TypeD, and the CSI-RS resources and SSB resources may be included in different resource sets.

The UE may be configured with up to 64 CSI-RS resources within a single CSI-RS resource set.

The UE may be configured with up to 16 CSI-RS resource sets.

The UE may be configured with up to 128 different CSI-RS resources across all CSI-RS resource sets.

For L1-RSRP reporting, in case that the UE is configured with a value of 1 for the higher layer signaling nrofReportedRS in CSI-ReportConfig, the reported L1-RSRP value may be quantized by using 7 bits, and the reported L1-RSRP value may be defined as a 1 dB-interval value within a range from-140 dBm to-44 dBm. In case that the UE is configured with a value greater than 1 for the higher layer signaling nrofReportedRS in CSI-ReportConfig, or that the UE is configured with the higher layer signaling groupBasedBeamReporting set to “enabled”, the UE may quantize the largest L1-RSRP value among the measured values by using 7 bits, and the largest L1-RSRP value may be defined as a 1 decibel (dB)-interval value within a range from-140 decibel milliwatts (dBm) to-44 dBm. In this case, a differential L1-RSRP, which may indicate a relative RSRP value with respect to the largest L1-RSRP value, may be quantized by using 4 bits, and the interval of the differential L1-RSRP value may be defined as 2 dB. The differential L1-RSRP may be reported together with the largest L1-RSRP value.

If the higher layer signaling timeRestrictionForChannelMeasurements configured in CSI-ReportConfig is set to “notConfigured” for the UE, the UE may calculate an L1-RSRP value to be reported in UL slot n, based on CSI-RS or SSB included in the CSI resource setting associated with the L1-RSRP report, which has been received within or prior to the CSI reference resource that may be defined in the time domain.

If the higher layer signaling timeRestrictionForChannelMeasurements configured in CSI-ReportConfig is set to “Configured” for the UE, the UE may calculate an L1-RSRP value to be reported in UL slot n, based only on the most recently received CSI-RS or SSB among those included in the CSI resource setting associated with the L1-RSRP report, which has been received within or prior to the CSI reference resource that may be defined in the time domain.

Table 39 below shows the order of information placement for L1-RSRP reporting. The bit lengths of the CRI and SSBRI may be defined by the number of bits that may represent the number of CSI-RS resources in the CSI-RS resource set

$$( e . g . , ⌈ {log}_{2} ( {K}_{s}^{CSI - RS} ) ⌉ )$$

or the number of bits that may represent the number of SSB resources in the

$$( e . g . , ⌈ {log}_{2} ( {K}_{s}^{SSB - RS} ) ⌉ ) , where {κ}_{s}^{CSI - RS} and {κ}_{s}^{SSB}$$

may respectively denote the number of CSI-RS resources within the CSI-RS resource set and the number of SSB resources within the SSB resource set. As described above, the RSRP and the differential RSRP may be represented using 7 bits and 4 bits, respectively.

TABLE 39

| CSI report number | CSI fields |
|---|---|
| CSI report #n | CRI or SSBRI #1 |
| | CRI or SSBRI #1 |
| | CRI or SSBRI #1 |
| | CRI or SSBRI #1 |
| | RSRP #1 |
| | Differential RSRP #2 |
| | Differential RSRP #3 |
| | Differential RSRP #4 |

Table 26 above relates to the CSI-ReportConfig configured via higher layer signaling associated with CSI reporting, and may be used for the subsequent description of a layer 1 signal to interference and noise ratio (L1-SINR) measurement.

If one resource setting is configured within the higher layer signaling CSI-ReportConfig for L1-SINR measurement, the resource setting (e.g., the higher layer signaling resourcesForChannelMeasurement) may be an NZP CSI-RS for channel and IM. In this case, it may be assumed that the UE uses an NZP CSI-RS having one port and a density value of 3 REs/RB for channel and IMs.

If two resource settings are configured within the higher layer signaling CSI-ReportConfig for the L1-SINR measurement, the first resource setting (e.g., the higher layer signaling resourcesForChannelMeasurement) may correspond to an SSB or an NZP CSI-RS for channel measurement. The second resource setting (e.g., the higher layer signaling csi-IM-ResourcesForInterference or nzp-CSI-RS-ResourcesForInterference) may correspond to a CSI-IM for IM or an NZP CSI-RS having one port and a density value of 3 REs/RB for IM. In this case, the SSB or NZP CSI-RS for channel measurement may be associated with one CSI-IM resource or one NZP CSI-RS for IM included in the same resource set. The number of SSBs or NZP CSI-RSs for channel measurement may be the same as the number of CSI-IMs or NZP CSI-RSs for IM.

In this case, when determining the reference RS for QCL-TypeD for the CSI-IM associated with SSB or NZP CSI-RS for channel measurement, or the NZP CSI-RS for IM, the UE may use the reference RS for QCL-TypeD of the SSB for channel measurement or the NZP CSI-RS for channel measurement.

The UE may expect that the higher layer signaling parameter “repetition” is configured for the NZP CSI-RS resource set for channel measurement and the NZP CSI-RS resource set for IM. In other words, both the NZP CSI-RS resource set for channel measurement and the NZP CSI-RS resource set for IM may be used for beam management purposes.

For L1-SINR measurement based on a specific IM resource, the UE may assume that the total power received from a specific NZP CSI-RS resource for IM or a specific CSI-IM resource for IM corresponds to interference and noise.

To calculate L1-SINR, the UE may be configured with an NZP CSI-RS resource and/or an SSB resource for channel measurement and may also be configured with an NZP CSI-RS or CSI-IM resource for IM. In this case, for channel measurement, the UE may be configured with up to 16 CSI resource sets, and up to 64 CSI-RS resources or 64 SSB resources across all the resource sets.

When one or two resource settings described above are configured for L1-SINR measurement, the following time restrictions for channel or IM may be considered:

In case that the higher layer signaling timeRestrictionForChannelMeasurements in CSI-ReportConfig is set to “notConfigured”, the UE may be required to derive a channel measurement for L1-SINR calculation to be reported in the n-th uplink slot, based on an SSB or NZP CSI-RS that can be received earlier in time than the CSI reference resource associated with the one or two resource settings described above.

In case that the higher layer signaling timeRestrictionForChannelMeasurements in CSI-ReportConfig is set to “configured”, the UE may be required to derive a channel measurement for L1-SINR calculation to be reported in the n-th uplink slot, based on the most recently received SSB or NZP CSI-RS among those received earlier in time than the CSI reference resource associated with the one or two resource settings described above.

In case that the higher layer signaling timeRestrictionForInterferenceMeasurements in CSI-ReportConfig is set to “notConfigured”, the UE may be required to derive the IM for L1-SINR calculation to be reported in the n-th uplink slot, based on the CSI-IM or NZP CSI-RS for IM that can be received earlier in time than the CSI reference resource associated with the one or two resource settings described above.

In case that the higher layer signaling timeRestrictionForInterferenceMeasurements in CSI-ReportConfig is set to “configured”, the UE may be required to derive the IM for L1-SINR calculation to be reported in the n-th uplink slot, based on the most recently received CSI-IM or NZP CSI-RS for IM among those received earlier in time than the CSI reference resource associated with the one or two resource settings described above.

When reporting L1-SINR, the UE may configure UCI using a specific quantization level according to conditions described below and report to the BS.

In case that the higher layer signaling nrofReportedRS in CSI-ReportConfig is configured as 1, the L1-SINR value may be quantized using a 7-bit representation with a step size of 0.5 dB for values in the range of [−23, 40] dB, and reported accordingly.

In case that the higher layer signaling nrofReportedRS in CSI-ReportConfig is configured as a value greater than 1, or if the higher layer signaling groupBasedBeamReporting is set to “enabled”, the UE may perform differential L1-SINR reporting. In this case, the maximum L1-SINR value may be quantized using a 7-bit representation with a step size of 0.5 dB for values in the range of [−23, 40] dB, and the differential L1-SINR value may be quantized using a 4-bit representation with a step size of 1 dB to represent the difference from the maximum L1-SINR value reported together with the corresponding differential L1-SINR. When the NZP CSI-RS is configured for channel measurement and/or IM, the reported L1-SINR value is expected not to be compensated by the same power offset as that of the higher layer signaling powerControlOffsetSS or powerControlOffset.

In case that the UE is configured with the higher layer signaling reportQuantity in CSI-ReportConfig set to “cri-SINR” or “ssb-Index-SINR”, the UE may consider the following operations related to group-based beam reporting.

In case that the UE is configured with the higher layer signaling groupBasedBeamReporting set to “disabled”, the UE may include nrofReportedRS number of different CRIs or SSBRIs, configured via higher layer signaling, in a single report and report them to the BS.

In case that the UE is configured with the higher layer signaling groupBasedBeamReporting set to “enabled”, the UE may include two different CRIs or SSBRIs in a single report and report them to the BS. In this case, the CSI-RS and/or SSB indicated by the CRI or SSBRI may be those received simultaneously by the UE.

In case that the UE is configured with the higher layer signaling reportQuantity set to “ssb-Index-SINR” in CSI-ReportConfig, the UE may be required to derive an L1-SINR, based on the SSBRI that has been reported to the BS, where SSBRIₖ (where k≥0) may correspond to the (k+1)-th entry in the csi-SSB-ResourceList of the CSI-SSB-ResourceSet for channel measurement, and may be associated with the (k+1)-th entry of the csi-IM-Resource in the csi-IM-ResourceSet or the (k+1)-th entry in the nzp-CSI-RS-Resources of the NZP-CSI-RS-ResourceSet for IM.

In case that the UE is configured with the higher layer signaling reportQuantity set to “cri-RSRP”, “cri-SINR”, or “none” in CSI-ReportConfig, and that the CSI-ReportConfig is associated with a resourceSetting for which the higher layer signaling resourceType is configured as “aperiodic”, the UE may not expect that more than 16 CSI-RS resources are configured in the CSI-RS resource set included in the corresponding resource setting.

The mathematical expression for the aforementioned priority rule may be considered as Pri_{iCSI}(y, k, c, s)=2·N_{cells}·Mₛ·y+N_{cells}·Mₛ·k+Mₛ·c+s, and in the case of CSI report that include L1-SINR reporting, k=0 may be considered.

Table 40 below shows the order of information placement for L1-SINR reporting. The bit lengths of the CRI and SSBRI may be defined by the number of bits that may represent the number of CSI-RS resources in the CSI-RS resource set

$$( e . g . , ⌈ {log}_{2} ( {K}_{s}^{CSI - RS} ) ⌉ )$$

or the number of bits that may represent the number of SSB resources in the SSB resource set

$$( e . g . , ⌈ {log}_{2} ( {K}_{s}^{SSB} ) ⌉ ) , where {κ}_{s}^{CSI - RS} and {κ}_{s}^{SSB}$$

may respectively denote the number of CSI-RS resources within the CSI-RS resource set and the number of SSB resources within the SSB resource set. As described above, the SINR and the differential SINR may be represented using 7 bits and 4 bits, respectively.

TABLE 40

| CSI report number | CSI fields |
|---|---|
| CSI report #n | CRI or SSBRI #1 |
| | CRI or SSBRI #1 |
| | CRI or SSBRI #1 |
| | CRI or SSBRI #1 |
| | SINR #1 |
| | Differential SINR #2 |
| | Differential SINR #3 |
| | Differential SINR #4 |

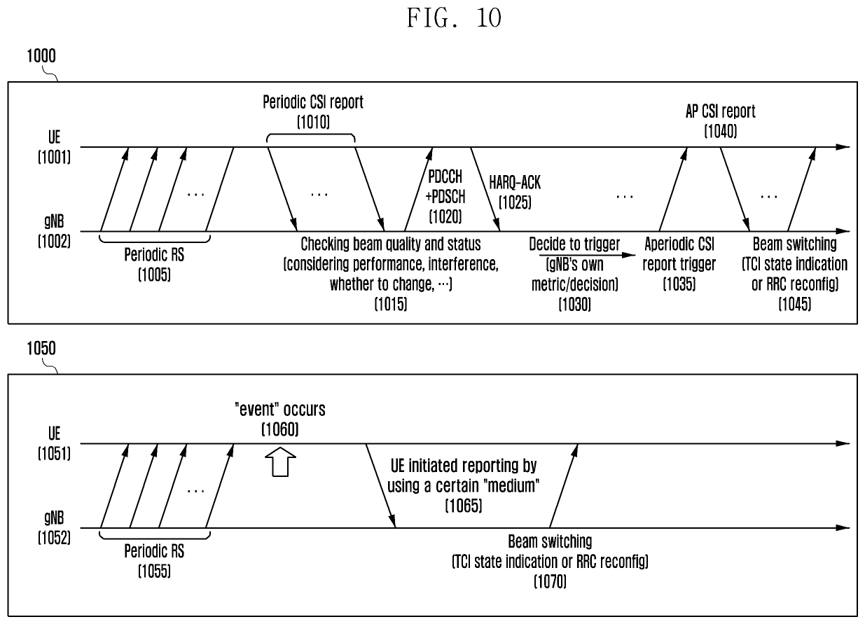

FIG. 10 illustrates a method for channel measurement and channel state reporting based on configuration and instructions from a BS, according to an embodiment.

Referring to FIG. 10, the method 1000 relates to ensuring and managing DL beam performance between a UE and a BS, based on periodic reference signal reception and periodic CSI reporting by the UE and/or aperiodic CSI report triggering by the BS and aperiodic CSI reporting method by the UE.

A BS 1002 may notify a UE 1001 of configuration information related to periodic reference signal reception and periodic CSI reporting corresponding thereto via higher layer signaling. Accordingly, the UE may receive periodic reference signals transmitted from the BS (1005), and may report periodic CSI corresponding thereto (1010). The corresponding periodic CSI may include performance of DL reception beams calculated by the UE. The BS may recognize the DL beam performance of the UE, based on the periodic reference signal reception and measurement and the periodic CSI reporting by the UE. The shorter the period of reference signal reception and measurement and CSI reporting, the more accurately the BS can identify the DL reception beam performance of the UE. However, this may result in significant signaling overhead for reference signal transmission/reception and CSI report transmission/reception between the UE and the BS.

If the period of reference signal reception and measurement and CSI reporting is long, the BS may be less accurate in identifying the reception beam performance of the UE. Therefore, the BS may trigger an aperiodic CSI reporting in the middle of such a long period to identify the reception beam performance of the UE (1035). Thereafter, the UE may perform aperiodic CSI reporting in response to the triggering of aperiodic CST reporting by the BS (1040), and the BS may, based on the collected information, notify the UE of beam switching if the DL reception beam performance of the UE is insufficient and switching to another beam is necessary (1045). Such beam switching may be performed by a method such as changing the TCI state indicated to the UE or RRC reconfiguration to change the configuration of the source RS within the TCI state.

For the BS to trigger aperiodic CSI reporting to the UE, the BS implementation may assume implicit information from the UE to make such a decision. The implicit information may pertain to a channel state, and representative implicit information may include a PDCCH transmitted by the BS to the UE and reception of the PDSCH scheduled thereby (1020), as well as the PUCCH transmission from the UE including HARQ-ACK information indicating whether the reception of the PDSCH is successful (1025). Based on information, such as the periodic CSI report that can be received from the UE (1010), and the PUCCH including HARQ-ACK information corresponding to the PDSCH scheduled to the UE (1025), the BS may determine whether the DL reception beam at the UE needs to be changed, or whether it is acceptable to maintain the current reception beam (1015). However, such information may be implicit, or even if the information is explicit, it may not always be available when the BS desires to obtain the information. Therefore, the amount of information available at the BS regarding the DL reception beam performance of the UE may be insufficient in absolute terms, or may be outdated.

The process 1050 of FIG. 10 relates to a method for securing and managing transmission/reception beam performance between the UE and the BS, based on the method for CSI reporting initiated by the UE in response to a specific event occurring at the UE.

To address the issues described above in process 1000, the BS may notify the UE of configuration information for CSI reporting initiated by the UE, based on at least one combination of higher layer signaling, MAC-CE signaling, and L1 signaling. Based on this, the UE may receive at least one combination of periodic reference signals, semi-persistent reference signals, and aperiodic reference signals (1055). When a specific event occurs at the UE (1060), the UE may perform the UE-initiated CSI reporting (1065). Thereafter, based on the information transferred from the UE, the BS may instruct the UE to perform beam switching (1070).

As such, the method for CSI reporting initiated by the UE differs from a scheme in which the BS triggers an aperiodic CSI report or instructs beam switching based on implicit information. Instead, in this method, the UE autonomously transmits information regarding its DL reception beam performance to the BS. Even when the BS does not trigger (a CSI report or beam switching), the BS may immediately identify a change in the UE's DL reception beam performance based on a predefined event at the UE and may take corresponding action (e.g., triggering an aperiodic CSI report or instructing beam switching). According to CSI reporting initiated by the UE, if a change in the DL reception beam is necessary, the BS may respond immediately, thereby reducing latency in beam management. Furthermore, unlike another method in which the periodicity of reference signal reception and periodic CSI reporting between the UE and the BS is shortened to allow the BS to quickly identify the DL reception beam performance of the UE even in the absence of UE-initiated CSI reporting, the method for CSI reporting initiated by the UE can significantly reduce the signaling overhead with respect to reference signals and CSI reporting.

For the CSI reporting method initiated by the UE as described above, the UE may define a specific event (1060) and notify the BS that the DL reception beam performance of the UE has changed when the defined event occurs. The UE may consider at least one of the following in defining the specific event for performing the CSI report initiated by the UE.

### Event 1

In case that there is a new reception beam having a performance metric that is greater than that of the current reception beam by a specific reference value or more, the UE may perform UE-initiated CSI reporting including information on the newly reception beam. In this case, in event 1, the new reception beam and the current reception beam may be defined as follows.

In event 1, the current reception beam may be defined by a reference signal configured as a QCL source within a TCI state indicated and applied to the UE, or may be defined by an SSB having a QCL relationship with the reference signal configured as the QCL source. The technical meaning of defining the current reception beam as a specific reference signal may be understood as that the UE determines parameters to be for a reception beam or reception filter corresponding to the current reception beam based on the received specific reference signal. Alternatively, the technical meaning of defining the current reception beam as a specific reference signal may be, when evaluating the performance of the current reception beam, the UE determines the performance of the current reception beam, based on the measured performance of a specific reference signal receivable by the UE. The specific method of determining the current reception beam may be a combination of one or more of the following methods.

In case that only one reference signal is configured as the QCL source, that is, when a QCL source for QCL-Type A, B, or C is configured in the TCI state instructed to the UE and the QCL source for QCL-Type D is not configured, the UE may determine the current reception beam by using the reference signal configured as the QCL source for QCL-TypeA, B, or C.

In case that multiple reference signals are configured as QCL sources, that is, when the QCL source for QCL-Type D as well as QCL-Type A, B, or C are configured in the instructed TCI state, the UE may determine the current reception beam by using the reference signal configured as the QCL source for QCL-Type D instead of the reference signal configured as the QCL source for QCL-Type A, B, or C. For example, when the TCI state instructed and applied to the UE includes a reference signal configured as the QCL source for QCL-Type A and a reference signal configured as the QCL source for QCL-Type D (i.e., when each of the two reference signals is configured as a QCL source for QCL-TypeA and QCL-TypeD), determining, by the UE, the performance of the reference signal configured as the QCL source for the instructed and applied TCI state may refer to determining the performance of the reference signal configured as the QCL source for QCL-Type D.

The UE may consider a CSI-RS as a reference signal that can be configured as the QCL source. In this case, the CSI-RS may be a tracking reference signal (TRS) configured with the higher layer signaling parameter “trs-Info”, a CSI-RS for beam management configured with the higher layer signaling parameter “repetition” set to on or off, or a CSI-RS for CSI for which neither the higher layer signaling parameter “trs-Info” nor “repetition” is configured. The UE may consider only TRS as a reference signal that can be configured as the QCL source, or only CSI-RS for beam management, or both TRS and CSI-RS for beam management.

The UE may be informed by the BS, via at least one or a combination of higher layer signaling, MAC-CE signaling, and L1 signaling, of whether to consider the reference signal configured as the QCL source of the TCI state instructed and applied by the BS as the current reception beam, or to consider the SSB having a QCL relationship with the reference signal configured as the QCL source as the current reception beam.

For example, the UE may be configured, via higher layer signaling, with whether to determine the current reception beam during the UE-initiated reception beam performance reporting, based on the reference signal configured as the QCL source of the instructed and applied TCI state or on the SSB having a QCL relationship with the reference signal. In this case, the UE may maintain the definition of the current reception beam according to the configured higher layer signaling, regardless of which TCI state is instructed.

In another example, the UE may be configured with higher layer signaling for each TCI state. The UE may determine, depending on which TCI state is instructed and applied by the BS, whether to regard the reference signal of the QCL source within the corresponding TCI state as the current reception beam, or to regard the SSB having a QCL relationship with the QCL source reference signal within the TCI state as the current reception beam, based on the higher layer signaling configuration within the TCI state. For example, when the UE is instructed to apply a specific TCI state, and the higher layer signaling within the corresponding TCI state is configured to indicate that the QCL source reference signal within the TCI state should be regarded as the current reception beam, the UE may regard the QCL source reference signal in the instructed and applied TCI state as the current reception beam. As another example, when the UE is instructed to apply a specific TCI state, and the higher layer signaling within the corresponding TCI state is configured to indicate that the SSB having a QCL relationship with the QCL source reference signal within the TCI state should be regarded as the current reception beam, the UE may regard the SSB having a QCL relationship with the QCL source reference signal in the instructed and applied TCI state as the current reception beam.

In event 1, the UE may be configured with a new reception beam via higher layer signaling. In this case, the UE may receive configuration of different new reception beams (or reference signals corresponding to new reception beams) depending on the current reception beam, or may receive configuration of new reception beams (or reference signals corresponding to new reception beams) irrespective of what the current reception beam is determined to be. In addition, the UE may receive, via MAC-CE, an activation indication from the BS for performing measurements on all or a subset of the configured new reception beams. The UE may consider a CSI-RS or an SSB as the new reception beam. The technical meaning of defining the new reception beam as a specific reference signal may be understood as that the UE determines parameters to be used as a reception beam or reception filter corresponding to the new reception beam based on the received specific reference signal. The specific method of determining the current reception beam may be a combination of one or more of the following methods. Alternatively, the technical meaning of defining the current reception beam as a specific reference signal may be that the UE determines the performance of the new reception beam by measuring the performance of a specific reference signal that can be received by the UE and based on the measured performance of the specific reference signal.

When the UE is configured with new reception beam via higher layer signaling, it may be expected that information on the new reception beam is configured within each TCI state (either in each TCI state configuration information or each TCI state). The UE may be configured with reference signals having similar reception beam directions to the reference signal configured as the QCL source within each TCI state as the new reception beams. In this case, the higher layer signaling for the new reception beam may be configured based on the index of each reference signal or may be configured based on a TCI state of another index in which the reference signal corresponding to the new reception beam is configured as a QCL source.

As described above, depending on whether the UE regards the current reception beam as the reference signal configured as the QCL source within the TCI state or as the SSB having a QCL relationship with the reference signal, based on notification from the BS, the UE may expect that the types of the current reception beam and the new reception beam remain the same.

For example, when the UE regards the current reception beam as a CSI-RS according to the methods described above from the BS, the UE may also consider a CSI-RS as the new reception beam for performance comparison with the current reception beam. In this case, the current reception beam and new reception beam may be identical in that they are both CSI-RSs, regardless of whether the CSI-RS corresponds to a TRS, a CSI-RS for beam management, or a CSI-RS for CSI. For instance, the UE may regard the current reception beam as a TRS configured as the QCL source within the currently indicated TCI state and may consider a CSI-RS for beam management as the new reception beam. In another example, the UE may regard the current reception beam as a CSI-RS for beam management configured as the QCL source within the currently indicated TCI state and may consider the TRS as the new reception beam. In another example, when the UE regards the current reception beam as a specific type of CSI-RS (e.g., one of TRS, CSI-RS for beam management, or CSI-RS for CSI) according to the methods described above from the BS, the UE may consider the same type of CSI-RS as the new reception beam for performance comparison with the current reception beam. For instance, the UE may consider the current reception beam as a TRS configured as a QCL source in the currently indicated TCI state, and consider another TRS of the same type as the new reception beam.

If the current reception beam is an SSB, the UE may consider an SSB as the new reception beam.

In event 1, a specific reference value used to compare the performance of the new reception beam with that of the current reception beam may be reported by the UE to the BS via a UE capability, configured by the BS via higher layer signaling, or statically defined in the specification.

In event 1, the UE may introduce a specific time interval and a counter to determine whether the performance of a new reception beam is greater than that of the current reception beam by a specific reference value or more. The UE may determine whether event 1 has occurred within the time interval that starts from a time point at which information on the current reception beam becomes available. The time point at which information on the current reception beam becomes available may be when the currently indicated TCI state is applied, or a time point at which the reference signal (e.g., CSI-RS or SSB as described above) corresponding to the current reception beam is received after time point at which the currently indicated TCI state is applied. The length of the time interval may be the periodicity of the reference signal corresponding to the current reception beam, or a real-number value that is greater than or less than the periodicity in terms of a frame, subframe, slot, symbol, or absolute time (e.g., msec), and may be configured by the BS to the UE via higher layer signaling. The UE may reset the time interval each time it receives the reference signal corresponding to the current reception beam, or at the time point at which the time interval ends.

Within the time interval, the UE may receive reference signals (i.e., CSI-RS or SSB as described above) corresponding to one or more new reception beams, and when event 1 occurs a specific number of times or more for a specific new reception beam, the UE may perform reception beam performance reporting, initiated by the UE, to the BS. Additionally, from the start point of the time interval, the UE may store, in the above-mentioned counter, the number of consecutive occurrences of event 1 within the time interval. Furthermore, when it is identified that the counter value exceeds a specific number, the UE may perform reception beam performance reporting, initiated by the UE, to the BS. The number of consecutive occurrences of event 1 may refer to when the performance of a specific new reception beam is determined to be greater than that of the current reception beam by at least a specific reference value. For example, when the performance of each of two different new reception beams is greater than that of the current reception beam by at least a specific reference value, it may be considered that event 1 has occurred once for each new reception beam. Within the time interval, the UE may identify whether event 1 occurs during every period of the current reception beam. When event 1 continuously occurs but not enough to reach a specific number of times, and event 1 does not occur in a specific period of the current reception beam, such that the count of consecutive occurrences no longer exceeds the specific number of times, the UE may reset the end time point of the specific period as a new start point of the time interval.

Based on the method described above, the UE may identify the number of consecutive occurrences of event 1 within a specific time interval and perform the reception beam performance reporting, initiated by the UE, to the BS. In this case, the specific number of occurrences may be one by default, and the UE may be configured by the BS with a specific natural number X greater than 1. The UE may report its individual capability regarding whether it considers the specific number of times as one, or as a specific natural number X greater than one, and notify the BS of whether it supports such a reporting approach.

In event 1, when performing the UE-initiated reception beam performance reporting, the UE may include at least one of the following pieces of information in the report to the BS.

The UE may include the index and/or the performance of the current reception beam in the report to the BS. The index of the current reception beam may be the index of the CSI-RS resource when the current reception beam is a CSI-RS, or the index of the SSB when the current reception beam is an SSB, as described above. The UE may be configured via higher layer signaling from the BS whether to report to the BS by including the index and/or the performance of the current reception beam in the report. In other words, if such configuration is provided by the BS via higher layer signaling, the UE may perform the UE-initiated reception beam performance reporting by including the index and/or the performance of the current reception beam in the report. When no such a configuration is provided via higher layer signaling from the BS, the UE may perform the UE-initiated reception beam performance reporting without including the index and/or the performance of the current reception beam.

In case that the UE includes the current reception beam performance (e.g., in the case of L1-RSRP) in the report to the BS, the UE may report the L1-RSRP performance of the current reception beam by quantizing a 1 dB-unit value within a range from-140 dBm to-44 dBm by using a total of 7 bits. This reporting method is merely an example, and the disclosure is not limited thereto.

The UE may include the index and/or the performance of new reception beams in the report to the BS. The UE may be configured, via higher layer signaling from the BS, with information regarding the number of new reception beams for which the performance is to be included and reported. For example, the UE may be configured by the BS with the number of new reception beams to be reported. In this case, the number of new reception beams to be reported may be a natural number N greater than or equal to 1. More specifically, the value of N may be 1, 2, 3, or 4, or a natural number less than or equal to 64. In this case, the number of new reception beams to be reported by the UE may follow higher layer signaling.

When the UE reports the performance of the N new reception beams, it may be assumed that all N new reception beams satisfy event 1. In other words, it may be assumed that the performance of each of the N new reception beams is greater than that of the current reception beam by a specific reference value or more.

In this case, when the UE reports the performance of the N new reception beams to the BS (e.g., L1-RSRP), regardless of whether higher layer signaling indicating inclusion of the current reception beam performance in the same report is configured (i.e., both for the case in which the performance of the current receive beam is included and not included), the UE may report the L1-RSRP of each of the new reception beams by quantizing a 1 dB-unit value within a range from-140 dBm to-44 dBm by using a total of 7 bits. This reporting method is merely an example, and the disclosure is not limited thereto.

As another method, when the UE reports the performance of the N new reception beams to the BS (e.g., in the case of L1-RSRP), regardless of whether higher layer signaling indicating inclusion of the current reception beam performance in the same report is configured (i.e., both for the case in which the performance of the current receive beam is included and not included), the UE may report the L1-RSRP of the new reception beam having the largest L1-RSRP value among the one or more new reception beams by quantizing a 1 dB-unit value within a range from −140 dBm to −44 dBm by using a total of 7 bits, and may represent the performance of the remaining (N−1) new reception beams by using a difference value from the performance of the new reception beam having the largest L1-RSRP value. The difference value may be represented using X bits and in units of Y dB, where X may be a natural number less than 7 (e.g., one of 1, 2, 3, 4, 5, or 6), and Y may be a positive real number (e.g., one of 0, 0.5, 1, 1.5, 2, 2.5, 3, . . . ). For example, the difference value may be represented using X=4 bits and in units of Y=2 dB. This reporting method is merely an example, and the disclosure is not limited thereto.

As another method, when the UE reports the performance of the N new reception beams to the BS (e.g., in the case of L1-RSRP), if higher layer signaling indicating inclusion of the current reception beam performance in the same report is configured (i.e., when the current reception beam performance is included), the UE may represent the L1-RSRP performance of the new reception beams as a difference value from a value that is greater than the performance of the current reception beam by a specific reference value. In this case, the difference value may be represented using X bits and in units of Y dB, where X may be a natural number less than 7 (e.g., one of 1, 2, 3, 4, 5, or 6), and Y may be a real number greater than or equal to 1 (e.g., one of 1, 1.5, 2, 2.5, 3, . . . ). For example, the difference value may be represented using X=4 bits and in units of Y=2 dB. This reporting method is merely an example, and the disclosure is not limited thereto. Since the performance of the new reception beams reported by the UE all satisfy event 1, the values may be greater than or equal to the value that is greater than the performance of the current reception beam by the specific reference value.

As another method, when the UE reports the performance of the N new reception beams to the BS (e.g., in the case of L1-RSRP), if higher layer signaling indicating inclusion of the current reception beam performance in the same report is configured (i.e., when the current reception beam performance is included), the UE may represent the L1-RSRP performance of the new reception beams as a difference value from a value that is greater than the performance of the current reception beam by a specific reference value. In this case, the difference value may be represented using X bits and in units of Y dB, where X may be a natural number less than 7 (e.g., one of 1, 2, 3, 4, 5, or 6), and Y may be a real number greater than or equal to 1 (e.g., one of 1, 1.5, 2, 2.5, 3, . . . ). For example, the difference value may be represented using X=4 bits and Y=2 dB units. This reporting method is merely an example, and the disclosure is not limited thereto. If the higher layer signaling indicating whether to include the performance of the current reception beam in the same report is not configured (i.e., when the performance of the current reception beam is not included in the report), the UE may report the L1-RSRP performance of the new reception beam having the largest L1-RSRP value among one or more new reception beams by quantizing a 1 dB-unit value within a range from −140 dBm to −44 dBm by using 7 bits.

The performance of the remaining (N−1) new reception beams may be represented as a difference value from a value relating to the performance of the new reception beam having the largest L1-RSRP value. In this case, the difference value may be represented using X bits and in units of Y dB, where X may be a natural number smaller than 7 (e.g., one of 1, 2, 3, 4, 5, or 6), and Y may be a positive real number (e.g., one of 0, 0.5, 1, 1.5, 2, 2.5, 3, . . . ). For example, the difference value may be represented using X=4 bits and in units of Y=2 dB. This reporting method is merely an example and the disclosure is not limited thereto. Accordingly, the UE may maintain the same bit length for the UE-initiated reception beam performance report when the higher layer signaling indicating the inclusion of the performance of the current reception beam in the same report is configured or not. Accordingly, in the two aforementioned cases (i.e., whether the higher layer signaling indicating the inclusion of the current reception beam performance in the same report is configured or not), if the bit length in one case is shorter than that in the other case, the UE may include a specific number of zero bits so that the both cases have the same bit length, thereby allowing the bit length of the UE-initiated reception beam performance report to remain the same.

When reporting the N new reception beams, the UE may expect that at least one of the N new reception beams satisfies event 1. That is, the UE may assume that the performance of some of the N new reception beams is greater than that of the current reception beam by at least a reference value, while the performance of the remaining new reception beams may not exceed the performance of the current reception beam by the reference value.

In this case, when the UE reports the performance of the N new reception beams (e.g., in the case of L1-RSRP), regardless of whether higher layer signaling indicating inclusion of the current reception beam performance in the same report is configured (i.e., both for the case in which the performance of the current receive beam is included and not included), the UE may report the L1-RSRP of each new reception beam by quantizing a 1 dB-unit value within a range from-140 dBm to-44 dBm by using a total of 7 bits. Regarding this method, if the UE is configured via higher layer signaling to report the performance of the current reception beam, the UE may not include the number of new reception beams that satisfy event 1 in the UE-initiated reception beam performance report. Even if the UE does not report the number of new reception beams that satisfy event 1, the BS may identify whether the performance of the new reception beams reported by the UE satisfies event 1 based on the performance value of the current reception beam reported by the UE and the specific reference value configured for the UE. Regarding this method, if the UE is not configured via higher layer signaling to report the performance of the current reception beam, the UE may include the number of new reception beams satisfying event 1 in the report to the BS. Since the UE does not report the performance of the current reception beam, if the UE does not report the number of new reception beams that satisfy event 1, the BS is unable to identify which of the new reception beams satisfy event 1. For example, when N=4, i.e., if 2 out of 4 new reception beams satisfy event 1, the UE may report the performance of the 4 new reception beams, and additionally indicate that the number of reception beams satisfying event 1 is 2 by using ceil (log₂(N)) bits (e.g., 2 bits when N=4). Here, ceil(.) denotes a ceiling function, and log₂(.) denotes a base-2 logarithm function. The UE may report the 4 new reception beams in descending order of performance, and the BS may identify that the new reception beams having the two highest performance values among the four new reception beams satisfy event 1, and the remaining two new reception beams do not satisfy event 1.

In another method, when the UE reports the performance of the N new reception beams to the BS (e.g., in the case of L1-RSRP), regardless of whether higher layer signaling indicating inclusion of the current reception beam performance in the same report is configured (i.e., both for the case in which the performance of the current receive beam is included and not included), the UE may report the L1-RSRP of the new reception beam having the largest L1-RSRP value among the one or more new reception beams by quantizing a 1 dB-unit value within a range from-140 dBm to-44 dBm by using a total of 7 bits, and may represent the performance of the remaining (N−1) new reception beams by using a difference value from the performance of the new reception beam having the largest L1-RSRP value. The difference value may be represented using X bits and in units of Y dB, where X may be a natural number less than 7 (e.g., one of 1, 2, 3, 4, 5, or 6), and Y may be a positive real number (e.g., one of 0, 0.5, 1, 1.5, 2, 2.5, 3, . . . ). For example, the difference value may be represented using X=4 bits and in units of Y=2 dB.

In this method, if the UE is configured via higher layer signaling to report the performance of the current reception beam, the UE may not include the number of new reception beams that satisfy event 1 in the UE-initiated reception beam performance report. Even if the UE does not report the number of new reception beams that satisfy event 1, the BS may identify whether the performance of the new reception beams reported by the UE satisfies event 1 based on the performance value of the current reception beam reported by the UE and the specific reference value configured for the UE. If the UE is not configured via higher layer signaling to report the performance of the current reception beam, the UE may include the number of new reception beams satisfying event 1 in the report to the BS. Since the UE does not report the performance of the current reception beam, if the UE does not report the number of new reception beams that satisfy event 1, the BS is unable to identify which of the new reception beams satisfy event 1. For example, when N=4, i.e., if 2 out of 4 new reception beams satisfy event 1, the UE may report the performance of the 4 new reception beams, and additionally indicate that the number of reception beams satisfying event 1 is 2 by using ceil (log₂(N)) bits (e.g., 2 bits when N=4). Here, ceil(.) denotes a ceiling function, and log₂(.) denotes a base-2 logarithm function. The UE may report the 4 new reception beams in descending order of performance, and the BS may identify that the new reception beams having the two highest performance values among the four new reception beams satisfy event 1, and the remaining two new reception beams do not satisfy event 1.

In another example, when the UE reports the performance of the N new reception beams to the BS (e.g., in the case of L1-RSRP), and when the higher layer signaling indicating whether the performance of the current reception beam is to be included in the same report is configured (i.e., in the case where the performance of the current reception beam is included), the UE may represent the L1-RSRP performance of each new reception beam as a difference value from a value that is greater than the performance of the current reception beam by a specific reference value. In this case, the difference value may be represented using X bits and in units of Y dB, where X may be a positive integer less than 7 (e.g., one of 1, 2, 3, 4, 5, or 6), and Y may be a real number greater than or equal to 1 (e.g., one of 1, 1.5, 2, 2.5, 3, . . . ). For example, the difference value may be represented using X=4 bits and in units of Y=2 dB. In this case, the UE may include in the report the number of new reception beams that satisfy event 1. Since the performance of each new reception beam is represented as a difference value from a value that is greater than the performance of the current reception beam by a specific reference value, when a specific new reception beam fails to satisfy event 1, it may indicate that its performance is less than a value that is greater than the performance of the current reception beam by a specific reference value. Accordingly, when the UE represents the performance of a new reception beams as a difference value from a value that is greater than the performance of the current reception beam by a specific reference value, the performance values of the number of new reception beams satisfying event 1 additionally reported by the UE may be assumed as a positive difference value from the value that is greater than the performance of the current reception beam by a specific reference value. In contrast, the performance values of the number of new reception beams that do not satisfy event 1 among all the new reception beams may be assumed as a negative difference value from the value that is greater than the performance of the current reception beam by a specific reference value. Sign information whether the difference value is positive or negative is not included in the UE-initiated reception beam performance report. Accordingly, the performance values of the new reception beams that satisfy event 1 may be placed first in the report, followed by the performance values of the new reception beams that do not satisfy event 1, and the BS may identify the performance of the new reception beams by applying a positive or negative difference value accordingly.

In another method, when the UE reports the performance of the N new reception beams to the BS (e.g., in the case of L1-RSRP), the UE may include the number of new reception beams that satisfy event 1 in the report. For example, when N=4, i.e., if 2 out of 4 new reception beams satisfy event 1, the UE may report the performance of the 4 new reception beams and, in addition, indicate that 2 beams satisfy event 1 using ceil (log₂(N)) bits (e.g., 2 bits for N=4), where ceil(.) denotes a ceiling function and log₂(.) denotes a base-2 logarithm function. In case that higher layer signaling indicating whether the performance of the current reception beam is to be included in the same report is configured (i.e., the performance of the current reception beam is included), if there are N new reception beams satisfying event 1 (i.e., all N new reception beams satisfy event 1), the UE may represent the L1-RSRP performance of the new reception beams as a difference value from a value that is greater than the performance of the current reception beam by a specific reference value. In this case, the difference value may be represented using X bits and in units of Y dB, where X may be a positive integer less than 7 (e.g., one of 1, 2, 3, 4, 5, or 6), and Y may be a real number greater than 0 (e.g., one of 0, 0.5, 1, 1.5, 2, 2.5, 3, . . . ). For example, the difference value may be represented using X=4 bits and in units of Y=2 dB.

In case that higher layer signaling indicating whether the performance of the current reception beam is to be included in the same report is configured (i.e., the performance of the current reception beam is included), if fewer than N new reception beams satisfy event 1 (i.e., at least one new reception beam fails to satisfy event 1), the UE may report the L1-RSRP performance of the new reception beam having the largest L1-RSRP among the one or more new reception beams by quantizing a 1 dB-unit value within a range from-140 dBm to-44 dBm by using a total of 7 bits. The performance values of the remaining (N−1) new reception beams may be represented by using a difference value from the performance of the beam having the largest L1-RSRP. In this case, the difference value may be represented using X bits and in units of Y dB, where X may be a positive integer less than 7 (e.g., one of 1, 2, 3, 4, 5, or 6), and Y may be a real number greater than 0 (e.g., one of 0, 0.5, 1, 1.5, 2, 2.5, 3, . . . ). For example, the difference value may be represented using X=4 bits and in units of Y=2 dB.

Accordingly, the UE may determine whether to represent the performance of all new reception beams as a difference value from a value that is greater than the performance of the current reception beam by a specific reference value, or to represent the performance of one new reception beam having the highest reception performance and the performances of the remaining new reception beams as difference values therefrom, depending on whether all of the new reception beams satisfy event 1.

### Event 2

In case that the performance of the current reception beam is at or below a specific reference value, the UE may perform CSI reporting initiated by the UE, including the corresponding reception beam information.

In event 2, the UE may determine the current reception beam in a similar manner to the event 1. That is, the UE may use a reference signal configured as a QCL source in the TCI state currently indicated and applied as the current reception beam, or may use an SSB that is in a QCL relationship with the corresponding reference signal.

In another method, the UE may regard the current reception beam as a reference signal configured by higher layer signaling in event 2.

In event 2, the specific reference value used when identifying the performance of the current reception beam may be a value that the UE reports to the BS via a UE capability, configured by the BS via higher layer signaling, or statically defined in the specification.

In event 2, the UE may introduce a specific time interval and a counter to determine whether the performance of the current reception beam is at or below a specific reference value. The UE may determine whether event 2 occurs within a time interval time that starts from a time point at which information on the current reception beam becomes available. The time point at which information on the current reception beam becomes available may be a time point when the currently indicated TCI state is applied, or a time point at which the reference signal (e.g., CSI-RS or SSB as described above) corresponding to the current reception beam is received after time point at which the currently indicated TCI state is applied. The length of the time interval may be the periodicity of the reference signal corresponding to the current reception beam, or a real-number value that is greater than or less than the periodicity in terms of a frame, subframe, slot, symbol, or absolute time (e.g., msec), and may be configured by the BS to the UE via higher layer signaling.

The UE may identify that event 2 occurs during the time interval from the start point of the time interval. The UE may store, in a counter, the number of occurrences of event 2 within the time interval from the start point thereof, and when it is identified that the counter value exceeds a specific number, the UE may perform UE-initiated reception beam performance reporting to the BS. In addition, the UE may store, in the above-mentioned counter, the number of consecutive occurrences of event 2 within the time interval from the start point thereof, and when it is identified that the counter value exceeds a specific number, the UE may perform UE-initiated reception beam performance reporting to the BS.

Within the time interval, the UE may identify whether event 2 occurs during every period of the current reception beam. When event 2 continuously occurs but not enough to reach a specific number of times, and event 2 does not occur in a specific period of the current reception beam, such that the count of consecutive occurrences of event 2 no longer exceeds the specific number of times, the UE may reset the end time point of the specific period as a new start point of the time interval. Based on the method described above, the UE may identify the number of consecutive occurrences of event 2 within a specific time interval and perform the reception beam performance reporting, initiated by the UE, to the BS. In this case, the specific number of occurrences may be one by default, and the UE may be configured by the BS with a specific natural number X greater than 1. The UE may report its individual capability regarding whether it considers the specific number of times as one, or as a specific natural number X greater than one, and notify the BS of whether it supports such a reporting approach.

In event 2, when performing the UE-initiated reception beam performance reporting, the UE may include at least one of the following pieces of information in the report to the BS.

In case that the UE reports the current reception beam performance (e.g., in the case of L1-RSRP) to the BS, the UE may report the L1-RSRP performance of the current reception beam by quantizing a 1 dB-unit value within a range from −140 dBm to −44 dBm by using a total of 7 bits. This reporting method is merely an example, and the disclosure is not limited thereto.

In case that the UE reports the performance of a current reception beam to a BS (for example, in the case of L1-RSRP), the UE may express the L1-RSRP performance of the current reception beam as a difference value from the specific reference value. The difference value may be represented using X bits and in units of Y dB, and X may be a natural number less than 7 (one of 1, 2, 3, 4, 5, or 6), and Y may be a real number greater than 0 (one of 0, 0.5, 1, 1.5, 2, 2.5, 3, . . . ). For example, the difference value may be represented using X=4 bits and in units of Y=2 dB.

### Event 3

If the performance of at least one new reception beam is greater than the performance of the current reception beam by a specific reference value or more, the UE may perform CSI reporting initiated by the UE, including the new reception beam information. In event 3, the new reception beam and the current reception beam may be defined as follows.

In event 3, the UE may determine the current reception beam through a method similar to the event 1. That is, the UE may use a reference signal configured as a QCL source in the TCI state currently indicated and applied as the current reception beam, or may use an SSB in a QCL relationship with the reference signal.

In another method, in the event 3, the current reception beam may be defined as a reception beam when receiving a reference signal having the lowest reception performance value among the reference signals configured as a QCL source in one or more TCI states activated for the UE. For example, when a reference signal configured as a QCL source in a second TCI state among the eight activated TCI states for the UE has the lowest performance (for example, L1-RSRP or L1-SINR), the UE may define a reception beam used when receiving the reference signal configured as a QCL source in the second TCI state among the activated TCI states as the current reception beam. If a QCL source for QCL-TypeD is configured in a specific TCI state among one or more activated TCI states in addition to QCL-TypeA, B, or C, the UE may use the reference signal configured as a QCL source for QCL-TypeD instead of the reference signal configured as a QCL source for QCL-TypeA, B, or C when the UE identifies the reception performance of the reference signal configured as the QCL source. For example, when the second TCI state has a reference signal configured as a QCL source for QCL-TypeA and QCL-TypeD, respectively (i.e., when each of the two reference signals is configured as a QCL source for QCL-TypeA and QCL-TypeD), the UE identifying the performance of the reference signal configured as a QCL source for the second TCI state indicates identifying the performance of the reference signal configured as a QCL source for QCL-TypeD.

In another method, the UE may, in event 3, define the current reception beam as the SSB with the lowest reception performance value among one or more SSBs that have a QCL relationship with the reference signal configured as a QCL source in one or more TCI states activated for the UE.

In event 3, the UE may be configured with a new reception beam via higher layer signaling. The UE may be configured with a different new reception beam depending on the current reception beam, or may be configured with a new reception beam regardless of a determined current reception beam. In addition, the UE may receive an activation instruction from the BS to perform measurements for some or all of the new reception beams configured for the UE via MAC-CE.

When the UE is configured with new reception beam via higher layer signaling, it may be expected that information on the new reception beam is configured within each TCI state (either in each TCI state configuration information or each TCI state). The UE may be configured with reference signals having similar reception beam directions to the reference signal configured as the QCL source within each TCI state as the new reception beams. In this case, the higher layer signaling for the new reception beam may be configured based on the index of each reference signal, or may be configured based on a TCI state of another index in which the reference signal corresponding to the new reception beam is configured as a QCL source.

Depending on whether the UE regards the current reception beam as a reference signal configured as a QCL source within the TCI state or as an SSB having a QCL relationship with the reference signal through the notification from the BS as described above, the UE may expect that the types of the current reception beam and the new reception beam are maintained the same.

For example, when the UE regards the current reception beam as a CSI-RS according to the methods described above from the BS, the UE may consider the CSI-RS as a new reception beam for performing a performance comparison with the current reception beam. The current reception beam and the new reception beam are the same only in that they are CSI-RS, and it does not matter whether the CSI-RS is a TRS, a CSI-RS for beam management, or a CSI-RS for CSI. For example, the UE may regard the current reception beam as a TRS configured as a QCL source within the currently indicated TCI state, and may consider the CSI-RS for beam management as the new reception beam. As another example, the UE may regard the current reception beam as a CSI-RS for beam management configured as a QCL source within the currently indicated TCI state, and may consider TRS as a new reception beam.

As another example, when the UE considers the current reception beam as a specific type of CSI-RS (for example, one of TRS, CSI-RS for beam management, and CSI-RS for CSI) according to the above-described methods from the BS, the UE may consider the same type of CSI-RS as a new reception beam to perform a performance comparison with the current reception beam. For example, the UE may consider the current reception beam as a TRS configured as a QCL source within the currently indicated TCI state, and may consider the same type of TRS as a new reception beam.

In event 3, a specific reference value used to compare the performance of the new reception beam with that of the current reception beam may be reported by the UE to the BS via a UE capability, configured by the BS via higher layer signaling, or statically defined in the specification.

In event 3, the UE may introduce a specific time interval and a counter to determine whether the performance of a new reception beam is greater than that of the current reception beam by a specific reference value or more. The UE may determine whether event 3 has occurred within the time interval that starts from a time point at which information on the current reception beam becomes available. The time point at which information on the current reception beam becomes available may be a time point when the currently indicated TCI state is applied, or a time point at which the reference signal (e.g., CSI-RS or SSB as described above) corresponding to the current reception beam is received after time point at which the currently indicated TCI state is applied. The length of the time interval may be the periodicity of the reference signal corresponding to the current reception beam, or a real-number value that is greater than or less than the periodicity in terms of a frame, subframe, slot, symbol, or absolute time (e.g., msec), and may be configured by the BS to the UE via higher layer signaling. The UE may reset the time interval each time it receives the reference signal corresponding to the current reception beam, or at the time point at which the time interval ends.

Within the time interval, the UE may receive reference signals (i.e., CSI-RS or SSB as described above) corresponding to one or more new reception beams, and when event 3 occurs a specific number of times or more for a specific new reception beam, the UE may perform reception beam performance reporting, initiated by the UE, to the BS. Additionally, from the start point of the time interval, the UE may store, in the above-mentioned counter, the number of consecutive occurrences of event 3 within the time interval. When it is identified that the counter value exceeds a specific number, the UE may perform reception beam performance reporting, initiated by the UE, to the BS. The number of consecutive occurrences of event 3 may refer to when the performance of a specific new reception beam is determined to be greater than that of the current reception beam by at least a specific reference value. For example, when the performance of each of two different new reception beams is greater than that of the current reception beam by at least a specific reference value, it may be considered that event 3 has occurred once for each new reception beam. Within the time interval, the UE may identify whether event 3 occurs during every period of the current reception beam. When event 3 continuously occurs but not enough to reach a specific number of times, and event 3 does not occur in a specific period of the current reception beam, such that the count of consecutive occurrences no longer exceeds the specific number of times, the UE may reset the end time point of the specific period as a new start point of the time interval.

Based on the method described above, the UE may identify the number of consecutive occurrences of event 3 within a specific time interval and perform the reception beam performance reporting, initiated by the UE, to the BS. In this case, the specific number of occurrences may be one by default, and the UE may be configured by the BS with a specific natural number X greater than 1. The UE may report its individual capability regarding whether it considers the specific number of times as one, or as a specific natural number X greater than one, and notify the BS of whether it supports such a reporting approach.

In event 3, when performing the UE-initiated reception beam performance reporting, the UE may include at least one of the following pieces of information in the report to the BS.

The UE may include the index and/or the performance of the current reception beam in the report to the BS. The index of the current reception beam may be the index of the CSI-RS resource when the current reception beam is a CSI-RS, or the index of the SSB when the current reception beam is an SSB, as described above. When the UE reports the index of the current reception beam and/or the performance of the current reception beam as the UE-initiated reception beam performance report corresponding to event 3, the reception beam performance report may be performed without configuration of a specific higher layer signaling from the BS.

The UE may receive a configuration from the BS via higher layer signaling whether to perform the UE-initiated reception beam performance reporting including the index of the current reception beam and/or the performance of the current reception beam. That is, when the UE receives the higher layer signaling from the BS, the UE may perform the UE-initiated reception beam performance reporting by including the index of the current reception beam and/or the performance of the current reception beam in the report. In case that the UE does not receive the higher layer signaling from the BS, the UE may perform the UE-initiated reception beam performance reporting without including the index of the current reception beam and/or the performance of the current reception beam.

When reporting the performance of a new reception beam, the UE may similarly use the method of event 1.

### Event 4

In case that the performance of at least one new reception beam is greater than the performance of the current reception beam by a specific reference value or more, the UE may perform the UE-initiated CSI reporting by including the corresponding new reception beam information. In the corresponding event 4, the new reception beam and the current reception beam may be defined as follows. In event 3, the current reception beam is defined by the reference signal with the lowest reception performance value. In contrast, in event 4, the current reception beam is defined by the reference signal with the highest reception performance value.

In event 4, the UE may determine the current reception beam through a method similar to the event 1. That is, the UE may use a reference signal configured as a QCL source in the TCI state currently indicated and applied as the current reception beam, or may use an SSB in a QCL relationship with the reference signal.

In another method, in the event 4, the current reception beam may be defined by a reception beam when receiving a reference signal having the highest reception performance value among the reference signals configured as a QCL source in one or more TCI states activated for the UE. For example, when a reference signal configured as a QCL source in a second TCI state among the eight activated TCI states for the UE has the highest performance (for example, L1-RSRP or L1-SINR), the UE may define a reception beam used when receiving the reference signal configured as a QCL source in the second TCI state among the activated TCI states as the current reception beam. If a QCL source for QCL-TypeD is configured in a specific TCI state among one or more activated TCI states in addition to QCL-TypeA, B, or C, the UE may use the reference signal configured as a QCL source for QCL-TypeD instead of the reference signal configured as a QCL source for QCL-TypeA, B, or C when the UE identifies the reception performance of the reference signal configured as the QCL source. For example, when the second TCI state has a reference signal configured as a QCL source for QCL-TypeA and QCL-TypeD, respectively (i.e., when each of the two reference signals is configured as a QCL source for QCL-TypeA and QCL-TypeD), the UE identifying the performance of the reference signal configured as a QCL source for the second TCI state indicates identifying the performance of the reference signal configured as a QCL source for QCL-TypeD.

In another method, the UE may, in event 4, define the current reception beam as the SSB with the highest reception performance value among one or more SSBs that have a QCL relationship with the reference signal configured as a QCL source in one or more TCI states activated for the UE.

In event 4, the UE may be configured with a new reception beam via higher layer signaling. The UE may be configured with a different new reception beam depending on the current reception beam or may be configured with a new reception beam regardless of a determined current reception beam. In addition, the UE may receive an activation instruction from the BS to perform measurements for some or all of the new reception beams configured for the UE via MAC-CE.

When the UE is configured with a new reception beam via higher layer signaling, it may be expected that information on the new reception beam is configured within each TCI state (either in each TCI state configuration information or each TCI state). The UE may be configured with reference signals having similar reception beam directions to the reference signal configured as the QCL source within each TCI state as the new reception beams. In this case, the higher layer signaling for the new reception beam may be configured based on the index of each reference signal, or may be configured based on a TCI state of another index in which the reference signal corresponding to the new reception beam is configured as a QCL source.

As described above, depending on whether the UE regards the current reception beam as the reference signal configured as the QCL source within the TCI state or as the SSB having a QCL relationship with the reference signal, based on notification from the BS, the UE may expect that the types of the current reception beam and the new reception beam remain the same.

For example, when the UE regards the current reception beam as a CSI-RS according to the methods described above from the BS, the UE may also consider a CSI-RS as the new reception beam for performance comparison with the current reception beam. In this case, the current reception beam and new reception beam may be identical in that they are both CSI-RSs, regardless of whether the CSI-RS corresponds to a TRS, a CSI-RS for beam management, or a CSI-RS for CSI. For instance, the UE may regard the current reception beam as a TRS configured as the QCL source within the currently indicated TCI state, and may consider a CSI-RS for beam management as the new reception beam. In another example, the UE may regard the current reception beam as a CSI-RS for beam management configured as the QCL source within the currently indicated TCI state, and may consider the TRS as the new reception beam.

In another example, when the UE regards the current reception beam as a specific type of CSI-RS (e.g., one of TRS, CSI-RS for beam management, or CSI-RS for CSI) according to the methods described above from the BS, the UE may consider the same type of CSI-RS as the new reception beam for performance comparison with the current reception beam. For instance, the UE may consider the current reception beam as a TRS configured as a QCL source in the currently indicated TCI state, and consider another TRS of the same type as the new reception beam.

When the UE is configured with new reception beam via higher layer signaling, it may be expected that the configuration is made within each TCI state. The UE may be configured, within each TCI state, with reference signals having similar reception beam directions to the reference signal configured as the QCL source within each TCI state as the new reception beams. In this case, the higher layer signaling for the new reception beam may be configured based on the index of each reference signal, or may be configured based on a TCI state of another index in which the reference signal corresponding to the new reception beam is configured as a QCL source.

As described above, depending on whether the UE regards the current reception beam as the reference signal configured as the QCL source within the TCI state or as the SSB having a QCL relationship with the reference signal, based on notification from the BS, the UE may expect that the types of the current reception beam and the new reception beam remain the same.

For example, when the UE regards the current reception beam as a CSI-RS according to the methods described above from the BS, the UE may also consider a CSI-RS as the new reception beam for performance comparison with the current reception beam. In this case, the current reception beam and new reception beam may be identical in that they are both CSI-RSs, regardless of whether the CSI-RS corresponds to a TRS, a CSI-RS for beam management, or a CSI-RS for CSI. For instance, the UE may regard the current reception beam as a TRS configured as the QCL source within the currently indicated TCI state, and may consider a CSI-RS for beam management as the new reception beam. In another example, the UE may regard the current reception beam as a CSI-RS for beam management configured as the QCL source within the currently indicated TCI state, and may consider the TRS as the new reception beam.

In another example, when the UE regards the current reception beam as a specific type of CSI-RS (e.g., one of TRS, CSI-RS for beam management, or CSI-RS for CSI) according to the methods described above from the BS, the UE may consider the same type of CSI-RS as the new reception beam for performance comparison with the current reception beam. For instance, the UE may consider the current reception beam as a TRS configured as a QCL source in the currently indicated TCI state, and consider another TRS of the same type as the new reception beam.

In event 4, a specific reference value used to compare the performance of the new reception beam with that of the current reception beam may be reported by the UE to the BS via a UE capability, configured by the BS via higher layer signaling, or statically defined in the specification.

In event 4, the UE may introduce a specific time interval and a counter to determine whether the performance of a new reception beam is greater than that of the current reception beam by a specific reference value or more. The UE may determine whether event 4 has occurred within the time interval that starts from a time point at which information on the current reception beam becomes available. The time point at which information on the current reception beam becomes available may be a time point when the currently indicated TCI state is applied, or a time point at which the reference signal (e.g., CSI-RS or SSB as described above) corresponding to the current reception beam is received after time point at which the currently indicated TCI state is applied. The length of the time interval may be the periodicity of the reference signal corresponding to the current reception beam, or a real-number value that is greater than or less than the periodicity in terms of a frame, subframe, slot, symbol, or absolute time (e.g., msec), and may be configured by the BS to the UE via higher layer signaling. The UE may reset the time interval each time it receives the reference signal corresponding to the current reception beam, or at the time point at which the time interval ends.

Within the time interval, the UE may receive reference signals (i.e., CSI-RS or SSB as described above) corresponding to one or more new reception beams, and when event 4 occurs a specific number of times or more for a specific new reception beam, the UE may perform reception beam performance reporting, initiated by the UE, to the BS. Additionally, from the start point of the time interval, the UE may store, in the above-mentioned counter, the number of consecutive occurrences of event 4 within the time interval. When it is determined that the counter value exceeds a specific number, the UE may perform reception beam performance reporting, initiated by the UE, to the BS. The number of consecutive occurrences of event 4 may refer to when the performance of a specific new reception beam is determined to be greater than that of the current reception beam by at least a specific reference value. For example, when the performance of each of two different new reception beams is greater than that of the current reception beam by at least a specific reference value, it may be considered that event 4 has occurred once for each new reception beam. Within the time interval, the UE may identify whether event 4 occurs during every period of the current reception beam. When event 4 continuously occurs but not enough to reach a specific number of times, and event 4 does not occur in a specific period of the current reception beam, such that the count of consecutive occurrences no longer exceeds the specific number of times, the UE may reset the end time point of the specific period as a new start point of the time interval.

Based on the method described above, the UE may identify the number of consecutive occurrences of event 4 within a specific time interval and perform the reception beam performance reporting, initiated by the UE, to the BS. In this case, the specific number of occurrences may be one by default, and the UE may be configured by the BS with a specific natural number X greater than 1. The UE may report its individual capability regarding whether it considers the specific number of times as one, or as a specific natural number X greater than one, and notify the BS of whether it supports such a reporting approach. In event 4, when performing the UE-initiated reception beam performance reporting, the UE may include at least one of the following pieces of information in the report to the BS. The UE may include the index of the current reception beam and/or the performance of the current reception beam in the report to the BS. The index of the current reception beam may be the index of the CSI-RS resource when the current reception beam is CSI-RS according to the above-mentioned, or may be the index of the SSB when the current reception beam is SSB. The UE may perform the index of the current reception beam and/or the performance of the current reception beam without configuration a specific higher layer signaling from the BS when the reception beam performance report starting from the UE corresponding to event 4.

The UE may receive a configuration from the BS via higher layer signaling whether to perform the UE-initiated reception beam performance reporting including the index of the current reception beam and/or the performance of the current reception beam. That is, when the UE receives the higher layer signaling from the BS, the UE may perform the UE-initiated reception beam performance reporting by including the index of the current reception beam and/or the performance of the current reception beam in the report. In case that the UE does not receive the higher layer signaling from the BS, the UE may perform the UE-initiated reception beam performance reporting without including the index of the current reception beam and/or the performance of the current reception beam.

When reporting the performance of a new reception beam, the UE may use the method of event 1 similarly.

The UE may use at least one combination of event 1, event 2, event 3, or event 4 for performing UE-initiated reception beam performance reporting. For example, the UE may perform reception beam performance reporting to the BS by considering event 1. As another example, the UE may be configured via higher layer signaling with respective reporting conditions for event 1 and event 2, and may perform reception beam performance reporting separately based on event 1 and event 2. When event 1 occurs, the UE may perform the UE-initiated reception beam performance reporting corresponding to event 1. When event 2 occurs, the UE may perform the UE-initiated reception beam performance reporting corresponding to event 2. When event 1 and event 2 occur simultaneously, the UE may report the UE-initiated reception beam performance corresponding to both event 1 and event 2, or may select only one of them or report the reception beam performance related to the event with a higher priority.

The UE may perform UE capability reporting to the BS to indicate that support for at least one combination of event 1, event 2, event 3, and event 4 is possible. For example, the UE may report, via UE capability to the BS, that it is possible to support UE-initiated reception beam performance reporting for event 1. For example, the UE may report, via UE capability to the BS, that it is possible to support UE-initiated reception beam performance reporting for event 2. For example, the UE may report, via UE capability to the BS, that it is possible to support UE-initiated reception beam performance reporting for event 1 and event 2.

In event 1, event 2, event 3, or event 4 described above, the UE may define a timer during which it does not monitor the occurrence of a specific event. For example, when beam switching occurs from a BS, the UE may not monitor specific events defined in event 1 to event 4 for a predetermined period of time starting from the time of the beam switching. As another example, after the specific event defined in event 1 to event 4 has occurred, the UE may not monitor the specific events defined in the in event 1 to event 4 for a predetermined period of time starting from the occurrence of the specific event. Through this method, frequent information exchange and beam switching between the UE and the BS can be prevented by suspending UE-initiated CSI reporting for a predetermined period of time after beam switching is configured or instructed by the BS.

The UE may monitor only one of event 1, event 2, event 3, or event 4, and perform UE-initiated CSI reporting when the corresponding event occurs. Alternatively, the UE may monitor one or more specific events independently and perform UE-initiated CSI reporting corresponding to each event, or may monitor one or more events separately but, if one or more events occur simultaneously, perform UE-initiated CSI reporting corresponding to the event with the highest priority. In each of these cases, the UE may apply the aforementioned timer either separately for each event or commonly to events. When the UE applies the timer commonly while monitoring one or more events, it means that the specific event occurs, the same timer is applied to the other events as well.

After one of the above-described specific events occurs, the UE may perform UE-initiated CSI reporting to deliver reception beam performance-related information to the BS. In this case, the UE may consider at least one of the following approaches in combination to perform the UE-initiated CSI reporting.

### Method 3-1

The UE may be configured with a PUCCH resource for requesting PUSCH resource allocation, including the transmission of UE-initiated reception beam performance reporting to the BS. When the above-mentioned specific event occurs from the UE, the UE may transmit a PUCCH (or PUSCH resource allocation request information, or a scheduling request) to the BS through the configured PUCCH resource. In this case, the UE may be configured, via higher layer signaling, with a PUCCH resource used for UE-initiated reception beam performance reporting, and this may be configured separately from the PUCCH resource used for conventional UL data scheduling requests. The PUCCH resource may include 1-bit information.

In addition, the UE may be configured with a single PUCCH resource for simultaneously requesting at least one combination of a request for PUSCH resource allocation that allows inclusion and transmission of a UE-initiated reception beam performance reporting to the BS and UL data scheduling, and two bits of information may be transmitted through the configured PUCCH resource. In case that the corresponding PUCCH resource has information bits of “01”, the corresponding PUCCH resource may indicate a conventional UL data scheduling request, and when the bit has a value of “10”, the corresponding PUCCH resource may trigger a request for PUSCH resource allocation that allows inclusion and transmission of the UE-initiated reception beam performance reporting to the BS as described above. When the bit has a value of “11”, the corresponding PUCCH resource may trigger both the UL data scheduling request and the request for PUSCH resource allocation that allows inclusion and transmission of the UE-initiated reception beam performance reporting to the BS. In case that the BS has received the corresponding PUCCH resource having information bits of “11” from the UE, the BS may transmit single DCI to the UE, and may force the UE to include, in the DCI, PUSCH scheduling information for UL data and PUSCH scheduling information for UE-initiated reception beam performance reporting, along with information indicating to include the UE-initiated reception beam performance report in the corresponding PUSCH. In this case, the corresponding DCI may schedule a PUSCH containing both the UL data and the reception beam performance reporting. This technique is merely an example, and the disclosure is not limited thereto.

In this case, the UE may be configured with a slot-level periodicity and offset for a PUCCH resource that triggers the UE-initiated reception beam performance reporting, or for a single PUCCH resource that enables simultaneous requests for at least one combination of the UE-initiated beam performance reporting and UL data scheduling. Upon occurrent of the specific event, the UE may transmit the information described above via the PUCCH resource corresponding to the closest period after a specific time offset from the time point at which the specific event has occurred. The above-described information may be referred to as a scheduling request. In this case, a specific time offset may be defined in units of slots or ms, and may include 0 among the possible values (i.e., a specific time offset may not be required). This time offset may be defined by a UE capability and reported by the UE to the BS, or notified by the BS through at least one combination of higher layer signaling, MAC-CE signaling, and L1 signaling, or defined through at least one combination of methods statically defined in the specification.

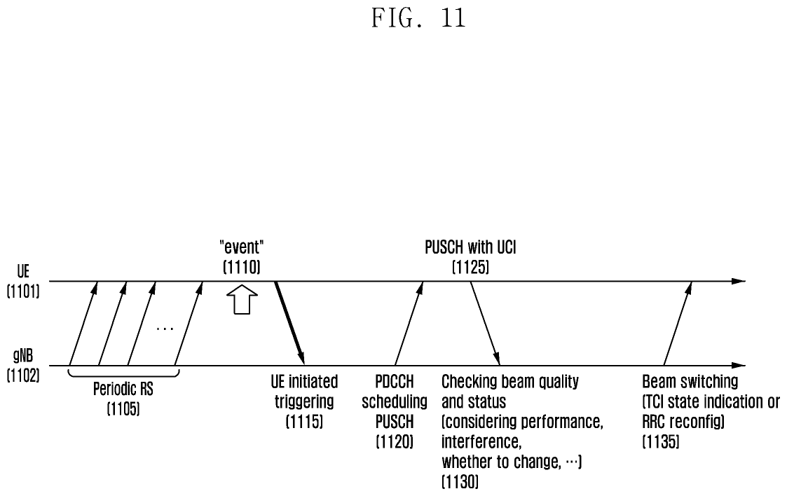

FIG. 11 illustrates an example of operations of a UE and a BS for CSI reporting initiated by a UE using a PUCCH resource that triggers the UE-initiated reception beam performance reporting according to an embodiment.

Referring to FIG. 11, a UE 1101 may be configured with a set of periodic channel measurement reference signals via higher layer signaling from a BS 1102, and may periodically receive the periodic channel measurement reference signals to measure the reception beam performance (1105). Thereafter, when a specific event occurs in the UE (1110), the UE may transmit a signal to the BS on a PUCCH resource that triggers the UE-initiated reception beam performance reporting. The specific event may correspond to at least one of events 1 to 4 described above. The corresponding PUCCH resource may be a PUCCH resource for a UL data scheduling request as described above and an individual PUCCH resource, or may be a PUCCH resource for requesting a combination of at least one of a UL data scheduling request and the UE-initiated reception beam performance reporting to the BS. In response thereto, the BS may transmit, to the UE, a PDCCH that triggers the UE-initiated reception beam performance reporting (or schedules a PUSCH for transmitting the reception beam performance report) (1120), and the UE may calculate a UCI according to the UE-initiated reception beam performance reporting request in response thereto and transmit the UCI to the BS by including the UCI in a PUSCH scheduled by the PDCCH (1125). Thereafter, when the BS determines that beam switching is required for the UE (1130), the BS may configure or instruct the UE to perform beam switching (1135).

In the method 3-1 described above, since the process of the UE-initiated channel status information reporting may be relatively long, the benefits in terms of latency may be limited. However, as described above, under conventional standards, the BS is required to transmit triggering of an aperiodic CSI report to the UE based on indirect information, and therefore, although an aperiodic CSI reporting method is available, it may not be fully utilized. Accordingly, when the UE first performs triggering of the UE-initiated reception beam performance reporting, a latency advantage over conventional schemes is realized. In addition, since the triggering of the reception beam performance reporting may be transmitted to the BS through a single PUCCH resource together with a UL data scheduling request, there may be a benefit in terms of signaling overhead. Furthermore, since the corresponding UE-initiated reception beam performance report is transmitted via the PUSCH, UCIs of various maximum lengths can be transmitted from the UE to the BS. Accordingly, this method can be applied to various cases in which the amount of information exchanged between the UE and the BS ranges from a small number of bits to a large amount of information.

### Method 3-2

The UE may be configured, by the BS, with a pair of a reserved PUCCH resource and a PUSCH transmission for UE-initiated CSI (CSI) reporting. In this case, the UE may generate the UE-initiated CSI in the form of a UCI or MAC-CE and include the same in the PUSCH to transmit to the BS. The UE may be configured with a slot-level periodicity and offset for the PUCCH resource and the PUSCH transmission, and may also be configured with parameters related to the PUSCH transmission, such as a time offset between the PUCCH resource and the PUSCH transmission, time and frequency resource allocation information for the PUSCH transmission, MCS (e.g., the lowest value), the number of MIMO layers (e.g., 1), DMRS port (e.g., 0), and waveform (e.g., CP-OFDM).

In another method, the UE may be configured with a slot-level periodicity and offset for the PUCCH resource, and may be configured with higher layer signaling related to the configured grant Type 1 PUSCH transmission by assuming a PUSCH transmission based on the Configured Grant Type 1 in the PUSCH transmission. In such case, the UE may transmit the PUSCH in a period only when a signal is transmitted through the PUCCH resource prior to the PUSCH transmission period, rather than transmitting the PUSCH in every period. In addition, upon the occurrence of the specific event, the UE may transmit the signal through the PUCCH resource in the closest period after a specific time offset from the time point at which the specific event has occurred. In this case, a specific time offset may be defined in units of slots or ms and may include 0 among the possible values (i.e., a specific time offset may not be required). This time offset may be defined by a UE capability and reported by the UE to the BS, or notified by the BS through at least one combination of higher layer signaling, MAC-CE signaling, and L1 signaling, or defined through at least one combination of methods statically defined in the specification.

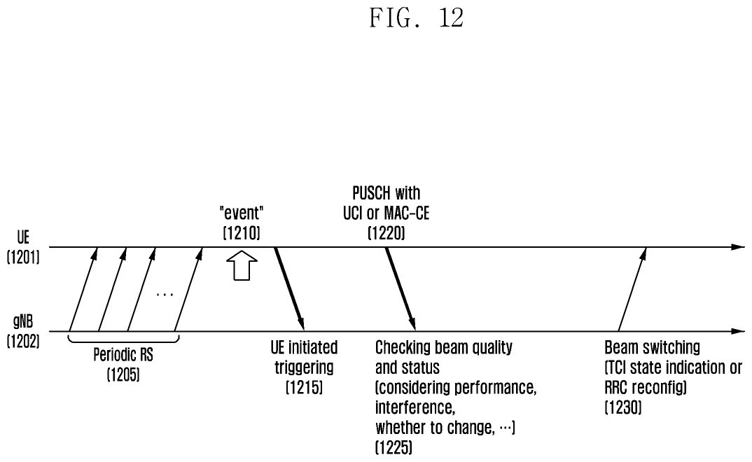

FIG. 12 illustrates a process of a UE and a BS for CSI reporting initiated by a UE using a pair of a reserved PUCCH resource and a PUSCH transmission according to an embodiment. Referring to FIG. 12, a UE 1201 may be configured with a set of periodic channel measurement reference signals from a BS 1202 via higher layer signaling, and may periodically receive the periodic channel measurement reference signals to measure reception beam performance (1205). Thereafter, when a specific event occurs in the UE (1210) (the specific event may correspond to at least one of the Events 1 to 4 described above), the UE may transmit a signal to the BS via the PUCCH resource (1215). Thereafter, the UE may perform PUSCH transmission after a time offset between the PUCCH resource set configured for the UE and the PUSCH transmission (1220), and may include UCI or MAC-CE in the corresponding PUSCH. Thereafter, when the BS determines that beam switching is required for the UE (1225), the BS may configure or instruct the UE to perform beam switching (1230).

In method 3-2 described above, the process of UE-initiated CSI reporting may be relatively shortened, which may be advantageous in terms of latency. However, the UE requires reserved PUCCH resources and PUSCH transmission resources, and during blind decoding at the BS, if at least one of the two channels is incorrectly decoded, the BS may fail to decode the UE-initiated reception beam performance report intended to be transmitted by the UE. Accordingly, the BS may need to attempt decoding again for the subsequently transmitted PUCCH and PUSCH from the UE to properly receive the report.

The UE may be notified by the BS of at least one combination of method 3-1 or method 3-2 through at least one combination of higher layer signaling, MAC-CE signaling, and L1 signaling, or may expect that at least one combination of method 3-1 or method 3-2 is statically defined in the specification. Additionally, when the UE is notified by the BS of at least one combination of specific one or more methods through at least one combination of higher layer signaling, MAC-CE signaling, and L1 signaling, this indicates that the UE cannot support specific one or more other combinations of methods. For example, the UE may expect that method 3-2 is statically defined in the specification for the method and process for the UE-initiated CSI reporting method and process described above. In another example, the UE may be notified of the above method 3-1 by a combination of at least one of higher layer signaling, MAC-CE signaling, and L1 signaling from the BS, and in this case, the UE may consider that the UE has been notified by the BS that the above method 3-2 is not supported.

The UE may report to the BS whether the UE may support at least one combination of the above method 3-1 or method 3-2 via a UE capability. In this case, when the UE reports to the BS via a UE capability that a combination of specific one or more methods is supportable, it may be considered that the UE has reported that it cannot support one or more other specific combinations of methods. For example, the UE may report to the BS whether or not the UE can support method 3-1 or method 3-2 described above. In another example, the UE may report to the BS that it is supportable the above method 3-1, and this UE capability report may imply that the UE cannot support method 3-2.

Method 3-1 or method 3-2 described above considered periodic CSI reporting as a conventional CSI reporting method, but the UE may also consider a semi-persistent CSI reporting method and/or an aperiodic CSI reporting method to perform the UE-initiated CSI reporting, and in the case of the channel measurement reference signal for this, not only a periodic reference signal but also a semi-persistent and aperiodic reference signal may be considered.

In method 3-1 or method 3-2 described above, the UE may define a predetermined timer such that, after performing the UE-initiated CSI reporting according to each method, the UE does not perform UE-initiated CSI reporting for a predetermined period of time. This can prevent frequent CSI reporting by the UE and, in the case of methods that require blind decoding at the BS, can prevent the BS from performing blind decoding for a predetermined period of time.

A method for determining the validity of a CSI report when performing UE-initiated reception beam performance reporting is described and may operate in combination with other embodiments.

When the UE performs UE-initiated reception beam performance reporting based on method 3-1, the UE may consider the following as the starting point for satisfying the CSI reporting validity condition 1 described above.

After the occurrence of a specific event, the UE may regard a PUCCH resource available for transmission as the starting point for satisfying the CSI reporting validity condition 1. In other words, the UE may determine that the UE-initiated reception beam performance reporting is valid starting from the first symbol occurring after T_{proc,CSI} following the transmission of a reception beam performance report triggering on the PUCCH resource. By considering such a common starting point condition for the CSI reporting validity condition 1, the UE and the BS may reduce the latency of the UE-initiated reception beam performance reporting. After transmitting a reception beam performance report triggering on the PUCCH resource, the UE may generate the UCI for the UE-initiated reception beam performance reporting and, when receiving a PUSCH resource allocation through DCI from the BS, the UE may include the pre-generated UCI immediately in the PUSCH, thereby reducing the reception beam reporting latency. To this end, the UE may be instructed by the BS to transmit no data in the PUSCH scheduled for UCI transmission.

After the occurrence of the specific event, the UE may regard the end point of the last symbol in which the DCI scheduling PUSCH resource allocation is received as a response from the BS to the PUCCH resource that can be transmitted from the UE, as the starting point for satisfying the CSI reporting validity condition 1 described above. In other words, the UE may determine that the UE-initiated reception beam performance reporting is valid from the first symbol occurring after T_{proc,CSI} from the end point of the last symbol in which the DCI has been received. By considering such a common starting point condition for the CSI reporting validity condition 1, the UE and the BS may shorten the latency of the reception beam performance report that can be transmitted from the UE. The UE may generate UCI for the UE-initiated reception beam performance reporting starting from the end point of the last symbol in which the DCI has been received from the BS and may include the UCI in the PUSCH upon receiving the PUSCH resource allocation through the DCI. The UE may assume that UL data transmission may exist in the PUSCH scheduled by the BS.

When performing UE-initiated reception beam performance reporting as described above, the UE may assume that no additional aperiodic CSI reporting exists other than the UE-initiated reception beam performance reporting, indicated by the DCI from the BS. This indicates that the UE-initiated reception beam performance reporting is possible when indicated through a new field in the DCI, or that, when the UE-initiated reception beam performance reporting is indicated via the CSI request field in the DCI, only the UE-initiated reception beam performance reporting is included in the specific codepoint indicated through the CSI request field.

When performing UE-initiated reception beam performance reporting based on method 3-2, the UE may consider the following conditions as the starting point for satisfying the above-described CSI reporting validity condition 1. The UE may report, via UE capability to the BS, whether it supports at least one combination of the following conditions. The UE may be notified by the BS, via at least one combination of higher layer signaling, MAC-CE signaling, or L1 signaling, of the method to be used for determining the time point at which the validity of the UE-initiated reception beam performance reporting is to be determined.

The UE may regard the time point at which a specific event occurs as the starting point for satisfying CSI reporting validity condition 1. When this time point is regarded as the starting point, a CSI report may be considered valid from the first symbol occurring after T_{proc,CSI} from the occurrence of the specific event. Therefore, it is highly likely that the UE-initiated reception beam performance reporting will be transmitted using the PUSCH transmission resource that immediately follows the PUCCH resource transmission period.

The UE may regard the start time point of the first symbol of the PUCCH resource that can be transmitted by the UE after the occurrence of the specific event as the starting point for satisfying CSI reporting validity condition 1. If the position of the first symbol occurring after T_{proc,CSI} from the first symbol of the PUCCH resource transmission starting point is after the starting point of the first PUSCH transmission resource that follows the first symbol of the PUCCH transmission starting point, the UE-initiated reception beam reporting through the first PUSCH transmission resource may be considered invalid. That is, the UE may not perform the UE-initiated reception beam reporting through the first PUSCH transmission resource, and instead, may perform the reception beam reporting through the second PUSCH transmission resource following the PUCCH resource transmission.
The UE may regard the end point of the last symbol of the PUCCH resource that can be transmitted by the UE after the occurrence of a specific event as the starting point for satisfying the above-described CSI reporting validity condition 1. If the position of the first symbol appearing after T_{proc,CSI} from the end point of the last symbol of the PUCCH resource is after the start point of the first PUSCH transmission resource following the PUCCH resource transmission, the UE may not perform the UE-initiated reception beam performance reporting through the first PUSCH transmission resource and may perform the reception beam reporting through the second PUSCH transmission resource following the PUCCH resource transmission.

The UE may calculate CSI based on a reference signal received before the CSI reference resource and may report the calculated CSI to the BS.

When performing UE-initiated reception beam performance reporting based on method 3-1, the UE may consider the following as possible positions for the CSI reference resource described above.

The UE may consider the position of the CSI reference resource that can be considered for the UE-initiated reception beam performance reporting to be the same as the position of the CSI reference resource used for aperiodic CSI reporting. If the UE receives DCI for the UE-initiated reception beam performance reporting, and the DCI indicates a PUSCH resource allocation that includes the UE-initiated reception beam performance reporting, and if the PUSCH is indicated to be transmitted in the same slot as the DCI, the UE may determine a slot, in which the DCI is received, as the CSI reference resource. If the PUSCH is not indicated to be transmitted in the same slot as the DCI, and the slot index in which the UE-initiated reception beam performance reporting occurs is n, the CSI reference resource may correspond to a slot that is

$${n}_{CSI - ref} = ⌊ {Z}^{′} / {N}_{symb}^{slot} ⌋$$

number of slots earlier than slot index n. In this case, Z′ may correspond to the above-mentioned CSI processing time, and

$${N}_{symb}^{slot}$$

may denote the number of symbols included in a single slot, which may be 14.

In other words, the UE may measure reference signals (e.g., at least one reference signal corresponding to the current reception beam and/or new reception beam described above) up to the above-described CSI reference resource for the purpose of generating UE-initiated reception beam performance reporting, and may generate a UCI for the UE-initiated reception beam performance report based on the measurement. After the CSI reference resource, the UE may stop measuring the corresponding reference signals and may restart the measurement from a specific time point. The criterion for restarting such a measurement may be configured by the UE based on a notification received from the BS (e.g., through at least one or a combination of higher layer signaling, MAC-CE signaling, or L1 signaling), may be statically defined in the specification (e.g., starting from a specific number of slots after the UE-initiated reception beam performance report, from a specific number of symbols after the report, from the first slot after a specific absolute time), may follow a value reported by UE capability (e.g., starting from a specific number of slots after the UE-initiated reception beam performance report, from a specific number of symbols after the report, from the first slot after a specific number of symbols, or from the first slot after a specific absolute time), or may be a time after the UE-initiated reception beam performance reporting. When such a method is applied, although the corresponding CSI report is UE-initiated reception beam performance reporting, the reporting method performed according to method 3-1 may be performed in a manner similar to an aperiodic CSI report, thereby allowing reuse of the implementation used for the aperiodic CSI reporting.

The position of the CSI reference resource that may be considered during the UE-initiated reception beam performance reporting may be determined as the slot position where the UE identifies the occurrence of a specific event or the time point at which the first PUCCH resource is transmitted. Since the UE-initiated reception beam performance reporting is based on the occurrence of a specific event, the information included in the UCI generated for the UE-initiated reception beam performance reporting is also determined according to the event that has been occurred. Therefore, by restricting the position of the CSI reference resource to the position in which the event has occurred, it is possible to reduce the power consumption of the UE by preventing the UE from performing measurement for the UE-initiated reception beam performance reporting from the time point at which the event has occurred until the time point at which the UE-initiated reception beam performance reporting is performed.

The position of the CSI reference resource that may be considered for the UE-initiated reception beam performance reporting may not be defined. In other words, the UE may continuously perform measurements for the reference signals (e.g., reference signals corresponding to the current reception beam or new reception beams) when performing UE-initiated reception beam performance reporting. When the UE performs the UE-initiated reception beam performance reporting, the reception beam performance included in the report may be considered as a value measured before the first PUCCH resource transmitted by the UE.

For the UE-initiated reception beam performance reporting based on method 3-2, the following may be considered as possible positions of the CSI reference resource:

The position of the CSI reference resource that may be considered during UE-initiated reception beam performance reporting may be determined as the slot position where the UE identifies the occurrence of a specific event or the time point at which the first PUCCH resource is transmitted. Since the UE-initiated reception beam performance reporting is based on the occurrence of a specific event, the information in the UCI generated for the UE-initiated reception beam performance reporting is also determined accordingly. Therefore, by restricting the position of the CSI reference resource to the position in which the event has occurred, it is possible to reduce the power consumption of the UE by preventing the UE from performing measurement for the UE-initiated reception beam performance reporting from the time point at which the event has occurred until the time point at which the UE-initiated reception beam performance reporting is performed.

In case that the UE performs method 3-1 and/or method 3-2, the UE may receive reference signals that can be received after the CSI reference resource. The UE may perform measurements for reference signals related to a UE-initiated reception beam reporting after the CSI reference resource, and the results of such measurements for the reference signals that can be received after the CSI reference resource may not be included in the CSI report based on the event that has occurred before the CSI reference resource. Instead, these measurements may be used for monitoring in preparation for a subsequent event. The UE may provide a notification to the BS, via UE capability reporting, whether it is capable of receiving reference signals even after the CSI reference resource. Upon receiving such a UE capability report, the BS may notify the UE to receive the reference signals after the CSI reference resource through at least one combination of higher layer signaling, MAC-CE signaling, or L1 signaling. When the UE reports the above UE capability, the BS may consider that the UE performs measurement on the reference signals after the CSI reference resource without requiring an explicit notification.

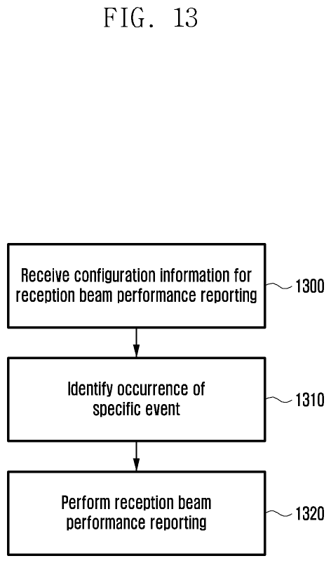

FIG. 13 illustrates a method of a UE that reports reception beam performance according to an embodiment.

The UE may transmit, to the BS, UE capability information related to the reception beam performance reporting from the UE. The UE capability information may include at least one of whether the UE supports the reception beam performance reporting from the UE, the number of current and/or new reception beams that can be reported, information on the types of reference signals that can be reported, whether the UE supports the reception beam performance reporting in a specific event, the number of occurrences of a specific event, information on a reference value relating to the difference between the current reception beam performance and new reception beam performance, and a CSI reporting method supportable by the UE. This information above is only an example. The transmission of the UE capability information may be omitted.

Referring to FIG. 13, the UE receives configuration information for reception beam performance reporting from the BS (1300). The configuration information may include at least one of configuration information for at least one of the above-described events 1 to 4, configuration information for the reception beam performance reporting methods 3-1 and/or 3-2, configuration information for determining the validity of CSI reporting, and configuration information for the CSI reference resource.

The UE identifies that the occurrence of an event requires the reception beam performance reporting, based on the received configuration information (operation 1310). The identification of the occurrence of an event may follow the methods described above. Thereafter, the UE performs the reception beam performance reporting according to the method described above (1320). The index and/or performance of the current reception beam and/or the index and/or performance of the new reception beam described above may be included in the reception beam performance reporting. The reception beam performance reporting may be performed according to Method 3-1 and/or Method 3-2. In addition, the reference signal included in the reception beam performance reporting may be determined based on the CSI reference resource as described above.

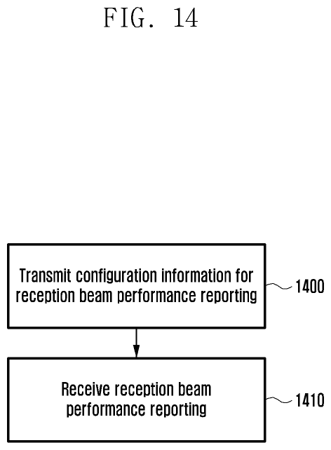

FIG. 14 illustrates a method of a BS that receives reception beam performance reporting according to an embodiment.

The BS may receive UE capability information related to the reception beam performance reporting from the UE. The UE capability information may include at least one of whether the UE supports the reception beam performance reporting from the UE, the number of current and/or new reception beams that can be reported, information on the types of reference signals that can be reported, whether the UE supports the reception beam performance reporting in specific events, the number of occurrences of a specific event, information on a reference value relating to the difference between the current reception beam performance and new reception beam performance, and a CSI reporting method supportable by the UE. This information above is only an example. The reception of the UE capability information may be omitted.

Referring to FIG. 14, the BS transmits configuration information for reception beam performance reporting to the UE (1400). The configuration information may include at least one of configuration information for at least one of the above-described Events 1 to 4, configuration information on the reporting method such as Method 3-1 and/or Method 3-2, configuration information for determining the validity of the CSI report, or configuration information on the CSI reference resource.

Thereafter, the BS receives the reception beam performance report based on the method described above (1410). The reception beam performance reporting is performed when an event that is required to perform the reception beam performance reporting has occurred. The identification of the occurrence of an event by the UE may follow the methods described above. The index and/or performance of the current reception beam and/or the index and/or performance of the new reception beam described above may be included in the reception beam performance reporting, and the reception beam performance reporting may be performed according to method 3-1 and/or 3-2. The reference signal included in the reception beam performance report may follow the CSI reference resource as described above.

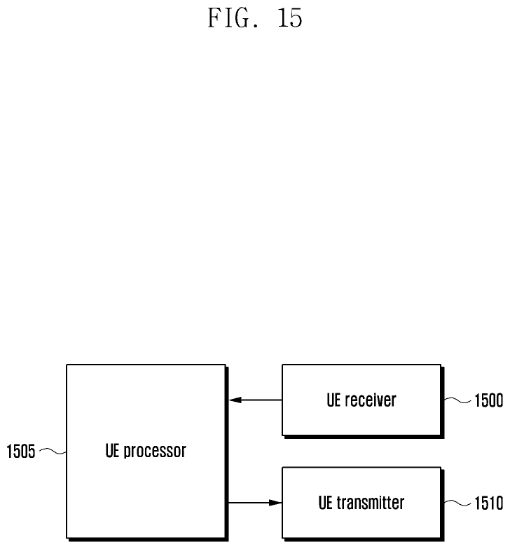

FIG. 15 illustrates a structure of a UE in a wireless communication system according to an embodiment.

Referring to FIG. 15, the UE may include a transceiver, which refers to a UE receiver 1500 and a UE transmitter 1510, a memory (not illustrated), and a UE processor 1505 (or UE controller or processor). The UE transceiver 1500 and 1510, the memory, and the UE processor 1505 may operate according to the above-described communication methods of the UE. Components of the UE are not limited to the above-described example. For example, the UE may include a larger or smaller number of components than the above-described components. The transceiver, the memory, and the processor may be implemented in the form of a single chip.

The transceiver may transmit/receive signals with the UE. The signals may include control information and data. To this end, the transceiver may include an RF transmitter configured to perform amplification and up-conversion of a frequency of a transmitted signal, an RF receiver configured to perform low-noise amplification of a received signal and down-conversion of a frequency, and the like. However, this is only an embodiment of the transceiver, and the components of the transceiver are not limited to the RF transmitter and the RF receiver.

In addition, the transceiver may receive signals through a radio channel, output the same to the processor, and transmit signals output from the processor through the radio channel.

The memory may store programs and data necessary for operations of the UE. In addition, the memory may store control information or data included in signals transmitted/received by the UE. The memory may include storage media such as a read only memory (ROM), a random access memory (RAM), a hard disk, a CD-ROM, and a DVD, or a combination of storage media. In addition, the memory may include multiple memories.

The processor may control a series of processes such that the UE can operate according to the above-described embodiments. For example, the processor may control components of the UE to receive DCI configured in two layers so as to simultaneously receive multiple PDSCHs. The processor may include multiple processors, and the processor may perform operations of controlling the components of the UE by executing programs stored in the memory.

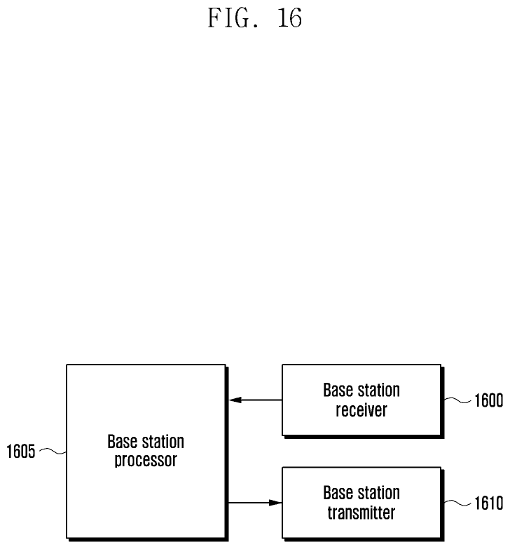

FIG. 16 illustrates a structure of a BS in a wireless communication system according to an embodiment.

Referring to FIG. 16, the BS may include a transceiver, which refers to a BS receiver 1600 and a BS transmitter 1610 as a whole, a memory (not illustrated), and a BS processor 1605 (or BS controller or processor). The BS transceiver 1600 and 1610, the memory, and the BS processor 1405 may operate according to the above-described communication methods of the BS. However, components of the BS are not limited to the above-described example. For example, the BS may include a larger or smaller number of components than the above-described components. The transceiver, the memory, and the processor may be implemented in the form of a single chip.

The transceiver may transmit/receive signals with UEs. The signals may include control information and data. To this end, the transceiver may include an RF transmitter configured to perform amplification and up-conversion of a frequency of a transmitted signal, an RF receiver configured to perform low-noise amplification of a received signal and down-conversion of a frequency, and the like. However, this is only an embodiment of the transceiver, and the components of the transceiver are not limited to the RF transmitter and the RF receiver.

In addition, the transceiver may receive signals through a radio channel, output the same to the processor, and transmit signals output from the processor through the radio channel.

The memory may store programs and data necessary for operations of the BS. In addition, the memory may store control information or data included in signals transmitted/received by the BS. The memory may include storage media such as a ROM, a RAM, a hard disk, a CD-ROM, and a DVD, or a combination of storage media. In addition, the memory may include multiple memories.

The processor may control a series of processes such that the BS can operate according to the above-described embodiments of the disclosure. For example, the processor may control components of the BS to configure DCI configured in two layers including allocation information regarding multiple PDSCHs and to transmit the same. The processor may include multiple processors, and the processor may perform operations of controlling the components of the BS by executing programs stored in the memory.

Herein, each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). In some alternative implementations, the functions noted in the blocks may occur out of the order. For example, two blocks shown in succession may in fact be executed substantially concurrently or the blocks may sometimes be executed in the reverse order, depending upon the functionality involved.

Herein, the term unit refers to a software element or a hardware element, such as a field programmable gate array (FPGA) or an application specific integrated circuit (ASIC), and the unit may perform certain functions. However, the unit does not always have a meaning limited to software or hardware. The unit may be constructed either to be stored in an addressable storage medium or to execute one or more processors. Therefore, the unit includes software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the unit may be either combined into a smaller number of elements, or a unit, or divided into a larger number of elements, or a unit. Moreover, the elements and units may be implemented to reproduce one or more central processing units (CPUs) within a device or a security multimedia card. The unit in embodiments may include one or more processors.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to embodiments of the disclosure.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

The programs may be stored in an attachable storage device which can access the electronic device through communication networks such as the Internet, Intranet, local area network (LAN), wide LAN (WLAN), and storage area network (SAN) or a combination thereof. Such a storage device may access the electronic device via an external port. Also, a separate storage device on the communication network may access a portable electronic device.

While the disclosure has been described with reference to various embodiments, various changes may be made without departing from the spirit and the scope of the present disclosure, which is defined, not by the detailed description and embodiments, but by the appended claims and their equivalents.

What is claimed is:

1. A method performed by a terminal in a communication system, the method comprising:
receiving, from a base station (BS), configuration information on a channel state information (CSI) reporting initiated by the terminal;
detecting an occurrence of an event associated with the CSI reporting initiated by the terminal;
transmitting, to the BS, an indicator for the CSI reporting initiated by the terminal on a physical uplink control channel (PUCCH); and
transmitting, to the BS, CSI on a physical uplink shared channel (PUSCH), wherein the PUSCH is transmitted after an offset from the PUCCH.

2. The method of claim 1,
wherein the event corresponds to when a reference signal received power (RSRP) of a reference signal as a new beam is greater than a sum of an RSRP of a current reference signal associated with a transmission configuration indicator (TCI) state and a threshold configured by higher layer signaling.

3. The method of claim 2,
wherein the reference signal as the new beam is configured by the higher layer signaling, and
wherein a type of the current reference signal is identical to a type of the reference signal as the new beam.

4. The method of claim 2,
wherein the current reference signal is of quasi co-located (QCL) type D of the TCI state.

5. The method of claim 1,
wherein the CSI includes one or more indices of the reference signal as the new beam and corresponding one or more reference signal received powers (RSRPs), and
wherein a highest RSRP is an absolute RSRP and another RSRP is a differential RSRP.

6. A method performed by a base station in a communication system, the method comprising:
transmitting, to a terminal, configuration information on a channel state information (CSI) reporting initiated by the terminal;
receiving, from the terminal, an indicator for the CSI reporting initiated by the terminal on a physical uplink control channel (PUCCH); and
receiving, from the terminal, CSI on a physical uplink shared channel (PUSCH),
wherein the CSI reporting is initiated based on an occurrence of an event associated with the CSI reporting initiated by the terminal, and
wherein the PUSCH is transmitted after an offset from the PUCCH.

7. The method of claim 6,
wherein the event corresponds to when a reference signal received power (RSRP) of a reference signal as a new beam is greater than a sum of an RSRP of a current reference signal associated with a transmission configuration indicator (TCI) state and a threshold configured by higher layer signaling.

8. The method of claim 7,
wherein the reference signal as the new beam is configured by the higher layer signaling, and
wherein a type of the current reference signal is identical to a type of the reference signal as the new beam.

9. The method of claim 7,
wherein the current reference signal is of quasi co-located (QCL) type D of the TCI state.

10. The method of claim 6,
wherein the CSI includes one or more indices of the reference signal as the new beam and corresponding one or more reference signal received powers (RSRPs), and
wherein a highest RSRP is an absolute RSRP and another RSRP is a differential RSRP.

11. A terminal in a communication system, the terminal comprising:
at least one transceiver;
at least one processor communicatively coupled to the at least one transceiver; and
at least one memory, communicatively coupled to the at least one processor, storing instructions executable by the at least one processor individually or in any combination, to cause the terminal to:
receive, from a base station (BS), configuration information on a channel state information (CSI) reporting initiated by the terminal,
detect an occurrence of an event associated with the CSI reporting initiated by the terminal,
transmit, to the BS, an indicator for the CSI reporting initiated by the terminal on a physical uplink control channel (PUCCH), and
transmit, to the BS, CSI on a physical uplink shared channel (PUSCH),
wherein the PUSCH is transmitted after an offset from the PUCCH.

12. The terminal of claim 11,
wherein the event corresponds to when a reference signal received power (RSRP) of a reference signal as a new beam is greater than a sum of an RSRP of a current reference signal associated with a transmission configuration indicator (TCI) state and a threshold configured by higher layer signaling.

13. The terminal of claim 12,
wherein the reference signal as the new beam is configured by the higher layer signaling, and
wherein a type of the current reference signal is identical to a type of the reference signal as the new beam.

14. The terminal of claim 12,
wherein the current reference signal is of quasi co-located (QCL) type D of the TCI state.

15. The terminal of claim 11,
wherein the CSI includes one or more indices of the reference signal as the new beam and corresponding one or more reference signal received powers (RSRPs), and
wherein a highest RSRP is an absolute RSRP and another RSRP is a differential RSRP.

16. A base station (BS) in a communication system, the BS comprising:
at least one transceiver;
at least one processor communicatively coupled to the at least one transceiver; and
at least one memory, communicatively coupled to the at least one processor, storing instructions executable by the at least one processor, individually or in any combination, to cause the BS to:
transmit, to a terminal, configuration information on a channel state information (CSI) reporting initiated by the terminal,
receive, from the terminal, an indicator for the CSI reporting initiated by the terminal on a physical uplink control channel (PUCCH), and
receive, from the terminal, CSI on a physical uplink shared channel (PUSCH), wherein the CSI reporting is initiated based on an occurrence of an event associated with the CSI reporting initiated by the terminal, and
wherein the PUSCH is transmitted after an offset from the PUCCH.

17. The BS of claim 16, wherein the event corresponds to when a reference signal received power (RSRP) of a reference signal as a new beam is greater than a sum of an RSRP of a current reference signal associated with a transmission configuration indicator (TCI) state and a threshold configured by higher layer signaling.

18. The BS of claim 17,
wherein the reference signal as the new beam is configured by the higher layer signaling, and
wherein a type of the current reference signal is identical to a type of the reference signal as the new beam.

19. The BS of claim 17,
wherein the current reference signal is of quasi co-located (QCL) type D of the TCI state.

20. The BS of claim 16,
wherein the CSI includes one or more indices of the reference signal as the new beam and corresponding one or more reference signal received powers (RSRPs), and
wherein a highest RSRP is an absolute RSRP and another RSRP is a differential RSRP.
